(19) United States
(12) Patent Application Publication
(10) Pub. No.: US 2011/0269857 A1
(43) Pub. Date: Nov. 3, 2011

(54) POLYMER AND METHOD OF PREPARING THE SAME

(75) Inventors: Young Moo Lee, Seoul (KR); Ho-Bum Park, Seoul (KR); Chul-Ho Jung, Gwangju (KR); Sang-Hoon Han, Seoul (KR)

(73) Assignee: Industry-University Cooperation Foundation, HANYANG UNIVERSITY, Seoul (KR)

(21) Appl. No.: 13/123,189

(22) PCT Filed: Oct. 9, 2009
(86) PCT No.: PCT/KR2009/005806

§ 371 Date: Jul. 21, 2011

(30) Foreign Application Priority Data
Oct. 9, 2008 (CA) 2640906
Oct. 10, 2008 (US) 12249159

(51) Int. Cl. C08G 73/22; C08J 9/40; C08G 75/32; C08G 73/10; C08G 73/20

(52) U.S. Cl. 521/55; 521/185; 521/180

(57) ABSTRACT

Disclosed is a polymer derived from polyamic acid or a polyimide. The polymer derived from polyamic acid or a polyimide includes picopores, and the polyamic acid and the polyimide include a repeating unit obtained from an aromatic diamine including at least one ortho-positioned functional group with respect to an amine group and a dianhydride.

### BACKGROUND OF THE INVENTION

(a) Field of the Invention

This disclosure relates to a polymer and a method of preparing the same.

(b) Description of the Related Art

In a rigid organic material, diffusion of low molecules or ions through pores is based on sub-nano or nano techniques. A membrane including such an organic material may be used in order to selectively separate low molecules or ions. The membrane may be applicable to many various field such as a process of preparing materials, energy conversion, energy storage, organic batteries, fuel cells, gas separation, and the like.

Accordingly, research into such a membrane has been actively undertaken. However, a material having heat resistance, chemical resistance, solubility in a generally-used solvent, as well as selective separation capability of low molecules or ions has not been developed and therefore there is a limit in application to various fields.

### SUMMARY OF THE INVENTION

One embodiment of the present invention provides a polymer having excellent permeability and selectivity for low molecules, excellent heat resistance and chemical resistance, and good solubility in a solvent.

Another embodiment of the present invention provides a method of preparing the polymer.

According to one embodiment of the present invention, a polymer derived from polyamic acid or a polyimide is provided. The polymer derived from polyamic acid or polyimide includes picopores, and the polyamic acid and the polyimide include a repeating unit obtained from an aromatic diamine including at least one ortho-positioned functional group with respect to an amine group and a dianhydride.

The picopores may have an hourglass-shaped structure by connecting at least two picopores.

The ortho-positioned functional group with respect to the amine group may be OH, SH, or NH₂. The polymer derived from polyamic acid or polyimide has a fractional free volume (FFV) of 0.18 to 0.40, and interplanar distance (d-spacing) of 580 pm to 800 pm measured by X-ray diffraction (XRD).

The picopores have a full width at half maximum (FWHM) of about 10 pm to about 40 pm measured by positron annihilation lifetime spectroscopy (PALS).

The polymer derived from polyamic acid or a polyimide has a BET surface area of 100 m²/g to 1000 m²/g.

The polyamic acid may be selected from the group consisting of a polyamic acid including a repeating unit represented by the following Chemical Formulae 1 to 4, polyamic acid copolymers including a repeating unit represented by the following Chemical Formulae 5 to 8, copolymers thereof, and blends thereof.

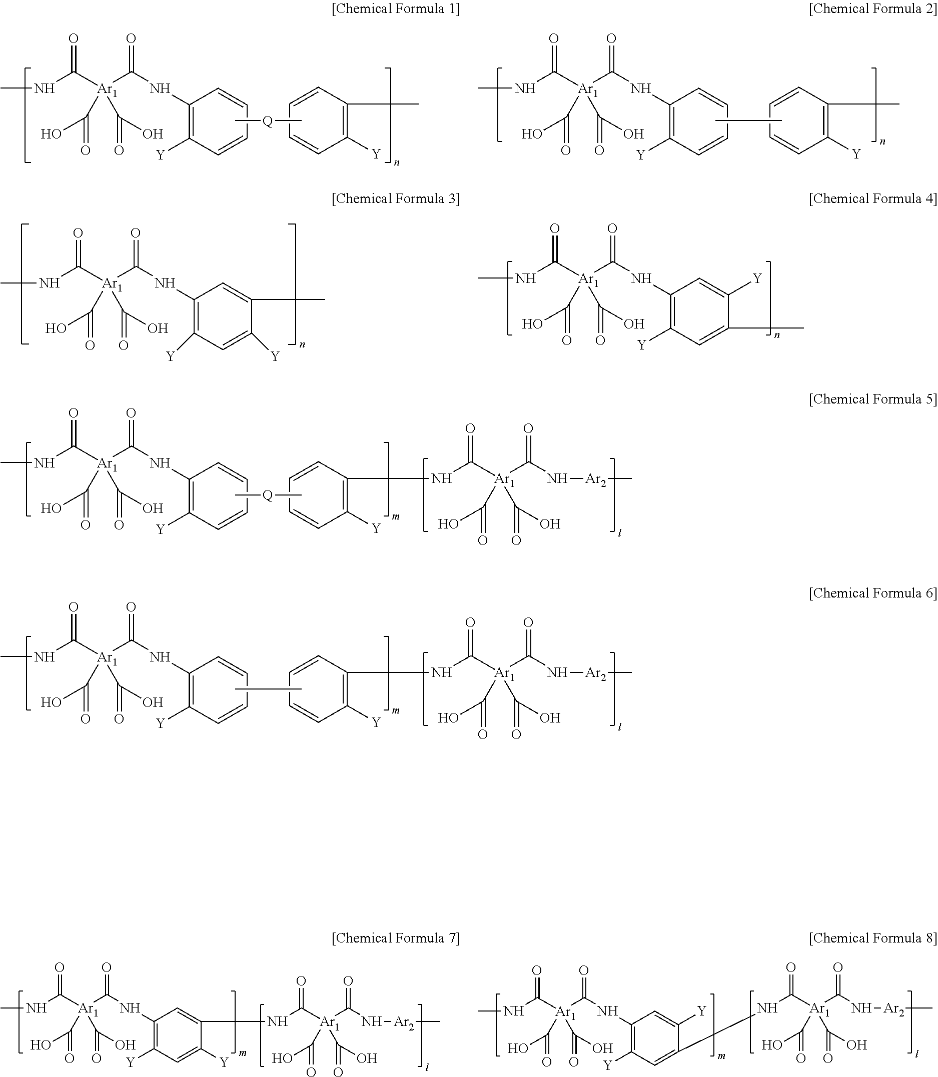

In the above Chemical Formulae 1 to 8,

Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different in each repeating unit and is independently selected from OH, SH, or NH₂,

n is an integer ranging from 20 to 200,

m is an integer ranging from 10 to 400, and

l is an integer ranging from 10 to 400.

The polyimide may be selected from the group consisting of a polyimide including a repeating unit represented by the following Chemical Formulae 33 to 36, polyimide copolymers including a repeating unit represented by the following Chemical Formulae 37 to 40, copolymers thereof, and blends thereof.

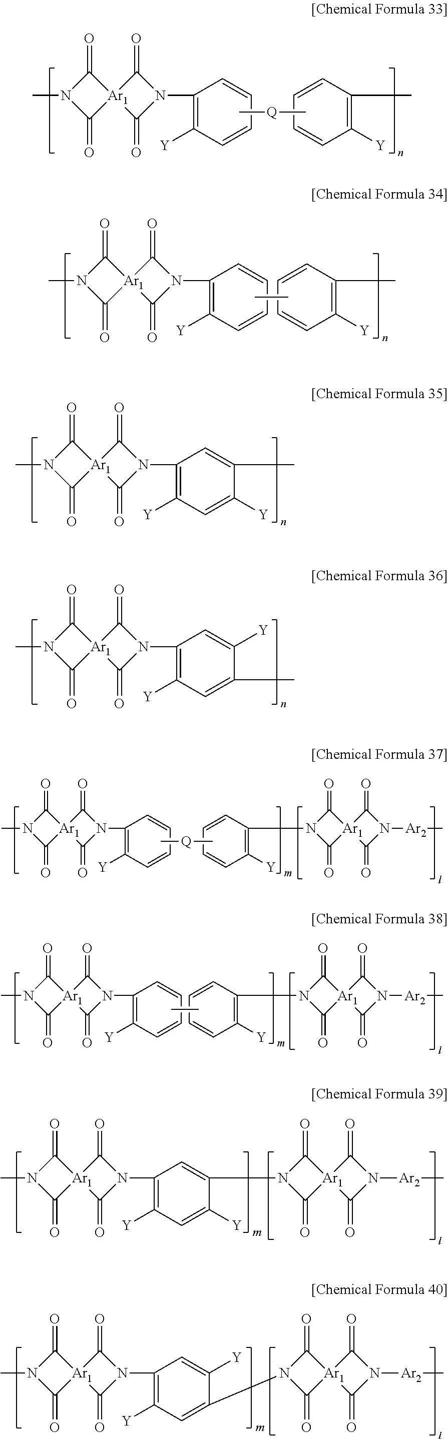

In above Chemical Formulae 33 to 40,

Ar₁, Ar₂, Q, Y, n, m, and l are the same as Ar₁, Ar₂, Q, n, m, and l in the above Chemical Formulae 1 to 8.

The polymer derived from polyamic acid or a polyimide may include a polymer including a repeating unit represented by one of the following Chemical Formulae 19 to 32, or copolymers thereof.

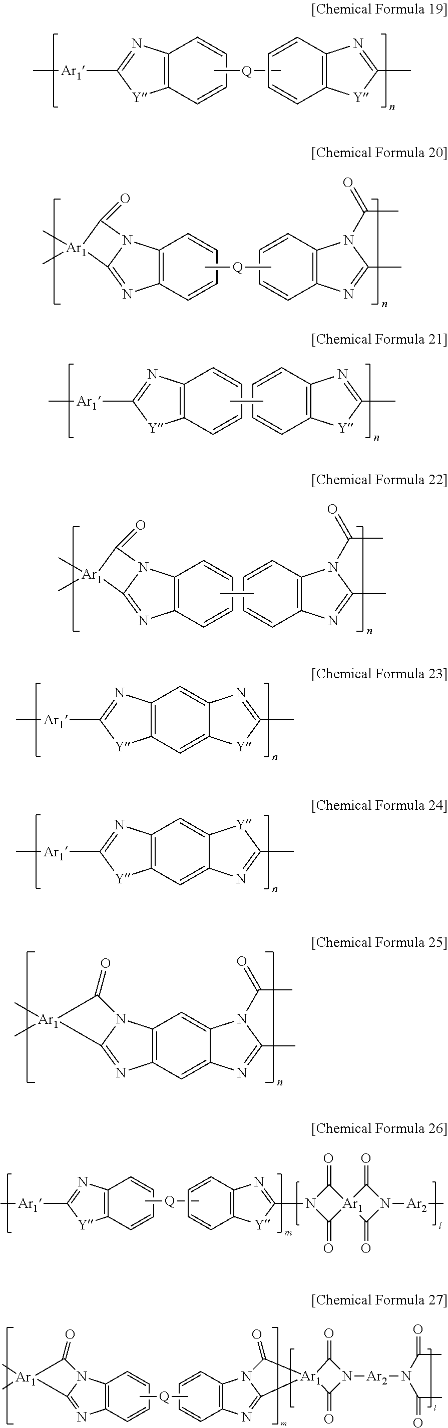

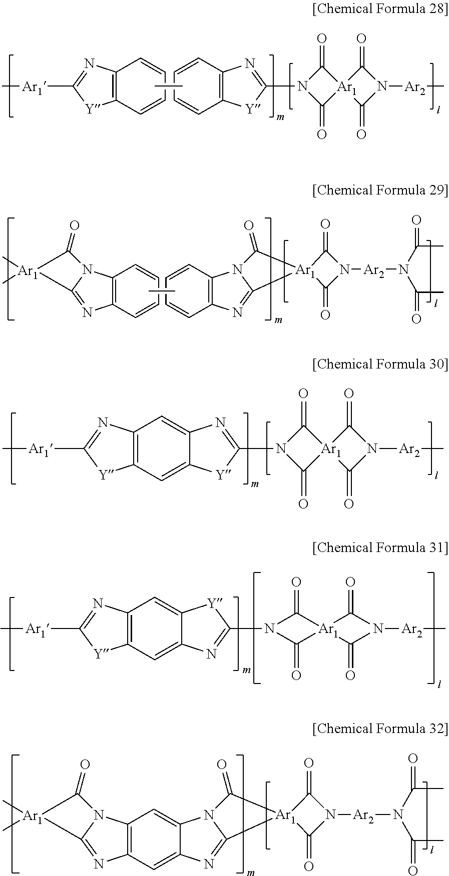

In the above Chemical Formulae 19 to 32,

Ar₁, Ar₂, Q, n, m, and l are the same as Ar₁, Ar₂, Q, n, m, and l in the above Chemical Formulae 1 to 8,

Ar₁′ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH, and

Y″ is O or S.

In the above Chemical Formulae 1 to 8 and Chemical Formulae 19 to 40, Ar₁ may be selected from one of the following Chemical Formulae.

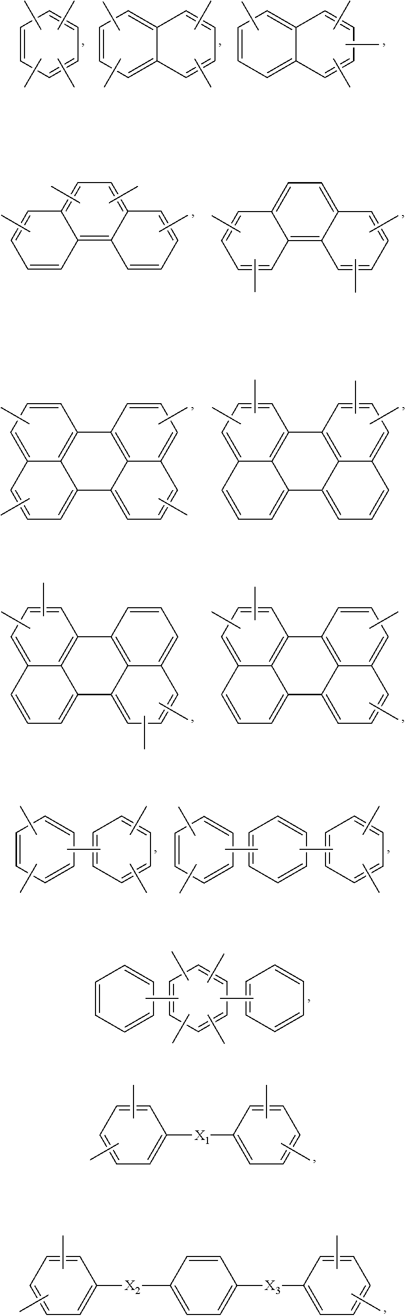

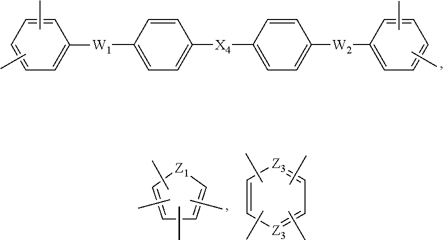

In the above Chemical Formulae,

X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different, and are independently O, S, or C(═O),

Z₁ is O, S, CR₁R₂, or NR₃, where R₁, R₂, and R₃ are the same or different and are independently hydrogen or a C1 to C5 alkyl group, and

Z₂ and Z₃ are the same or different and are independently N or CR₄ (where R₄ is hydrogen or a C1 to C5 alkyl group), provided that both Z₂ and Z₃ are not CR₄.

In the above Chemical Formulae 1 to 8 and Chemical Formulae 19 to 40, specific examples of Ar₁ may be selected from one of the following Chemical Formulae.

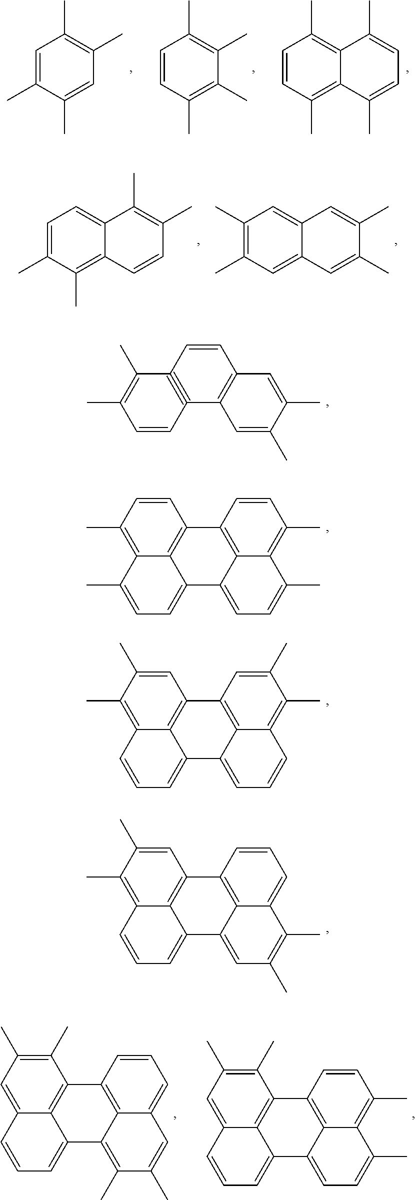

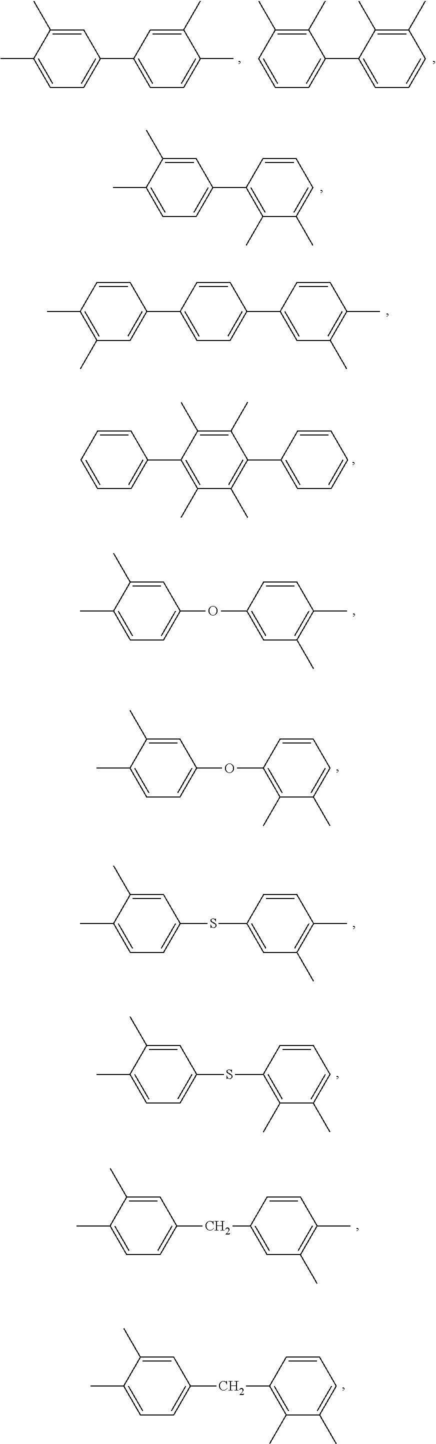

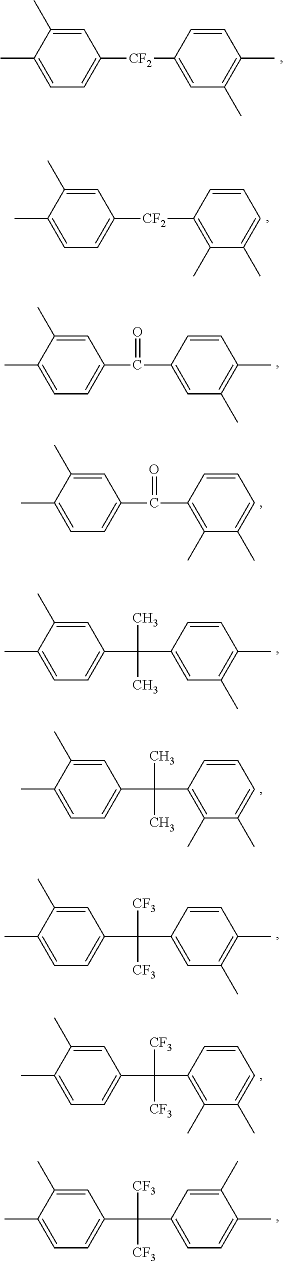

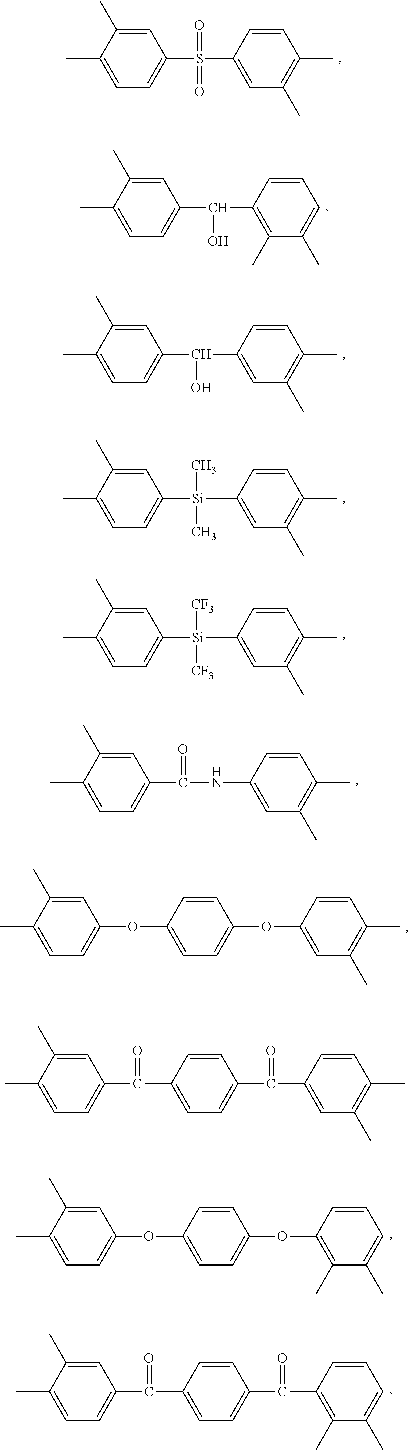

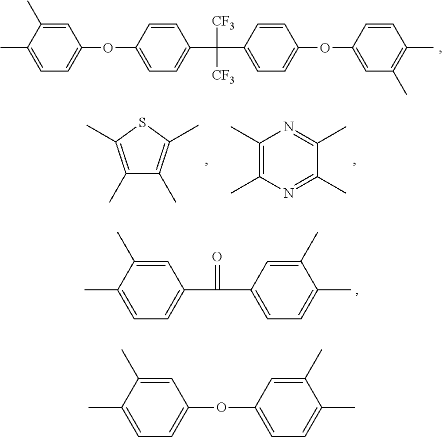

In the above Chemical Formulae 1 to 8 and Chemical Formulae 19 to 40, Ar₂ may be selected from one of the following Chemical Formulae.

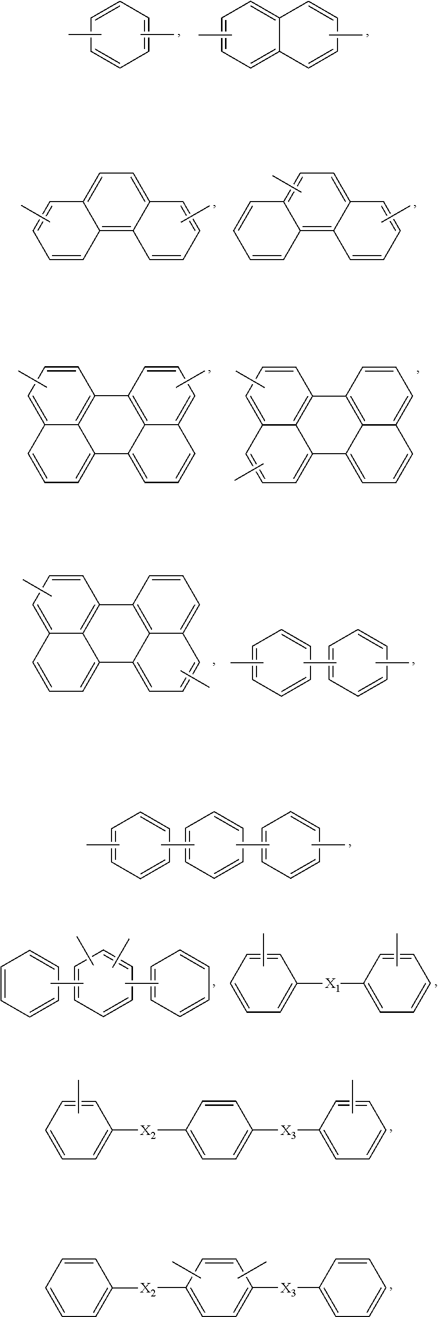

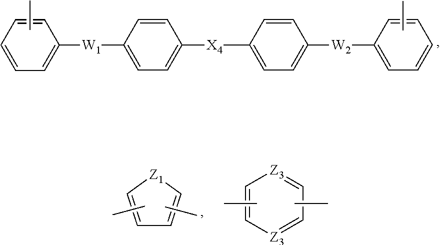

In the above Chemical Formulae,

X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C(═O),

Z₁ is O, S, CR₁R₂, or NR₃, where R₁, R₂, and R₃ are the same or different and are independently hydrogen or a C1 to C5 alkyl group, and

Z₂ and Z₃ are the same or different and are independently N or CR₄ (where R₄ is hydrogen or a C1 to C5 alkyl group), provided that both Z₂ and Z₃ are not CR₄.

In the above Chemical Formulae 1 to 8 and Chemical Formulae 19 to 40, specific examples of Ar₂ may be selected from one of the following Chemical Formulae.

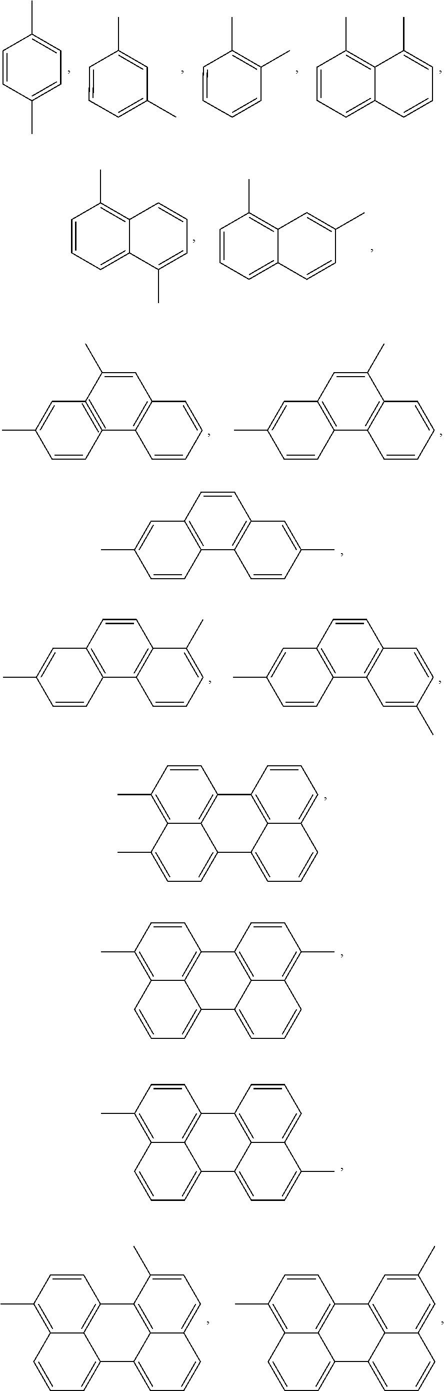

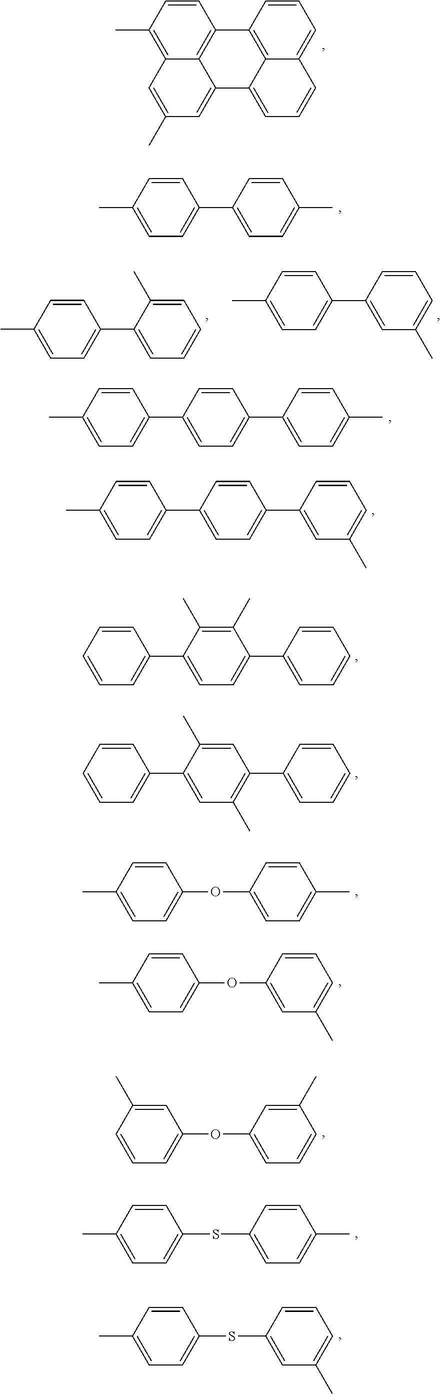

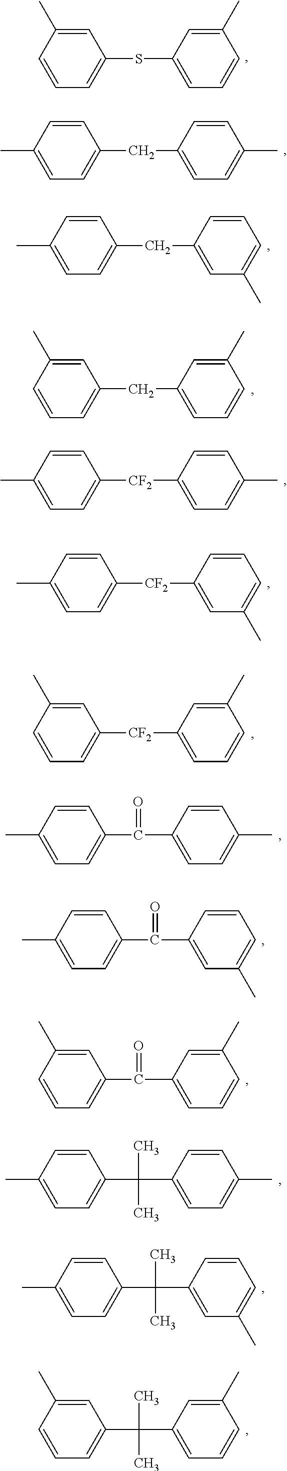

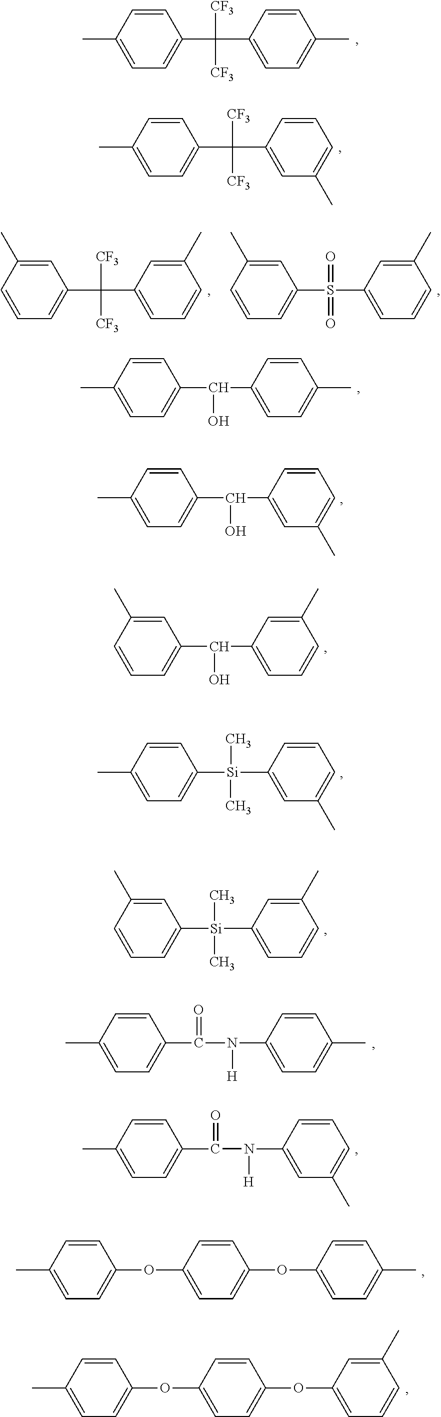

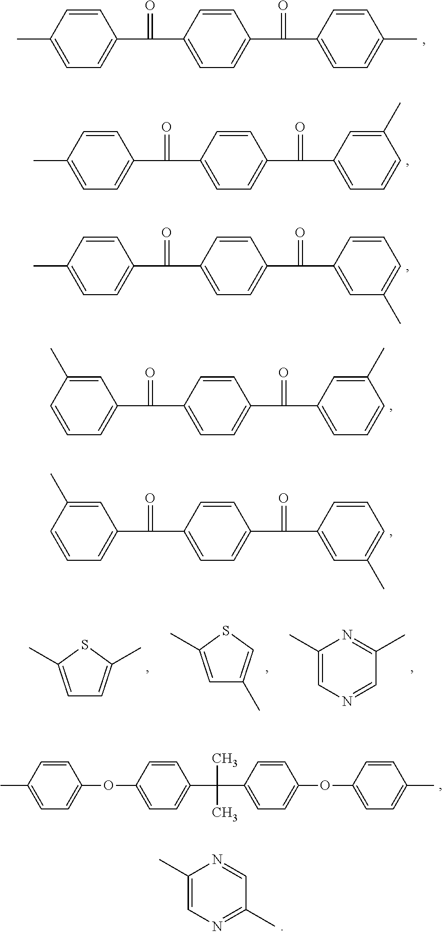

In the above Chemical Formulae 1 to 8 and Chemical Formulae 19 to 40, Q is selected from C(CH₃)₂, C(CF₃)₂, O, S, S(═O)₂, or C(═O).

In the above Chemical Formulae 19 to 32, examples of Ar₁′ are the same as in those of Ar₂ of the above Chemical Formulae 1 to 8 and Chemical Formulae 19 to 40.

In the above Chemical Formulae 1 to 8 and Chemical Formulae 33 to 40, Ar₁ may be a functional group represented by the following Chemical Formula A, B, or C, Ar₂ may be a functional group represented by the following Chemical Formula D or E, and Q may be C(CF₃)₂.

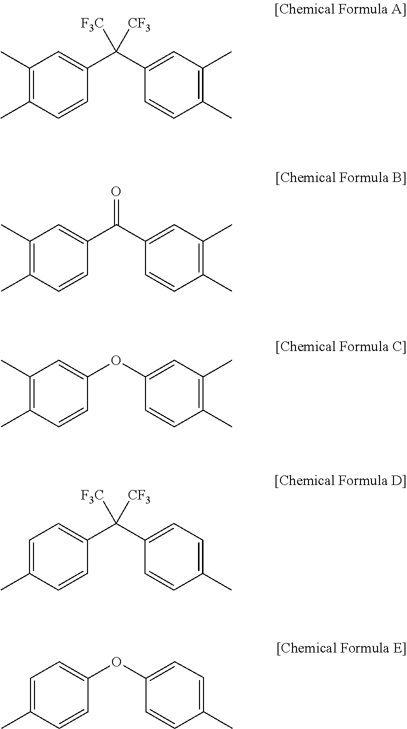

In the above Chemical Formulae 19 to 32, Ar₁ may be a functional group represented by the above Chemical Formula A, B, or C, Ar₁′ may be a functional group represented by the following Chemical Formula F, G, or H, Ar₂ may be a functional group represented by the above Chemical Formula D or E, and Q may be C(CF₃)₂.

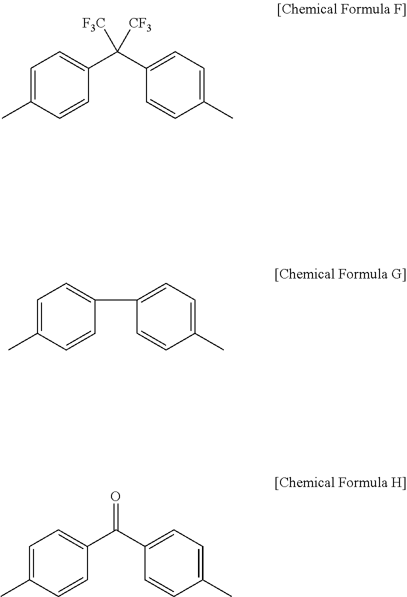

A mole ratio of each repeating unit in the polyamic acid copolymer including a repeating unit represented by the above Chemical Formulae 1 to 4 and an m:l mole ratio in Chemical Formula 5 to 8 range from 0.1:9.9 to 9.9:0.1. A mole ratio between repeating units in the polyimide copolymer including a repeating unit represented by the above Chemical Formulae 33 to 36 and an m:l mole ratio in Chemical Formula 37 to 40 range from 0.1:9.9 to 9.9:0.1.

The polymer may have a weight average molecular weight (Mw) of 10,000 to 200,000.

The polymer may be doped with an acid dopant. The acid dopant includes one selected from the group consisting of sulfuric acid, hydrochloric acid, phosphoric acid, nitric acid, HBrO₃, HClO₄, HPF₆, HBF₆, 1-methyl-3-methylimidazolium cations (BMIM⁺), and a combination thereof.

The polymer may further include an additive selected from the group consisting of fumed silica, zirconium oxide, tetraethoxysilane, montmorillonite clay, and a combination thereof.

The polymer may further include an inorganic filler selected from the group consisting of phosphotungstic acid (PWA), phosphomolybdic acid, silicotungstic acid (SiWA), molybdophosphoric acid, silicomolybdic acid, phosphotin acid, zirconium phosphate (ZrP), and a combination thereof.

Still another embodiment of the present invention provides a method of preparing a polymer including obtaining a polyimide by imidization of the polyamic acid, and heat-treating the polyimide. The polymer includes picopores.

Yet another embodiment of the present invention provides a method of preparing a polymer including a heat-treatment of the polyimide. The polymer includes picopores.

The heat treatment may be performed by increasing the temperature by 1 to 30° C./min up to 350 to 500° C., and then maintaining the temperature for 1 minute to 12 hours under an inert atmosphere. Specifically, the heat treatment may be performed by increasing the temperature by 5 to 20° C./minute to 350 to 450° C., and then maintaining the temperature for 1 hour to 6 hours under an inert atmosphere.

One embodiment of the present invention provides an article including the polymer. The article includes a sheet, a film, a powder, a layer, or a fiber.

The article includes picopores that form a three-dimensional network structure where at least two picopores are three-dimensionally connected to have an hourglass-shaped structure forming a narrow valley at connection parts.

Hereinafter, further embodiments of the present invention will be described in detail.

### BRIEF DESCRIPTION OF THE DRAWINGS

FIG. 1 shows two types of changes in chain structure occurring during thermal rearrangement.

FIG. 2 shows FT-IR spectra of polymers according to Example 3 and Comparative Example 1.

FIG. 3 shows FT-IR spectra of polymers according to Example 9 and Comparative Example 2.

FIG. 4 shows FT-IR spectra of polymers according to Example 10 and Comparative Example 3.

FIG. 5 is a TGA/MS graph of polyhydroxyimide of Comparative Example 1 and of polybenzoxazole of Examples 1, 3, and 4.

FIG. 6 is a TGA/MS graph of a polymer (precursor of a polymer of Example 9) of Comparative Example 2 and a polymer of Example 9.

FIG. 7 is a TGA/MS graph of polyaminoimide (precursor of a polymer of Example 10) of Comparative Example 3 and a polymer of Example 10.

FIG. 8 shows nitrogen (N₂) adsorption/desorption isotherms of polymers according to Examples 3, 9, and 10 at −196° C.

FIG. 9 shows nitrogen (N₂) adsorption/desorption isotherms of polymers according to Examples 3, 5, and 8 at −196° C.

FIG. 10 is a graph showing pore radius distribution of polymers of Examples 1 to 3 and Comparative Example 1 measured by PALS.

FIG. 11 is a graph showing oxygen permeability (Barrer) and oxygen/nitrogen selectivity of flat membranes prepared by using polymers of Examples 1 to 11, Examples 18 to 22, and Examples 24 to 34 of the present invention, and polymers of Comparative Examples 1 to 7 and Comparative Examples 11 to 13 (the numbers 1 to 11, 18 to 22, and 24 to 34 indicate Examples 1 to 11, Examples 18 to 22, and Examples 24 to 34, respectively, and the numbers 1′ to 7′ and 11′ to 13′ indicate Comparative Examples 1 to 7 and Comparative Examples 11 to 13, respectively).

FIG. 12 is a graph showing carbon dioxide permeability (Barrer) and carbon dioxide/methane selectivity for flat membranes prepared by using polymers of Examples 1 to 11, 18 to 22, and 24 to 34 of the present invention, and polymers of Comparative Examples 1 to 7 and 11 to 13 (the numbers 1 to 11, 18 to 22, and 24 to 34 indicate Examples 1 to 11, 18 to 22, and 24 to 34, respectively, and the numbers 1′ to 7′ and 11′ to 13′ indicate Comparative Examples 1 to 7 and 11 to 13, respectively).

### DETAILED DESCRIPTION OF THE EMBODIMENTS

Exemplary embodiments of the present invention will hereinafter be described in detail. However, these embodiments are only exemplary, and the present invention is not limited thereto.

The term “picopore” refers to a pore having an average diameter of hundreds of picometers, and in one embodiment, having an average diameter of 100 picometers to 1000 picometers.

As used herein, when a specific definition is not provided, the term “substituted” refers to a compound or a functional group where hydrogen is substituted with at least one substituent selected from the group consisting of a C1 to C10 alkyl group, a C1 to C10 alkoxy group, a C1 to C10 haloalkyl group, and a C1 to C10 haloalkoxy group. The term “hetero cyclic group” refers to a substituted or unsubstituted C2 to C30 cycloalkyl group, a substituted or unsubstituted C2 to C30 cycloalkenyl group, a substituted or unsubstituted C2 to C30 cycloalkynyl group, or a substituted or unsubstituted C2 to C30 heteroaryl group including 1 to 3 heteroatoms selected from the group consisting of O, S, N, P, Si, and combinations thereof.

As used herein, when a definition is not otherwise provided, the term “combination” refers to a mixture or copolymer. The term “copolymerization” refers to block polymerization or random polymerization, and the term “copolymer” refers to a block copolymer or a random copolymer.

The polymer according to one embodiment of the present invention includes a polymer derived from polyamic acid or a polyimide having picopores. The polyamic acid and the polyimide include a repeating unit obtained from an aromatic diamine including at least one ortho-positioned functional group with respect to an amine group and a dianhydride.

The picopores have an hourglass-shaped structure forming a narrow valley at connection parts of at least two picopores. Thereby, the polymer has high porosity to permeate or selectively separate low molecules, for example gases, efficiently.

The ortho-positioned functional group with respect to the amine group may be OH, SH, or NH₂.

The polyamic acid and the polyimide may be prepared by a generally-used method in this art. For example, the polyamic acid may be prepared by reacting an aromatic diamine including ortho-positioned OH, SH, or NH₂ with respect to the amine group, and tetracarboxylic anhydride. The polyimide may be prepared by thermal solution imidization or chemical imidization of the obtained polyamic acid. The thermal solution imidization and chemical imidization are described hereinafter.

The polyamic acid is imidized and then thermally rearranged, and the polyimide is thermally rearranged into a polymer such as polybenzoxazole, polybenzthiazole, or polypyrrolone having a high fractional free volume in accordance with a method that will be described below.

The polymer derived from polyamic acid or a polyimide has a fractional free volume (FFV) of about 0.18 to about 0.40, and interplanar distance (d-spacing) of about 580 pm to about 800 pm measured by X-ray diffraction (XRD). The polymer derived from polyamic acid or a polyimide permeates or selectively separates low molecules.

The polymer derived from polyamic acid or a polyimide includes picopores, The picopores have an average diameter of about 600 pm to about 800 pm, without limitation. The picopores have a full width at half maximum (FWHM) of about 10 pm to about 40 pm measured by positron annihilation lifetime spectroscopy (PALS). This indicates that the produced picopores have a significantly uniform size. The PALS measurement is performed by obtaining time difference, τ₁, τ₂, τ₃ and the like between γ₀ of 1.27 MeV produced by radiation of positrons produced from ²²Na isotope and γ₁ and γ₂ of 0.511 MeV produced by annihilation thereafter.

The polymer derived from polyamic acid or a polyimide has a BET (Brunauer-Emmett-Teller) surface area of about 100 m²/g to about 1000 m²/g. When the BET surface area is within the range, a surface area that is appropriate for permeability or selective separation of low molecules can be obtained.

The polyamic acid may be selected from the group consisting of polyamic acid including a repeating unit represented by the following Chemical Formulae 1 to 4, polyamic acid copolymers including a repeating unit represented by the following Chemical Formulae 5 to 8, copolymers thereof, and blends thereof, but is not limited thereto.

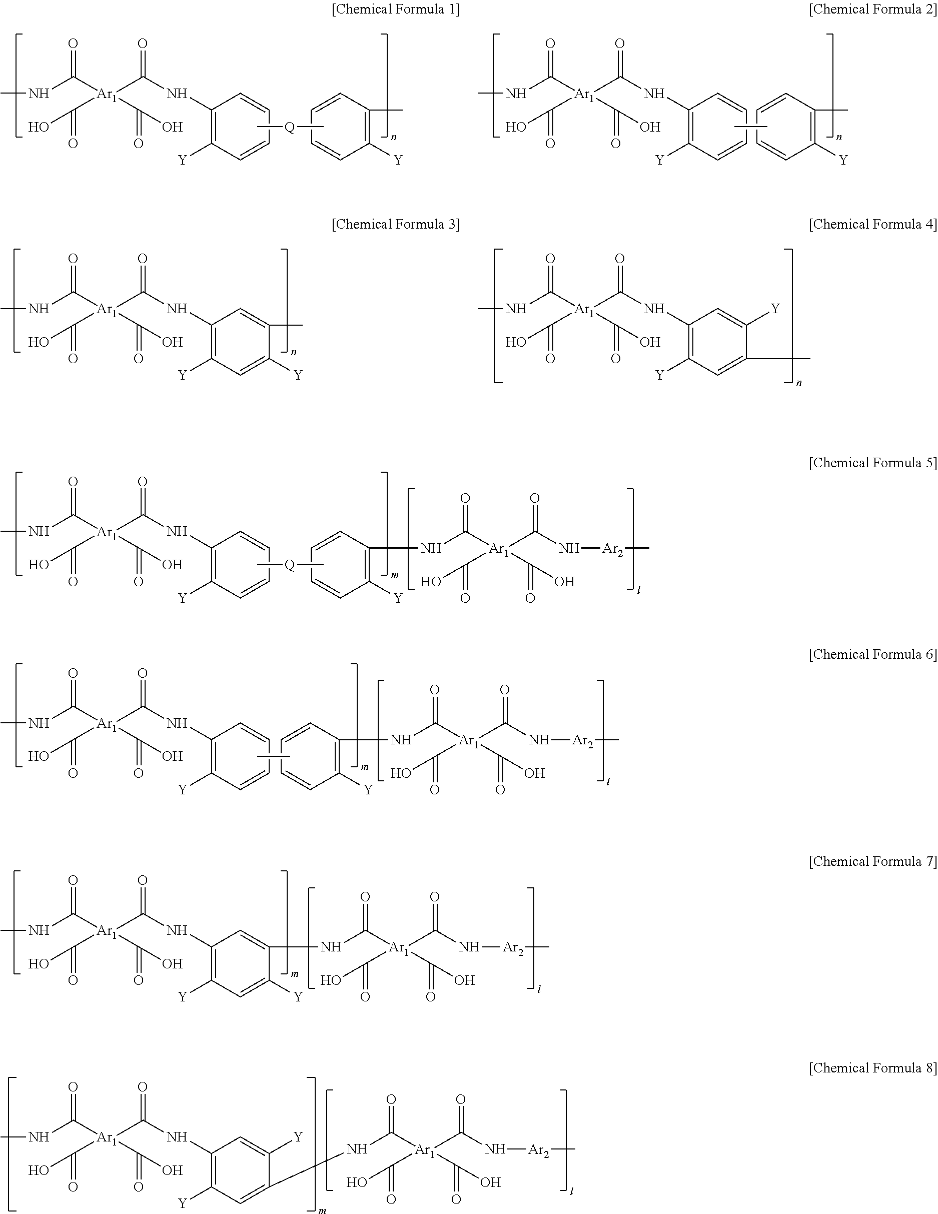

In the above Chemical Formulae 1 to 8,

Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different in each repeating unit and is independently selected from OH, SH, or NH₂,

n is an integer ranging from 20 to 200,

m is an integer ranging from 10 to 400, and

l is an integer ranging from 10 to 400.

Examples of the copolymers of the polyamic acid including repeating units represented by the above Chemical Formula 1 to 4 include polyamic acid copolymers including repeating units represented by the following Chemical Formulae 9 to 18.

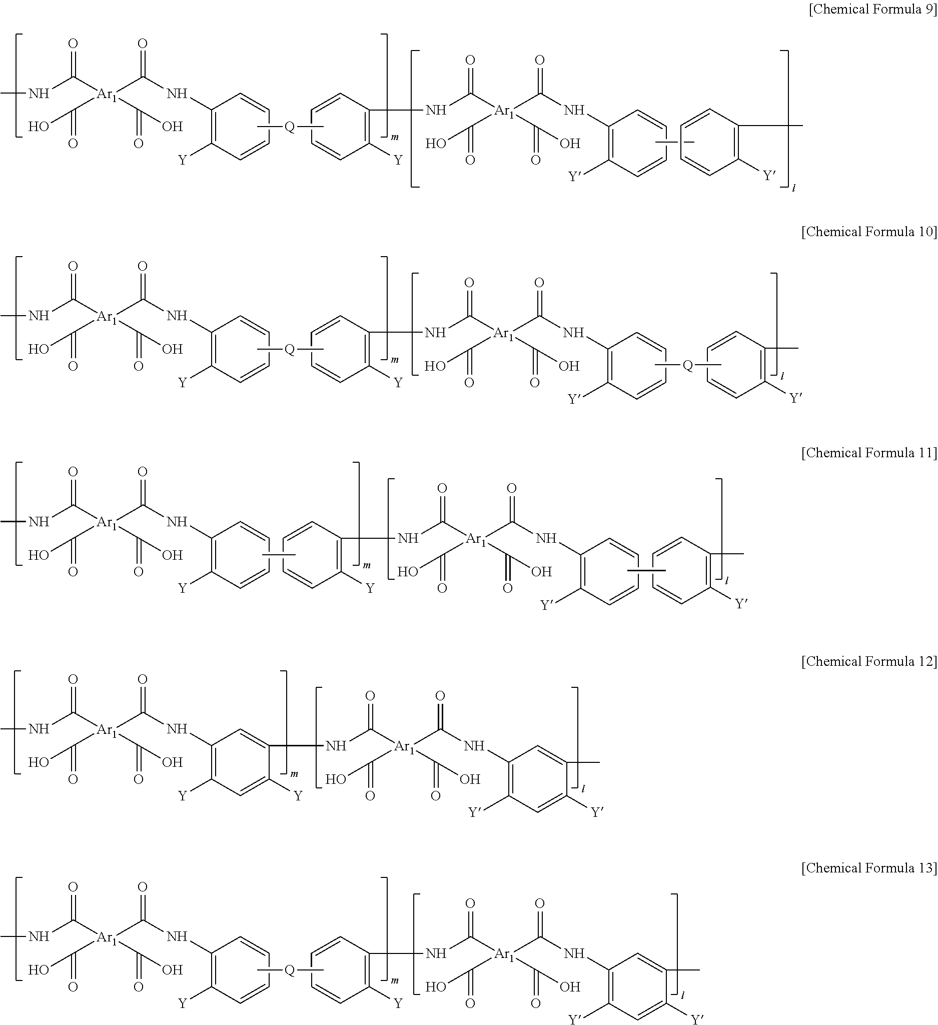

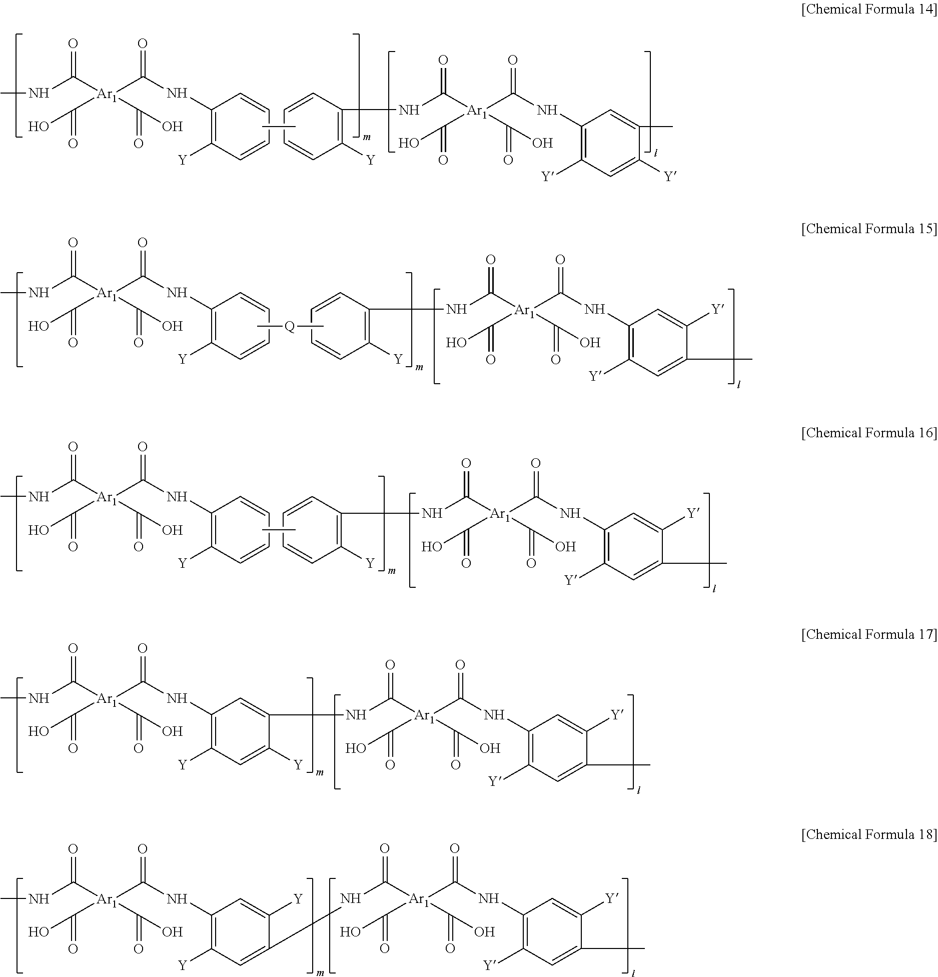

In the above Chemical Formulae 9 to 18,

Ar₁, Q, n, m, and l are the same as defined in the above Chemical Formulae 1 to 8, and

Y and Y′ are the same or different, and are independently OH, SH, or NH₂.

In the above Chemical Formulae 1 to 18, Ar₁ may be selected from one of the following Chemical Formulae, but is not limited thereto.

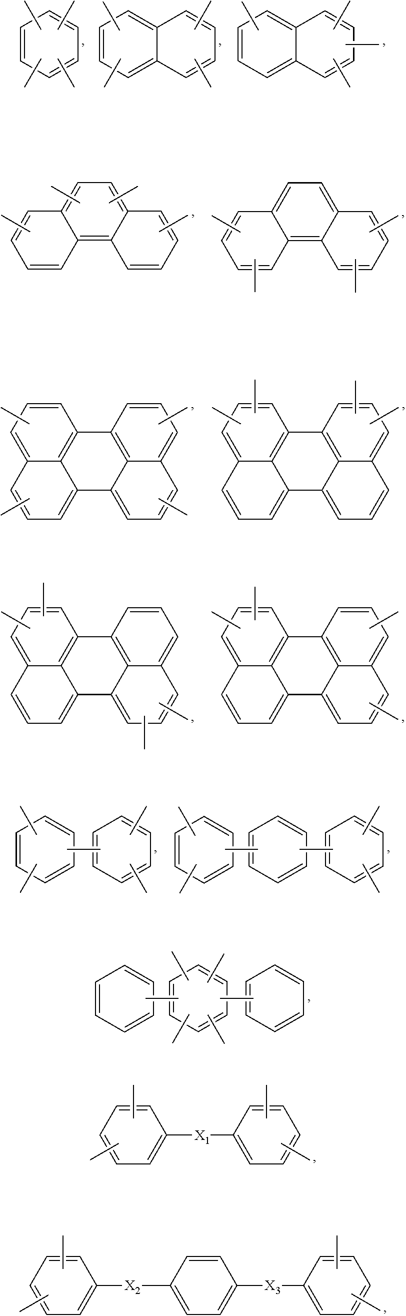

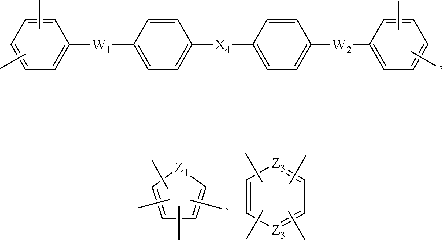

In the above Chemical Formulae,

X₁, X₂, X₃, and X₄ are the same or different, and are independently O, S, C(═O), CH(OH), S(═O)₂, Si(CH₃)₂, (CH₂)ₚ (where 1≦p≦10), (CF₂), (where 1≦q≦10), C(CH₃)₂, C(CF₃)₂, or C(═O)NH,

W₁ and W₂ are the same or different, and are independently O, S, or C(═O),

Z₁ is O, S, CR₁R₂, or NR₃, where R₁, R₂, and R₃ are the same or different and are independently hydrogen or a C1 to C5 alkyl group, and

Z₂ and Z₃ are the same or different and are independently N or CR₄ (where R₄ is hydrogen or a C1 to C5 alkyl group), provided that both Z₂ and Z₃ are not CR₄.

In the above Chemical Formulae 1 to 18, specific examples of Ar₁ may be selected from one of the following Chemical Formulae, but are not limited thereto.

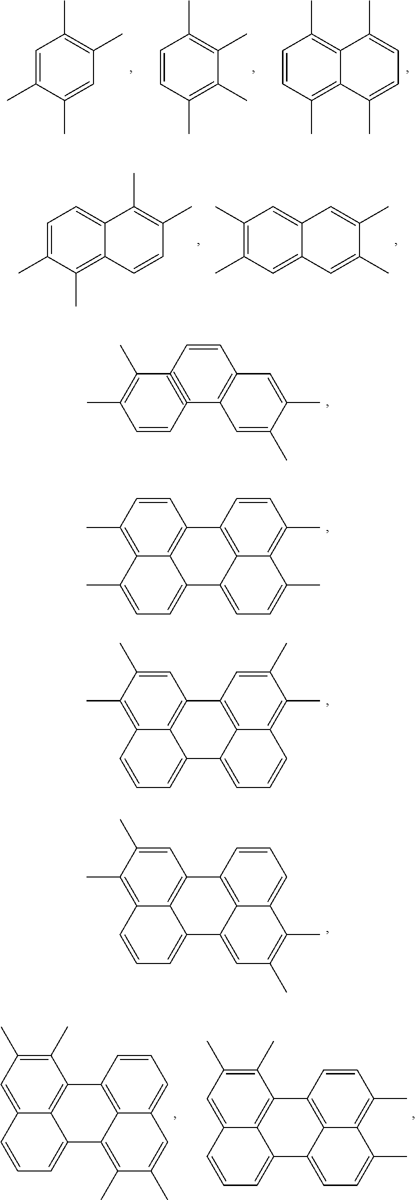

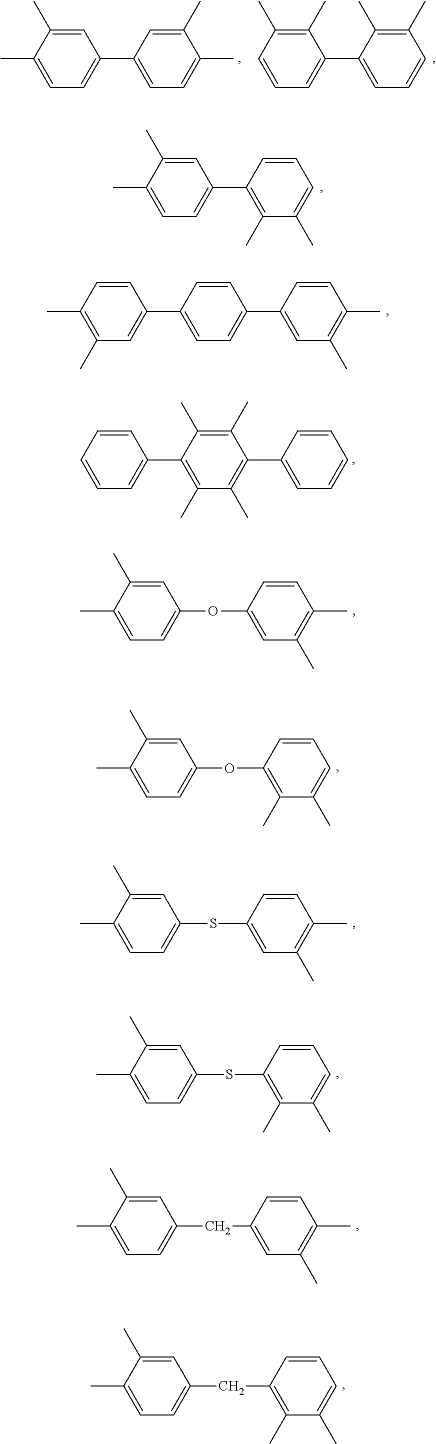

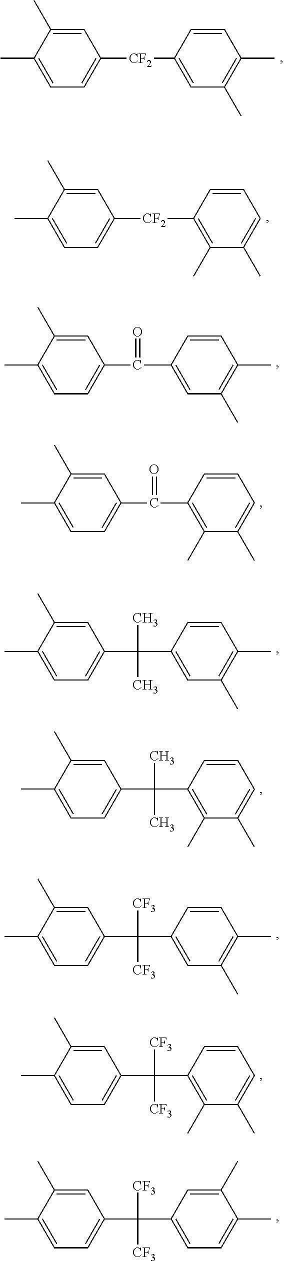

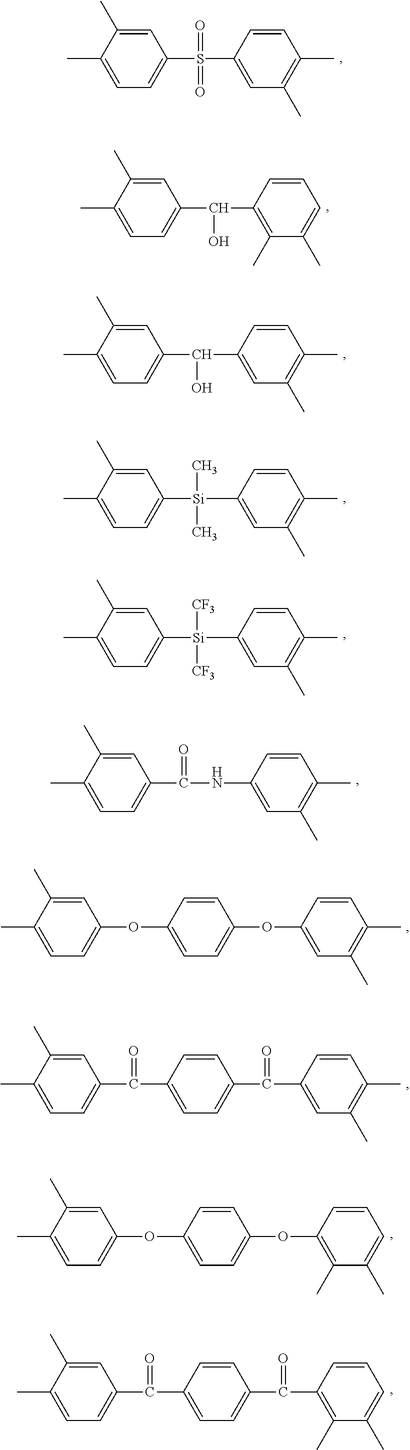

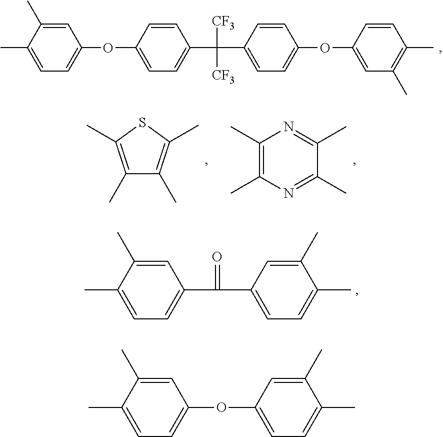

In the above Chemical Formulae 1 to 18, Ar₂ may be selected from one of the following Chemical Formulae, but is not limited thereto.

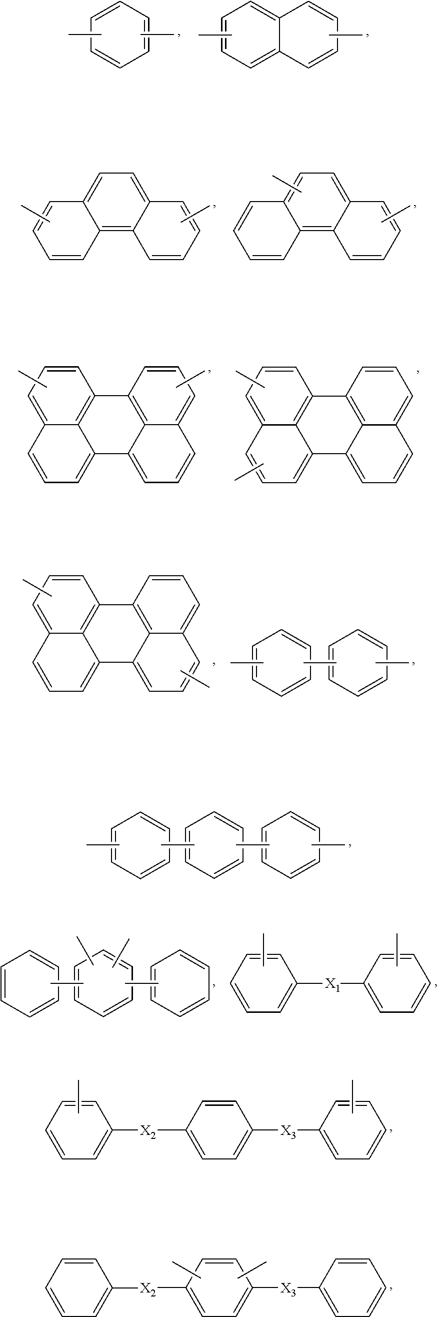

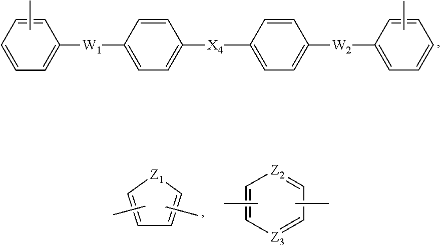

In the above Chemical Formulae,

X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C(═O),

Z₁ is O, S, CR₁R₂ or NR₃, where R₁, R₂ and R₃ are the same or different and are independently hydrogen or a C1 to C5 alkyl group, and

Z₂ and 4 are the same or different and are independently N or CR₄ (where R₄ is hydrogen or a C1 to C5 alkyl group), provided that both Z₂ and Z₃ are not CR₄.

In the above Chemical Formulae 1 to 18, specific examples of Ar₂ may be selected from one of the following Chemical Formulae, but are not limited thereto.

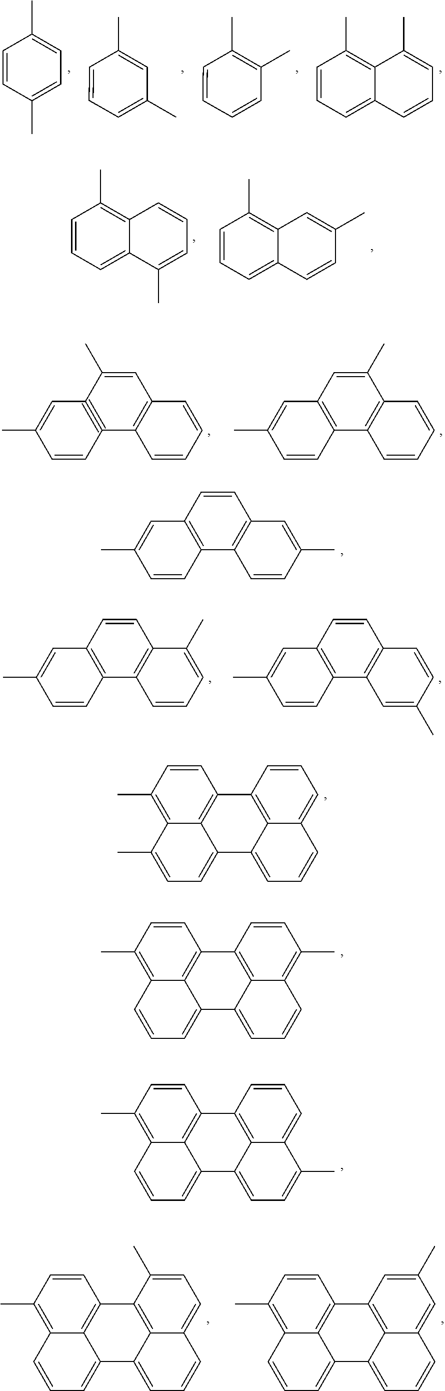

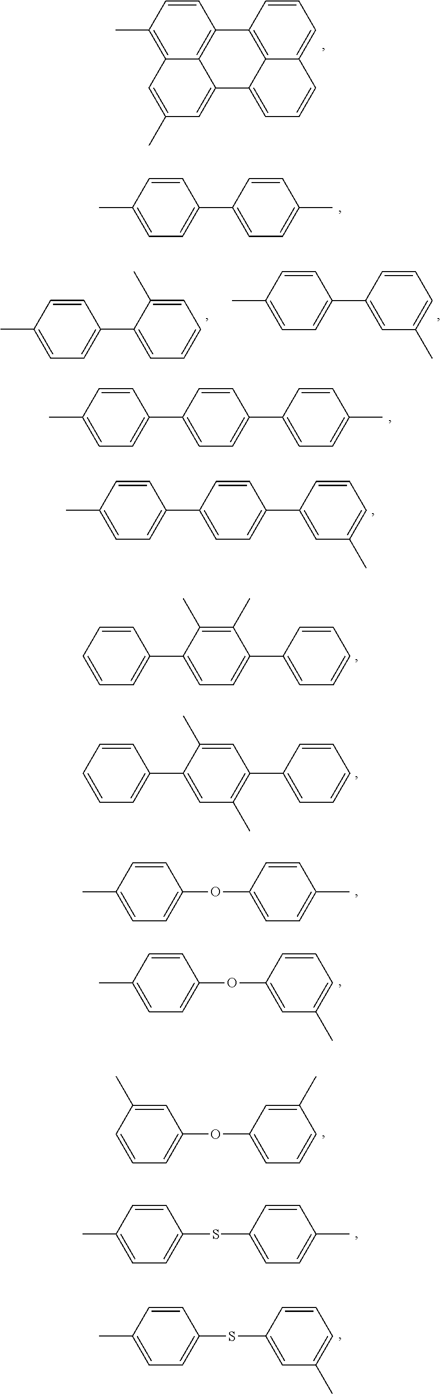

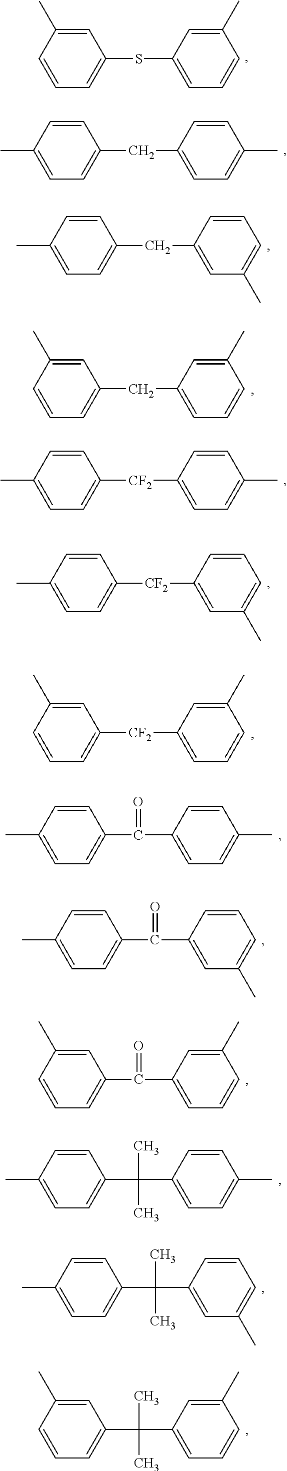

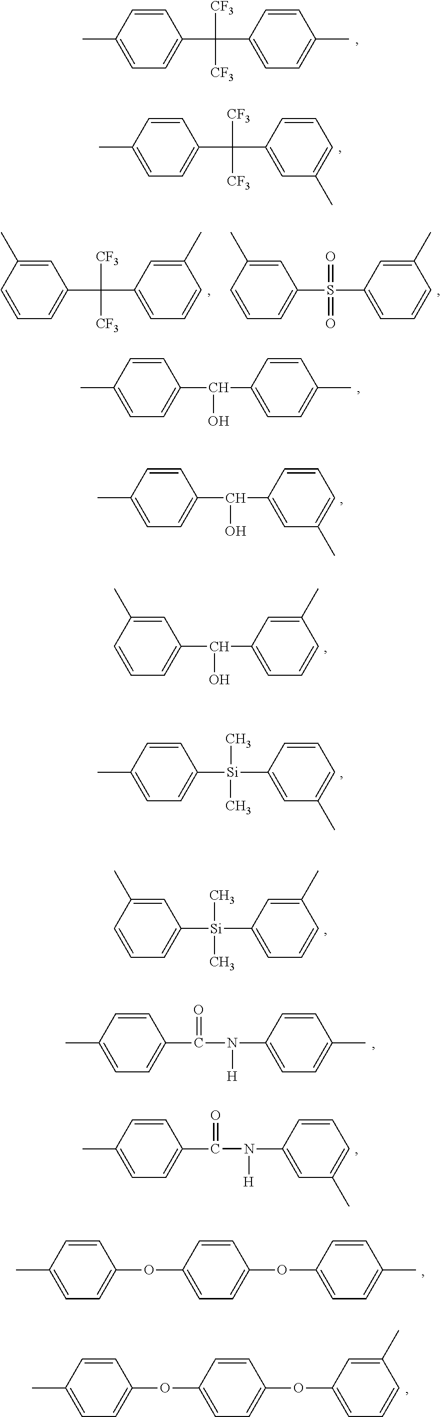

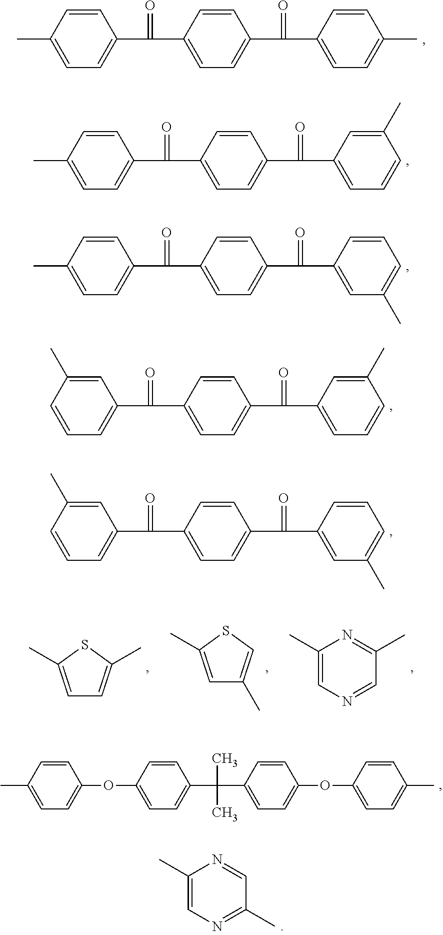

In the above Chemical Formulae 1 to 18, Q is selected from C(CH₃)₂, C(CF₃)₂, O, S, S(═O)₂, and C(═O), but is not limited thereto.

In the above Chemical Formulae 1 to 18, Ar₁ may be a functional group represented by the following Chemical Formula A, B, or C, Ar₂ may be a functional group represented by the following Chemical Formula D or E, and Q may be C(CF₃)₂, but are not limited thereto.

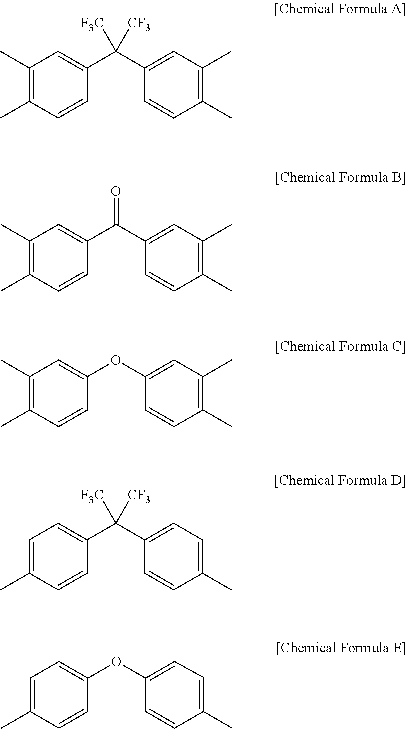

The polyimide may be selected from the group consisting of a polyimide including a repeating unit represented by the following Chemical Formulae 33 to 36, polyimide copolymers including a repeating unit represented by the following Chemical Formulae 37 to 40, copolymers thereof, and blends thereof, but is not limited thereto.

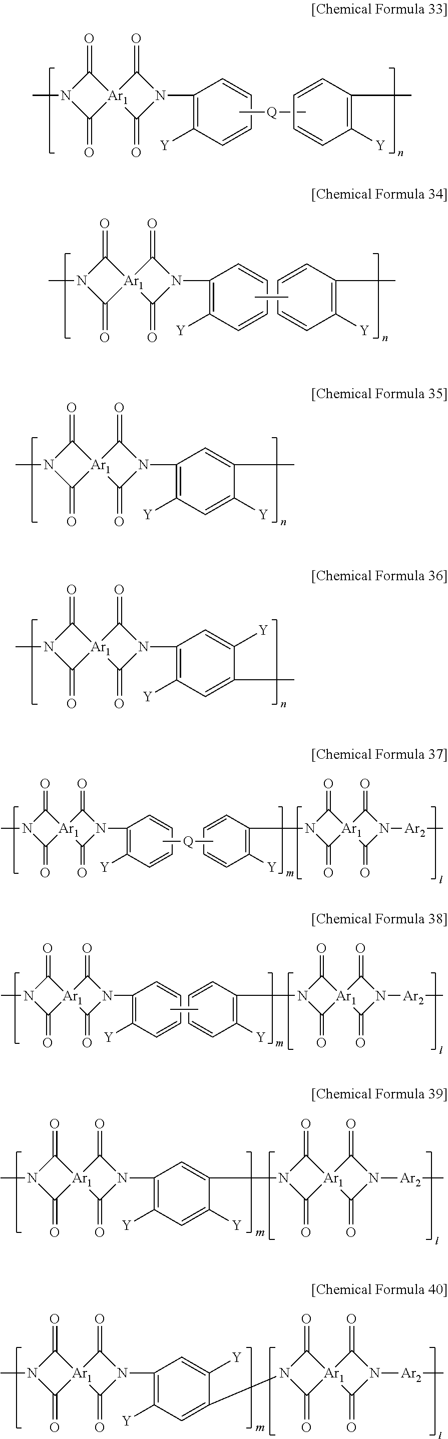

In the above Chemical Formulae 33 to 40,

Ar₁, Ar₂, Q, Y, n, m, and l are the same as Ar₁, Ar₂, Q, n, m, and l in the above Chemical Formulae 1 to 8.

In the above Chemical Formulae 33 to 40, examples of Ar₁, Ar₂, and Q are the same as examples of Ar₁, Ar₂, and Q in the above Chemical Formulae 1 to 18.

Examples of the polyimide copolymer including repeating units represented by the above Chemical Formulae 33 to 36 include polyimide copolymers including repeating units represented by the following Chemical Formulae 41 to 50.

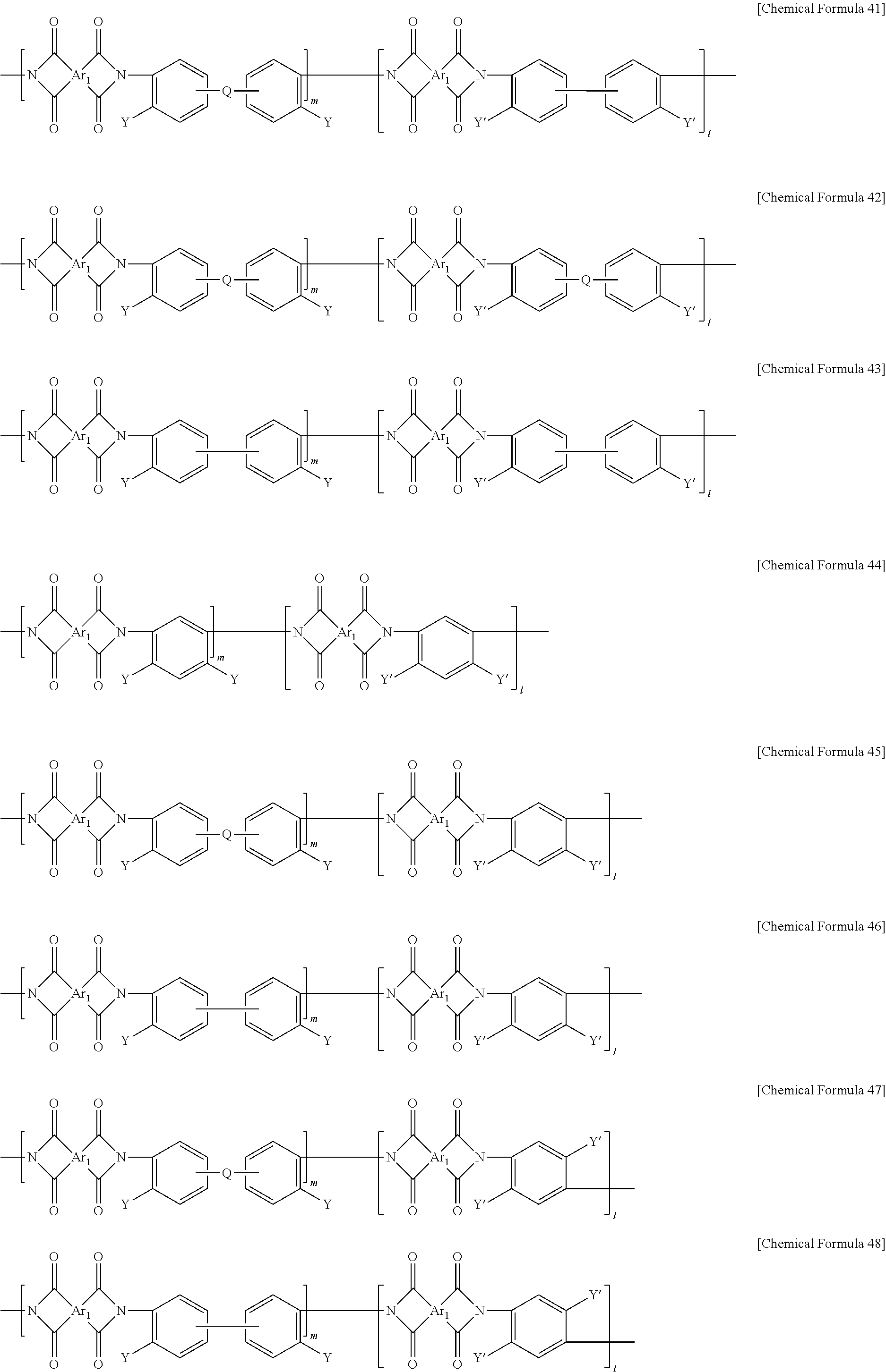

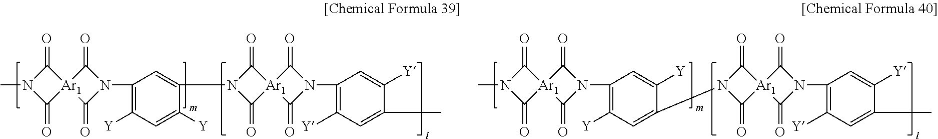

In the above Chemical Formulae 41 to 50,

Ar₁, Q, Y, Y′, n, m, and l are the same as Ar₁, Q, Y, Y′, n, m, and l of the above Chemical Formulae 1 to 18.

In the above Chemical Formulae 41 to 50, examples of Ar₁ and Q are the same as examples of Ar₁ and Q of the above Chemical Formulae 1 to 18.

The polyamic acid including a repeating unit according to the above Chemical Formulae 1 to 4, and the polyimide including a repeating unit according to above Chemical Formulae 33 to 36 may be prepared by a generally-used method in this art. For example, the monomer may be prepared by reacting tetracarboxylic anhydride and an aromatic diamine including OH, SH, or NH₂.

The polyamic acid including a repeating unit represented by Chemical Formulae 1 to 4 are imidized and thermally rearranged through a preparation process that will be mentioned later, to be converted into polybenzoxazole, polybenzothiazole, or polypyrrolone having a high fractional free volume, respectively. The polyimides including a repeating unit represented by Chemical Formulae 33 to 36 are thermally rearranged through a preparation process that will be mentioned later, to be converted into polybenzoxazole, polybenzothiazole, or polypyrrolone having a high fractional free volume, respectively. Here, a polymer including polybenzoxazole derived from polyhydroxyamic acid in which Y of Chemical Formulae 1 to 4 is OH or polyhydroxyimide in which Y of Chemical Formulae 33 to 36 is OH, polybenzothiazole derived from polythiolamic acid in which Y of Chemical Formulae 1 to 4 is SH or polythiolimide in which Y of Chemical Formulae 33 to 36 is SH, or polypyrrolone derived from polyaminoamic acid in which Y of Chemical Formulae 1 to 4 is NH₂ or polyaminoimide in which Y of Chemical Formulae 33 to 36 is NH₂ may be prepared.

In addition, it is possible to control the physical properties of the polymer thus prepared by controlling the mole ratio between the repeating units of polyamic acid copolymers including a repeating unit represented by Chemical Formulae 1 to 4, or polyimide copolymers including a repeating unit represented by Chemical Formulae 33 to 36.

The polyamic acid copolymers including a repeating unit represented by Chemical Formulae 5 to 8 are imidized and thermally rearranged through a preparation process that will be mentioned later. The polyimide copolymers including a repeating unit represented by Chemical Formulae 37 to 40 are thermally rearranged through a preparation process that will be mentioned later. Here, the polyamic acid copolymer including a repeating unit represented by Chemical Formulae 5 to 8 or the polyimide copolymer including a repeating unit represented by Chemical Formulae 37 to 40 are converted into poly(benzoxazole-imide) copolymer, poly(benzothiazole-imide) copolymer, or poly(pyrrolone-imide) copolymer, each having a high fractional free volume, and therefore the polymers including the copolymers mentioned above may be prepared. In addition, it is possible to control the physical properties of the polymer thus prepared by controlling the copolymerization ratio (mole ratio) between blocks that will be thermally converted into polybenzoxazole, polybenzothiazole, or polypyrrolone by intramolecular and intermolecular rearrangement, and blocks that will be imidized into polyimide.

The polyamic acid copolymers including a repeating unit represented by Chemical Formulae 9 to 18 are imidized and thermally rearranged through a preparation process that will be mentioned later. The polyamic acid copolymers including a repeating unit represented by Chemical Formulae 41 to 50 are thermally rearranged through a preparation process that will be mentioned later. Herein, the polyamic acid copolymer including a repeating unit represented by Chemical Formulae 9 to 18 or the polyimide copolymer including a repeating unit represented by Chemical Formulae 41 to 50 are converted into polybenzoxazole copolymer, polybenzothiazole copolymer, and polypyrrolone copolymer, each having a high fractional free volume, and therefore the polymers including the copolymers mentioned above may be prepared. In addition, it is it is possible to control the physical properties of the polymer thus prepared by controlling the mole ratio between the blocks that will be thermally rearranged into polybenzoxazole, polybenzothiazole, and polypyrrolone.

Preferably, a mole ratio between the repeating units of the polyamic acid copolymers including a repeating unit represented by Chemical Formulae 1 to 4, or a copolymerization ratio (mole ratio) m:l between blocks in the polyamic acid copolymers including a repeating unit represented by Chemical Formulae 5 to 18, may be controlled to be from about 0.1:9.9 to about 9.9:0.1, more preferably about 2:8 to about 8:2, and most preferably about 5:5.

Preferably, a mole ratio between the repeating units of the polyimide copolymers including a repeating unit represented by Chemical Formulae 33 to 36, or a copolymerization ratio (mole ratio) m:l between blocks in the polyimide copolymers including a repeating unit represented by Chemical Formulae 37 to 50, may be controlled to be from about 0.1:9.9 to about 9.9:0.1, more preferably about 2:8 to about 8:2, and most preferably about 5:5.

The copolymerization ratio affects the morphology of the thus-prepared thermally rearranged polymer. Since such morphologic change is associated with pore characteristics, heat resistance, and surface hardness. When the mole ratio and the copolymerization ratio are within the range, the prepared polymer may effectively permeate or selectively separate the low molecules, and have excellent heat resistance, chemical resistance, and surface hardness.

The polymer derived from polyamic acid or a polyimide may include compounds including a repeating unit represented by one of the following Chemical Formulae 19 to 32 or copolymers thereof, but is not limited thereto.

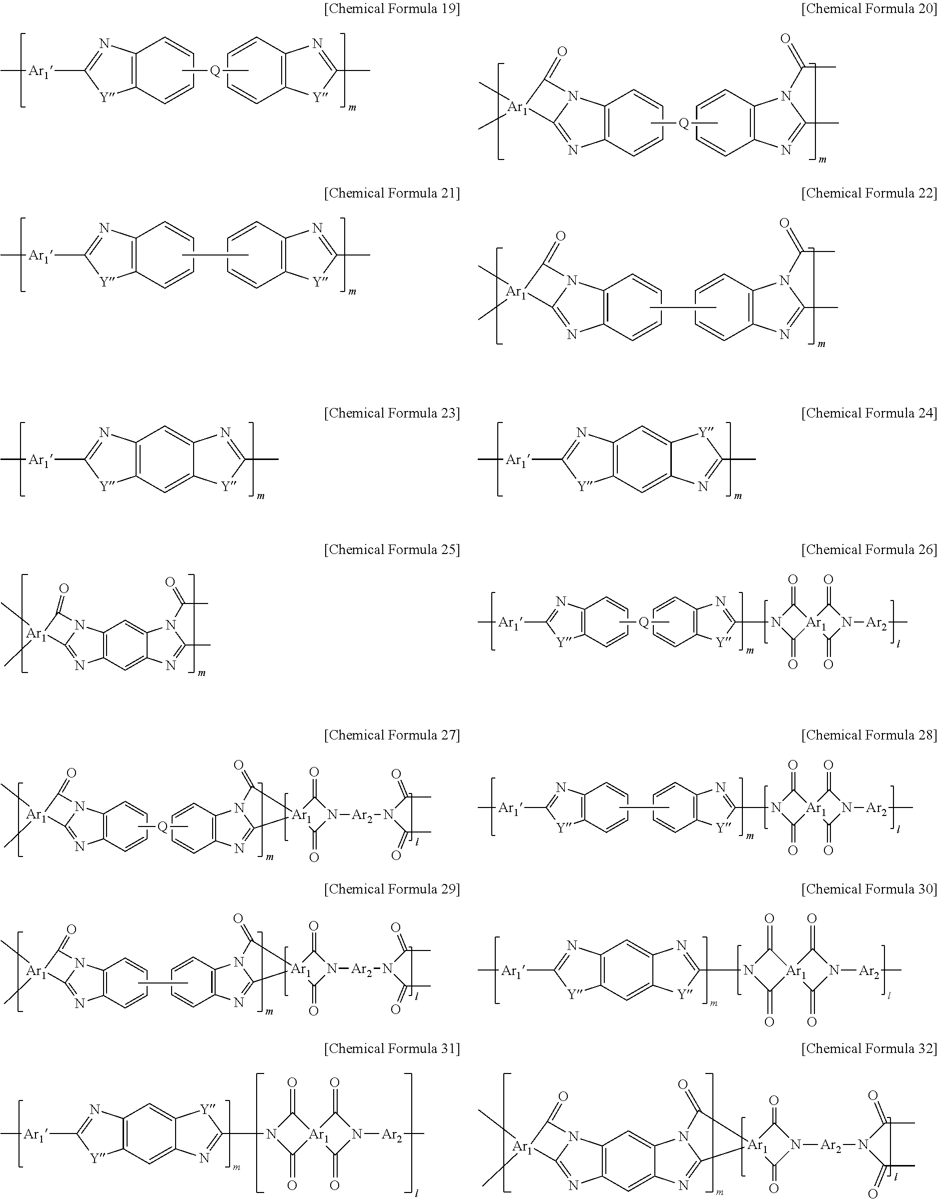

In the above Chemical Formulae 19 to 32,

Ar₁, Ar₂, Q, n, m, and l are the same as Ar₁, Ar₂, Q, n, m, and l in the above Chemical Formulae 1 to 8,

Ar₁′ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH, and

Y″ is O or S.

Examples of Ar₁, Ar₂, and Q in the above Chemical Formulae 19 to 32 are the same as examples of Ar₁, Ar₂, and Q in the above Chemical Formulae 1 to 18.

In addition, examples of Ar₁′ in the above Chemical Formulae 19 to 32 is the same as examples of Ar₂ in the above Chemical Formulae 1 to 18.

In the above Chemical Formulae 19 to 32, Ar₁ may be a functional group represented by the above Chemical Formula A, B, or C, Ar₁′ may be a functional group represented by the following Chemical Formula F, G, or H, Ar₂ may be a functional group represented by the above Chemical Formula D or E, and Q may be C(CF₃)₂, but are not limited thereto.

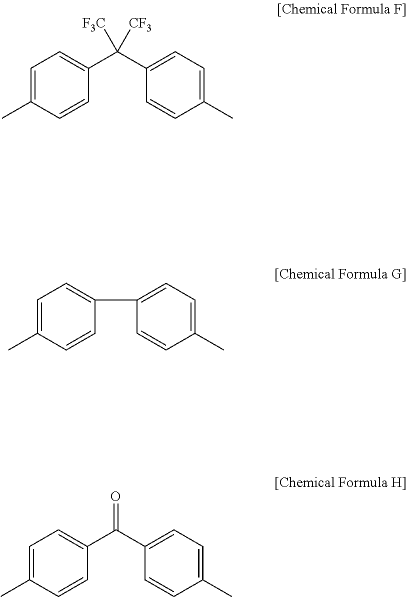

The polymer derived from polyamic acid or the polymer derived from a polyimide may be doped with an acid dopant. When it is doped with an acid dopant, the acid dopant may be presented in a pore of the polymer, and then the pore size and form of the polymer may be controlled, and thereby it is possible to control the physical properties of the polymer. For example, since the polymer is doped with an acid dopant, carbon dioxide permeability is decreased and carbon dioxide/methane is selectivity increased.

The doping with an acid dopant may be performed by impregnating the polymer with a solution including an acid dopant. It may be doped due to the hydrogen bond between an acid dopant and the polymer, but is not limited thereto.

The acid dopant includes one selected from the group consisting of sulfuric acid, hydrochloric acid, phosphoric acid, nitric acid, HBrO₃, HClO₄, HPF₆, HBF₆, 1-methyl-3-methylimidazolium cations (BMIM⁺), and a combination thereof, but is not limited thereto.

The polymer derived from polyamic acid or the polymer derived from a polyimide may further include an additive selected from the group consisting of fumed silica, zirconium oxide, an alkoxysilane such as tetraethoxysilane, montmorillonite clay, and a combination thereof, but is not limited thereto. Before processing a heat treatment that will be described hereinafter, the additive may be present in a dispersed condition in the polymer by mixing and agitating the polyamic acid or the polyimide in an organic solvent dispersed with the additive. Thereby, mechanical strength, heat resistance, and chemical resistance of the polymer may be improved.

The additive may be included in an amount about 0.1 to about 10 wt % based on the total weight of the polymer including the additive. When the additive is included within the above amount range, mechanical strength, heat resistance, and chemical resistance of the polymer may be effectively improved.

The polymer derived from polyamic acid or polyimide may further include an inorganic filler selected from the group consisting of a phosphotungstic acid (PWA), a phosphomolybdic acid, a silicotungstic acid (SiWA), a molybdophosphoric acid, a silicomolybdic acid, a phosphotin acid, zirconium phosphate (ZrP), and combinations thereof, but is not limited thereto. The inorganic filler may be presented in pores of the polymer by impregnating the polymer with a solution including the inorganic filler. The inorganic filler may form a bond such as a hydrogen bond with the polymer, but is not limited thereto.

It is possible to control the pore size and form of the polymer, and therefore physical properties of the polymer may be controlled, and mechanical strength, heat resistance, and chemical resistance of the polymer may be improved.

The inorganic filler may be included in an amount about 0.5 to about 60 wt % based on the total weight of the polymer including the inorganic filler. When the inorganic filler is included within the above amount ranges, mechanical strength, heat resistance, and chemical resistance of the polymer may be effectively improved.

The polymer derived from polyamic acid or a polyimide may be prepared by using polyamic acid or a polyimide that are soluble in a general organic solvent and may be coated without defects or cracks, and therefore it may reduce manufacturing costs by simplify the preparation process and may be formed with a large size. The pore size or distribution of the polymer is adjustable by controlling the preparation process condition. Accordingly, the polymer may be widely used in various areas such as gas permeability, gas separation, vapor separation, water purifying, an adsorption agent, a heat resistance fiber, a thin film, and the like.

In another embodiment, a polymer may be derived from the combinations of polyamic acid and polyimide, and the polymer may include the polymer derived from polyamic acid and the polyimide. Hereinafter, polyamic acid, a polyimide, and a polymer derived from polyamic acid or the polyimide are the same as described above.

The polymer may include a polymer derived from polyamic acid or a polyimide polymer in a weight ratio of about 0.1:9.9 to about 9.9:0.1, and in one embodiment, about 8:2 to about 2:8, and more preferably, about 5:5. The polymer may have each characteristics of a polymer derived from polyamic acid or the polyimide. It is also has excellent dimensional stability and long-term stability.

In another embodiment, a method of preparing a polymer including obtaining the polyimide by imidization of polyamic acid and heat-treating the polyimide is provided. The polymer may have picopores. The polymer may include compounds including a repeating unit represented by one of the above Chemical Formulae 19 to 32, or copolymers thereof, but is not limited thereto.

In the preparing method of the polymer, the imidization may include thermal imidization, but is not limited thereto.

The thermal imidization may be performed at about 150° C. to 300° C. for about 30 minutes to 2 hours under an inert atmosphere. When the imidization temperature is below the range, polyamic acid as a precursor is only slightly imidized, and on the other hand, when the imidization temperature exceeds this range, significant effects cannot be obtained and economic efficiency is thus very low.

The imidization conditions may be suitably controlled within the range according to the functional groups of the polyamic acid, Ar₁, Ar₂, Q, Y, and Y′.

The polymer including picopores may be obtained by thermal rearrangement of the polyimide through a heat-treatment. The polymer including picopores may have decreased density comparing with the polyimide, increased fractional free volume caused by good connection between picopores, and increased d-spacing. Thereby, the polymer including picopores may have excellent low molecular permeability, and is applicable for selective separation of low molecules.

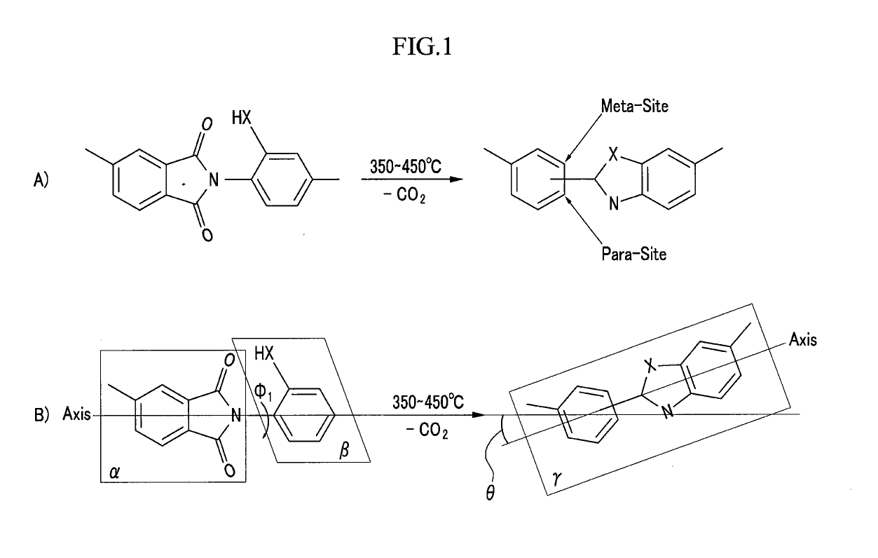

The thermal rearrangement of the polyimide will be described referring to FIG. 1.

FIG. 1 shows two types of changes in a chain structure occurring during the thermal rearrangement.

Referring to FIG. 1, A) shows random chain formations resulting from the formation of meta- and para-linked chains, and B) shows relatively flexible, twisting pairs of short flat planes (α and β) that convert to single long flat planes (γ). The single long flat planes (γ) are much more stiff and rigid than twisting pairs of short flat planes (α and β) because it forms a stable resonance. Accordingly, the polymer including picopores prepared by heat treatment of the polyimide may prevents torsional rotation inside of a chain, increasing the efficiency of picopores formation, and inhibiting rapid collapse of the created picopores. The polymer may effectively include a plurality of picopores, and thereby the low molecules may be permeated effectively or separated selectively. The polymer may have excellent mechanical strength, heat resistance, and chemical resistance.

Hereinafter, the imidization and heat treatment will be illustrated in detail with reference to the following Reaction Schemes 1 and 2.

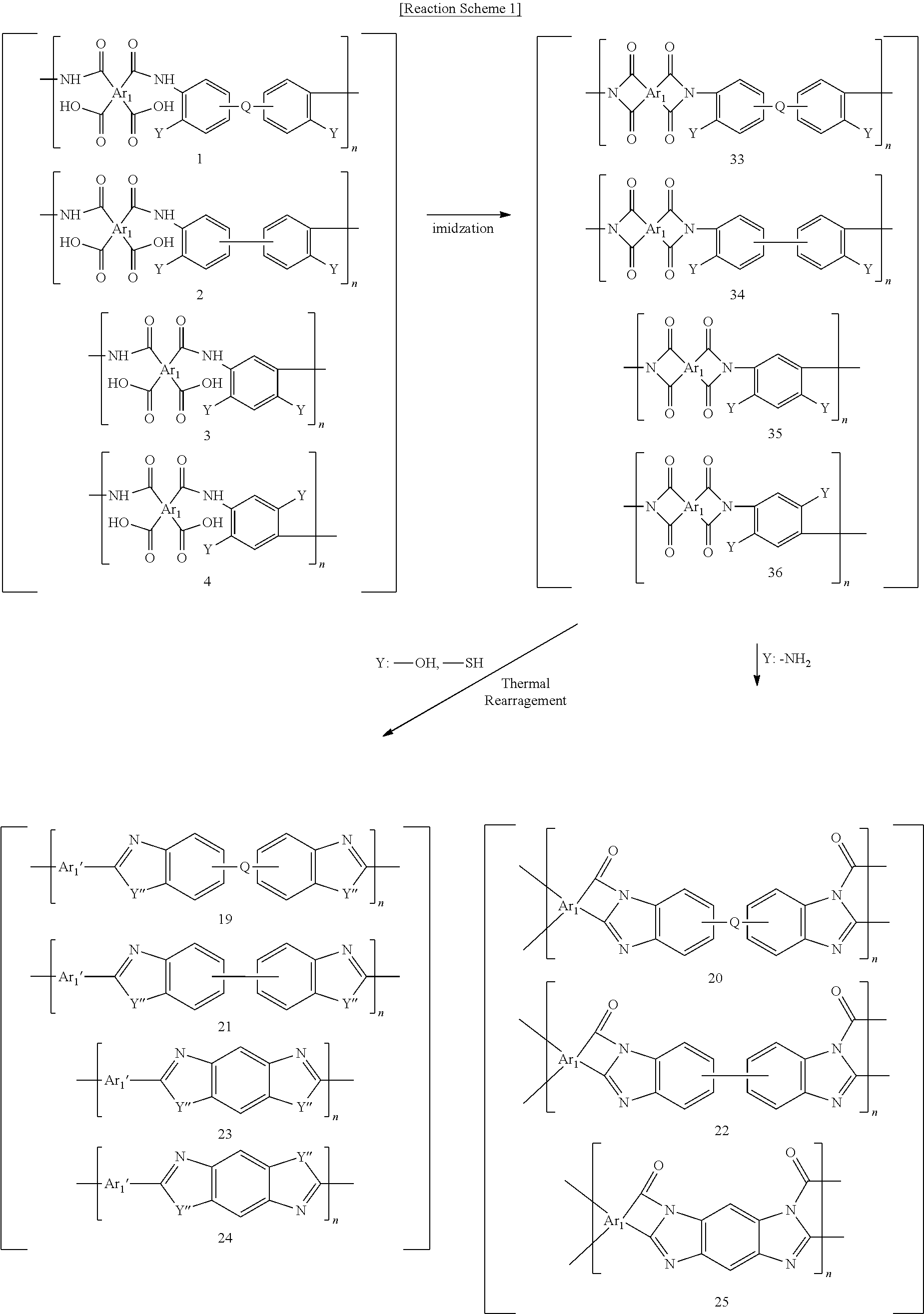

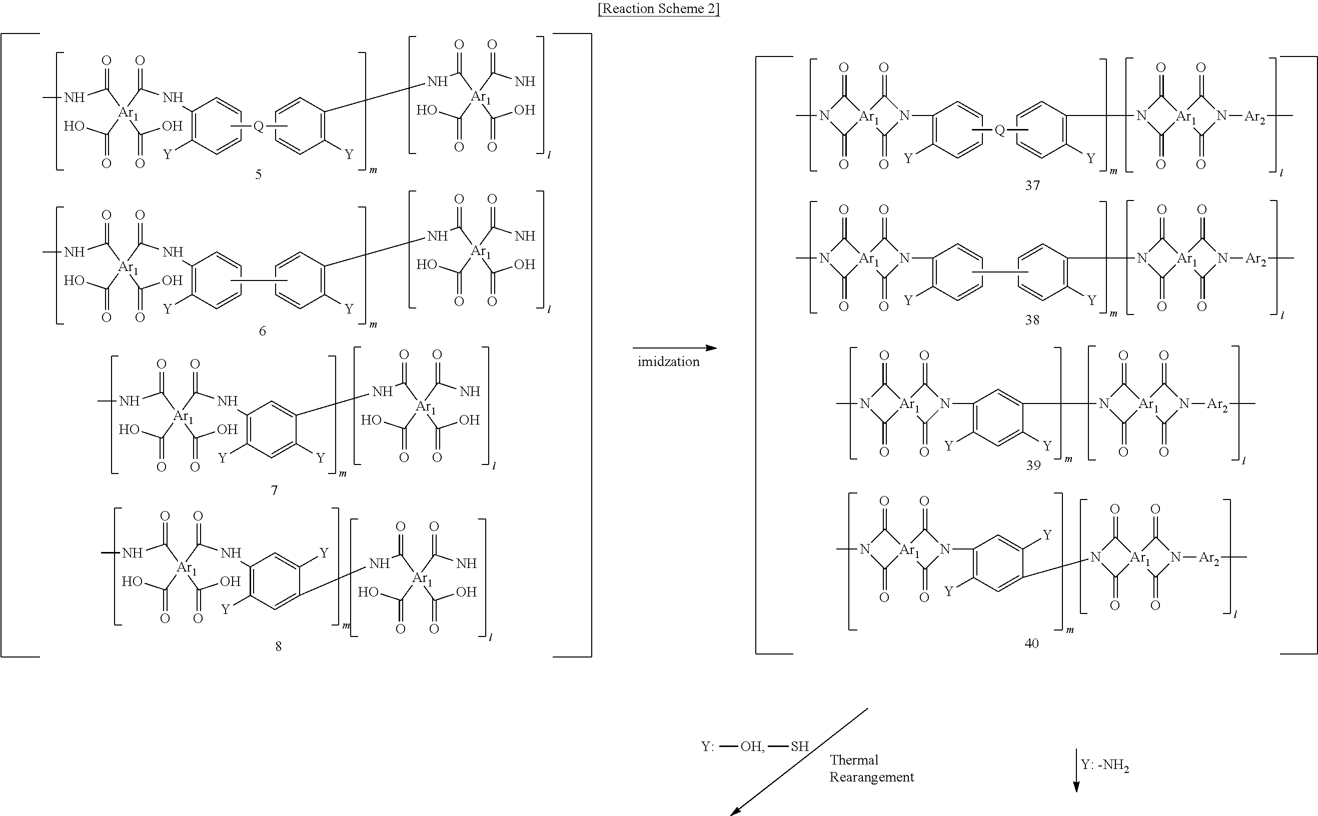

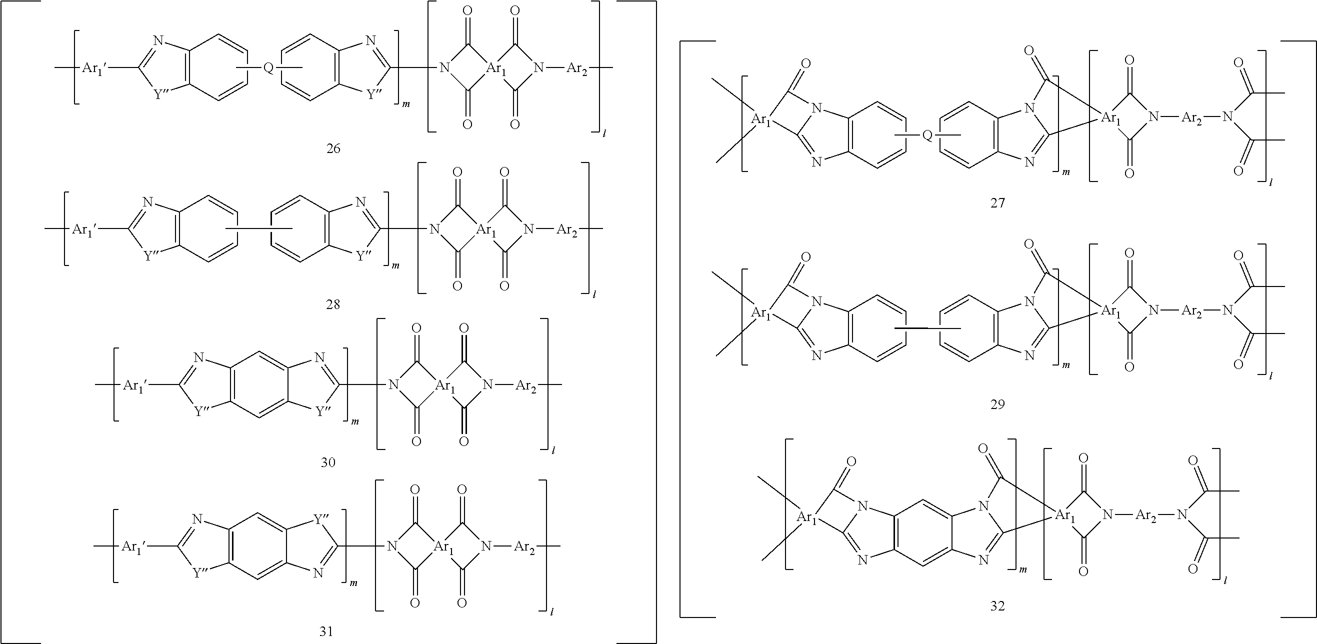

In the Reaction Schemes 1 and 2,

Ar₁, Ar₁′, Ar₂, Q, Y, Y″, n, m, and l are the same as defined in the above Chemical Formulae 1 to 50.

Referring to the Reaction Scheme 1, the polyamic acid including a repeating unit represented by the above Chemical Formulae 1 to 4 is subjected to imidization as described above to form a polyimide including a repeating unit represented by the above Chemical Formulae 33, 34, 35, and 36.

Subsequently, the polyimide including a repeating unit represented by the above Chemical Formulae 33 to 36, respectively, is converted into a polybenzoxazole, polybenzthiazole, or polypyrrolone polymer including a repeating unit represented by Chemical Formulae 19 to 25, respectively, through heat treatment. The polymer preparation is carried out through the removal reaction of CO₂ or H₂O present in the polyimide polymers including repeating units of Chemical Formulae 33 to 36.

The polyhydroxyamic acids in which Y of Chemical Formulae 1 to 4 is —OH or the polythiolamic acids in which Y of Chemical Formulae 1 to 4 is —SH are thermally rearranged into polybenzoxazole (Y″═O) or polybenzthiazole (Y″═S) including repeating units of Chemical Formula 19, Chemical Formula 21, Chemical Formula 23, and Chemical Formula 24, respectively. In addition, polyaminoamic acids in which Y of Chemical Formulae 1 to 4 is —NH₂ are thermally rearranged into polypyrrolones including repeating units of Chemical Formulae 20, 22, and 25.

As shown in Reaction Scheme 2, polyamic acid copolymers including repeating units of Chemical Formulae 5 to 8 are converted through imidization into polyimides including repeating units of Chemical Formulae 37 to 40.

Through the above-described thermal heat treatment, the polyimides including repeating units of the above Chemical Formulae 37 to 40 are converted through the removal reaction of CO₂ or H₂O present in the polyimides into polymers including repeating units of Chemical Formulae 26 to 32.

Polyhydroxyamic acids in which Y of Chemical Formulae 5 to 8 is —OH or polythiolamic acids in which Y of Chemical Formulae 5 to 8 is —SH are thermally rearranged into poly(benzoxazole(Y″═O)-imide) copolymers or poly(benzthiazole(Y″═S)-imide) copolymers including repeating units of Chemical Formulae 26, 28, 30, and 31. In addition, polyaminoamic acids (Y═NH₂) represented by the above Chemical Formulae 5 to 8 are thermally rearranged into poly(pyrrolone-imide) copolymers including repeating units represented by Chemical Formula 27, 29, and 32, respectively.

Each block of the polyamic acid copolymers including repeating units represented by Chemical Formulae 9 to 18 is imidized to form a polyimide including blocks that are different from each other. The resulting each block of the polyimide are thermally rearranged into polybenzoxazole, polybenzothiazole, and polypyrrolone, depending upon the kinds of Y to form copolymers of polymers including repeating units represented by Chemical Formulae 19 to 25.

Another embodiment of the present invention provides a method of preparing a polymer including heat-treating of the polyimide. The polymer includes picopores. The polymer may include compounds including a repeating unit represented by the above Chemical Formulae 19 to 32 or copolymers thereof, but is not limited thereto.

The heat treatment, the thermal convertion, and the rearrangement are the same as above as long as they are not differently described hereinafter.

The polyimide may be prepared by imidization of polyamic acid including a repeating unit obtained from an aromatic diamine including at least one ortho-positioned functional group with respect to an amine group and a dianhydride, for example chemical imidization or thermal solution imidization.

The chemical imidization may be performed at about 20° C. to about 180° C. for about 4 hours to about 24 hours. Pyridine as a catalyst and acetic anhydride to remove produced water may be added. When the chemical imidization is performed in the above temperature range, imidization of polyamic acid may be sufficiently performed.

The chemical imidization may be performed after protecting ortho-positioned functional groups OH, SH, and NH₂ with respect to the amine group in the polyamic acids. That is, a protecting group for functional groups OH, SH, and NH₂ are introduced, and the protecting group is removed after imidization. The protecting group may be introduced by a chlorosilane such as trimethylchlorosilane ((CH₃)₃SiCl), triethylchlorosilane ((C2H₅)₃SiCl), tributyl chlorosilane ((C4H₉)₃SiCl), tribenzyl chlorosilane ((C6H₅)₃SiCl), triethoxy chlorosilane ((C2H₅O)₃SiCl), and the like, or a hydrofuran such as tetrahydrofuran (THF). For the base, tertiary amines such as trimethyl amine, triethyl amine, tripropyl amine, pyridine, and the like may be used. For removing the protecting group, diluted hydrochloric acid, sulfuric acid, nitric acid, acetic acid, and the like may be used. The chemical imidization using the protecting group may improve yield and molecular weight of the polymer according to one embodiment of the present invention.

The solution-thermal imidization may be performed at about 100° C. to about 180° C. for about 2 to about 30 hours in a solution. When the thermal solution imidization is performed within the above temperature range, polyamic acid imidization may be sufficiently realized.

The thermal solution imidization may be performed after protecting ortho-positioned functional groups OH, SH, and NH₂ with respect to the amine group in the polyamic acids. That is, a protecting group for functional groups OH, SH, and NH₂ is introduced, and the protecting group is removed after imidization. The protecting group may be introduced by a chlorosilane such as trimethylchlorosilane, triethylchlorosilane, tributyl chlorosilane, tribenzyl chlorosilane, triethoxy chlorosilane, and the like, or a hydrofuran such as tetrahydrofuran. For the base, tertiary amines such as trimethyl amine, triethyl amine, tripropyl amine, pyridine, and the like may be used. For removing the protecting group, diluted hydrochloric acid, sulfuric acid, nitric acid, acetic acid, and the like may be used.

The thermal solution imidization may be performed using an azeotropic mixture that further includes benzenes such as benzene, toluene, xylene, cresol, and the like, aliphatic organic solvents such as hexane, and alicyclic organic solvents such as cyclohexane and the like.

The thermal solution imidization using the protecting group and azeotropic mixture may also increase yield and molecular weight of the polymer according to one embodiment of the present invention.

The imidization condition can be controlled in accordance with the functional groups Ar₁, Ar₂, Q, Y, and Y′ of the polyamic acid.

The imidization reaction will be described in more detail referring to the following Reaction Schemes 3 and 4.

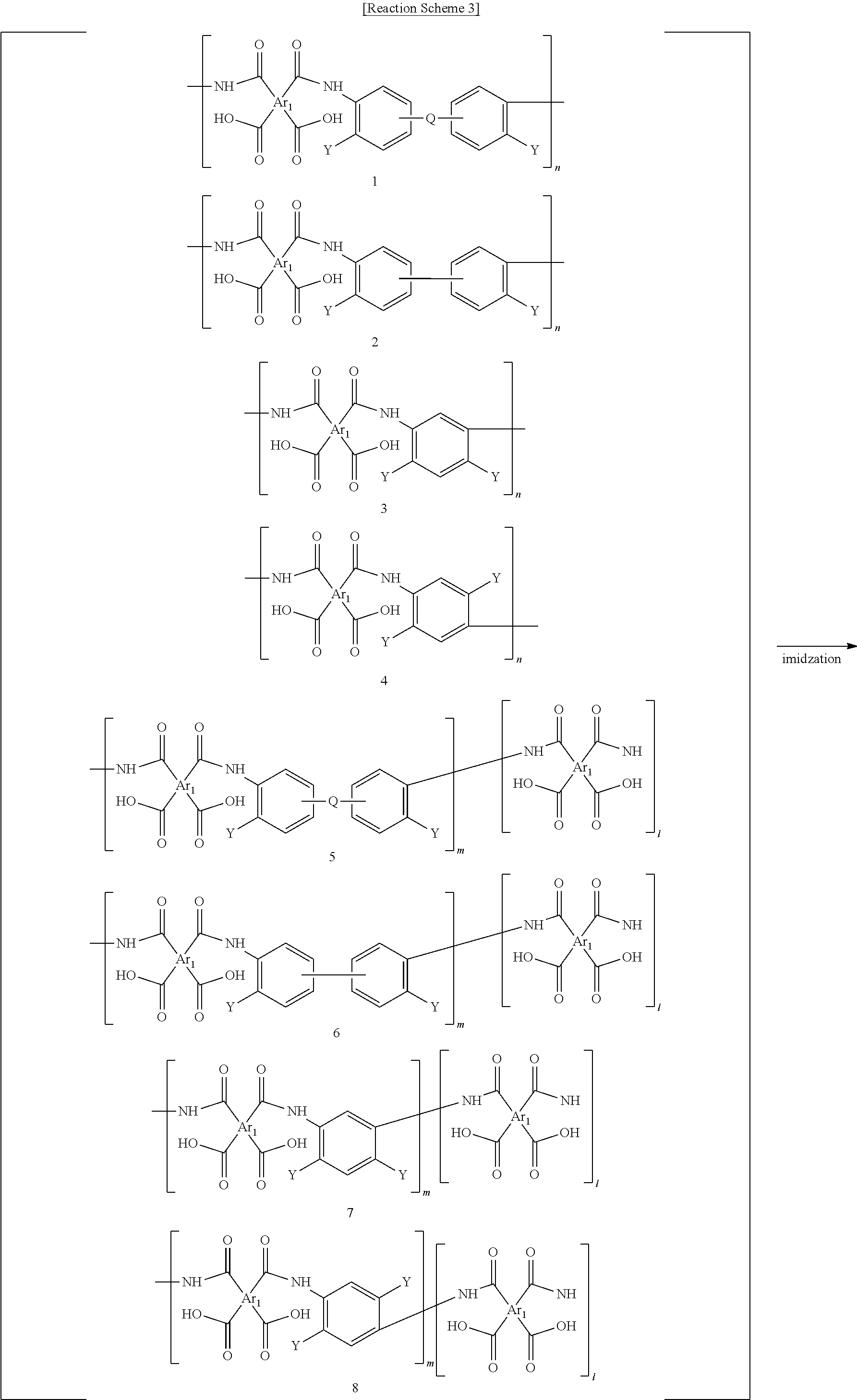

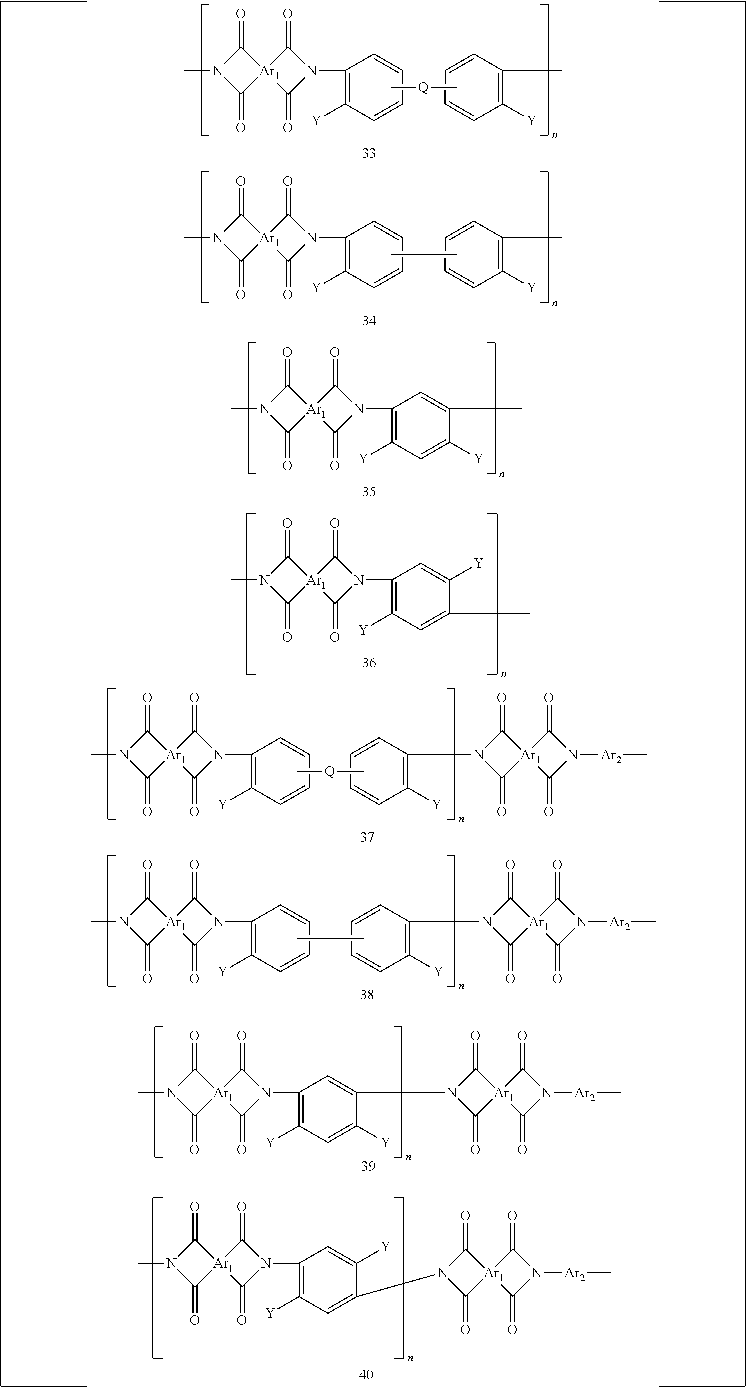

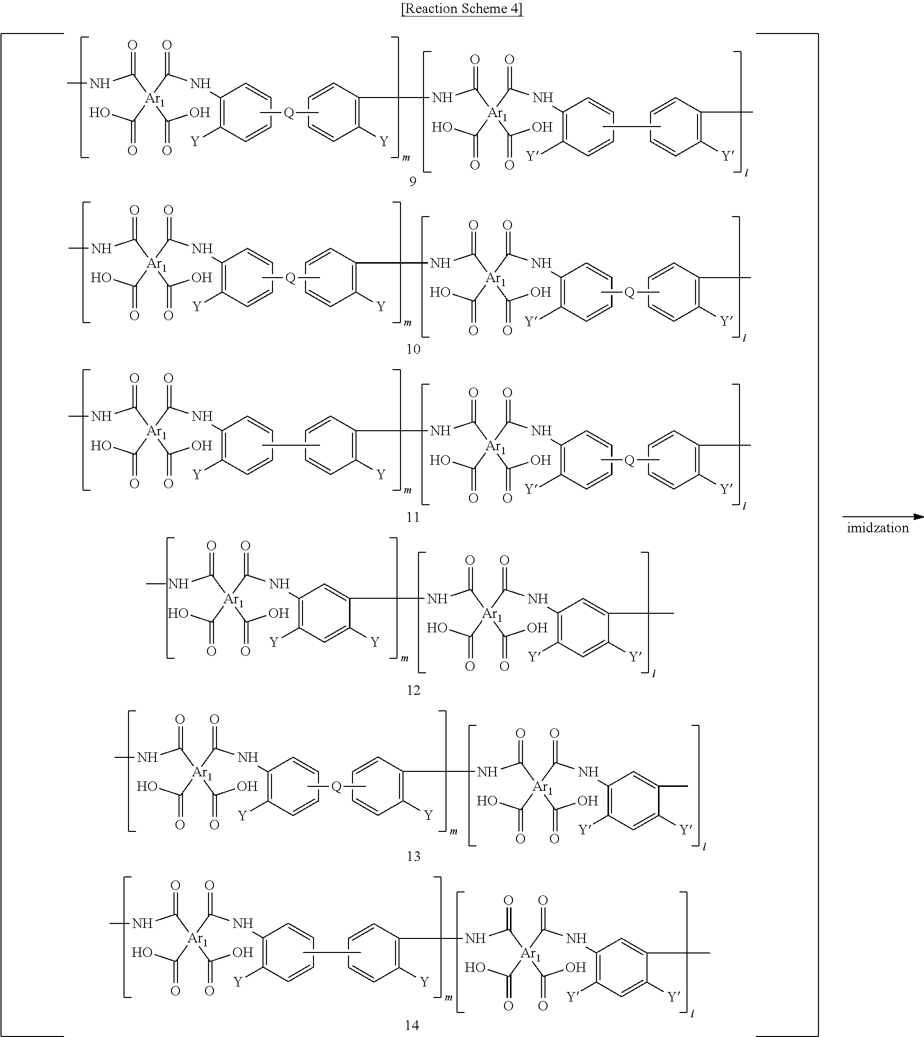

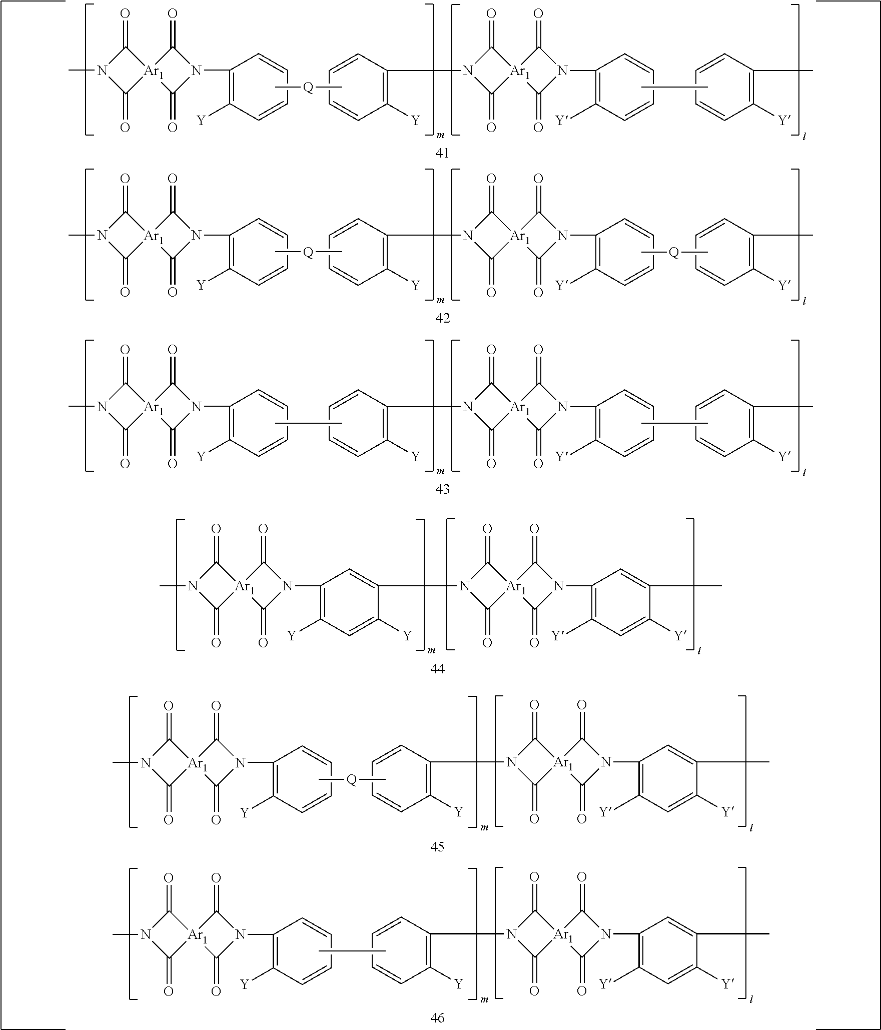

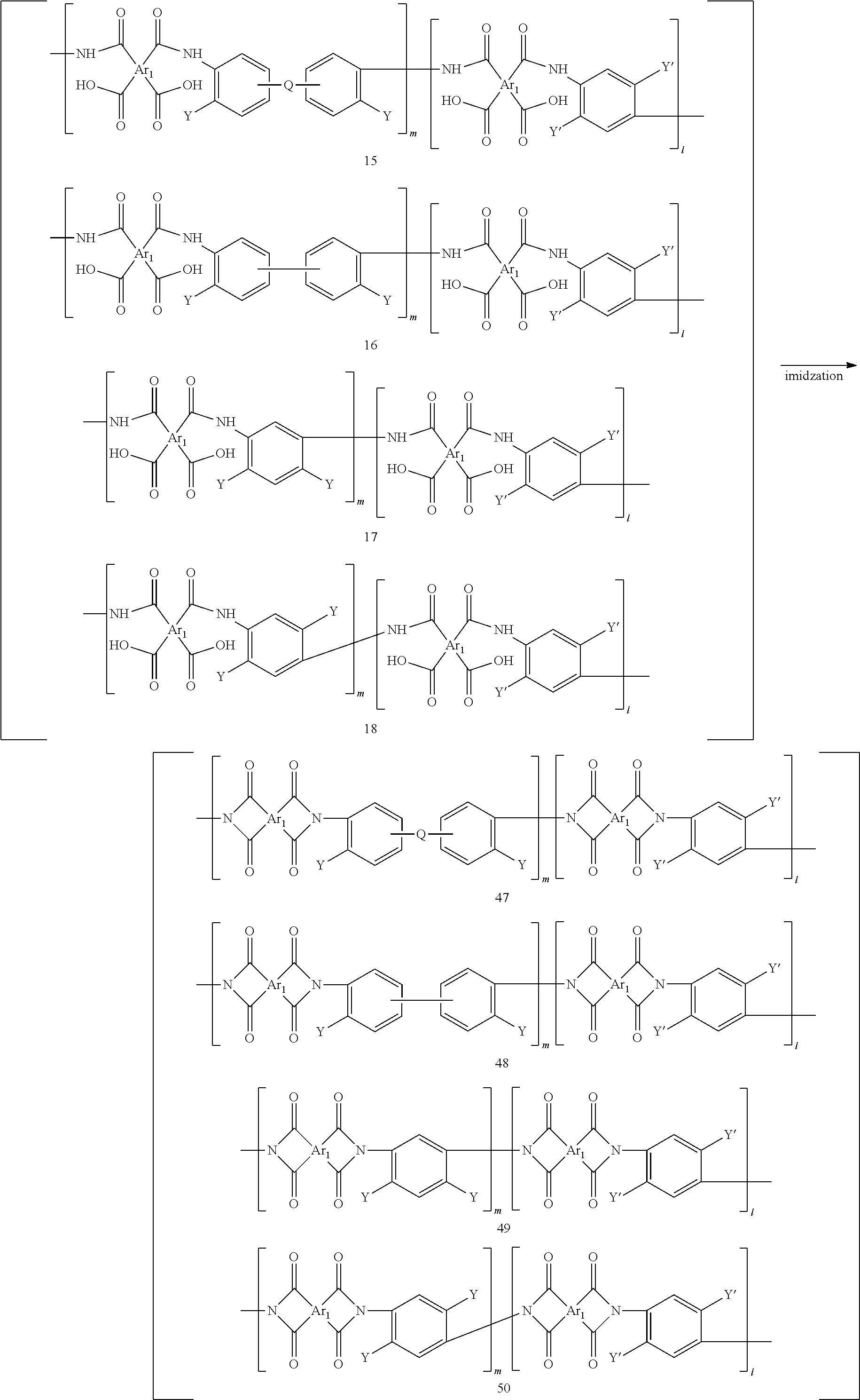

In Reaction Schemes 3 and 4,

Ar₁, Ar₂, Q, Y, Y′, n, m, and l are the same as in the above Chemical Formulae 1 to 18.

As shown in Reaction Scheme 3, polyamic acids (polyhydroxyamic acid, polythiolamic acid, or polyaminoamic acid) including a repeating unit represented by Chemical Formula 1, Chemical Formula 2, Chemical Formula 3, and Chemical Formula 4 are converted through imidization, i.e., a cyclization reaction, into polyimides including a repeating unit represented by Chemical Formula 33, Chemical Formula 34, Chemical Formula 35, and Chemical Formula 36, respectively.

In addition, polyamic acid copolymers including a repeating unit represented by Chemical Formula 5, Chemical Formula 6, Chemical Formula 7, and Chemical Formula 8 are converted through imidization into polyimide copolymers including a repeating unit represented by Chemical Formula 37, Chemical Formula 38, Chemical Formula 39, and Chemical Formula 40, respectively.

As shown in Reaction Scheme 4, polyamic acid copolymers including a repeating unit represented by Chemical Formulae 9 to 18 are converted through imidization into polyimide copolymers including a repeating unit represented by Chemical Formulae 41 to 50.

Still another embodiment of the present invention provides a method of preparing a polymer including obtaining a polyimide by imidization of the polyamic acid that is from the compound including combinations of the polyamic acid and the polyimide, and heat-treating the polyimide. The polymer includes picopores. The polymer may include a compound including a repeating unit represented by the above Chemical Formulae 19 to 32 or copolymers thereof, but is not limited thereto.

The imidization, the heat treatment, the thermal convertion, and the rearrangement are the same as above as long as they are not differently described hereinafter.

The heat treatment may be performed by increasing the temperature by about 1° C./min to about 30° C./min up to about 350° C. to about 500° C., and then maintaining the temperature for about 1 minute to about 12 hours under an inert atmosphere. Preferably, the heat treatment may performed by increasing the temperature by about 5° C./min to about 20° C./min up to about 350° C. to about 450° C., and then maintaining the temperature for about 1 hour to about 6 hours under an inert atmosphere. More preferably, the heat treatment may performed by increasing the temperature by about 10° C./min to about 15° C./min up to about 420° C. to about 450° C., and then maintaining the temperature for about 2 hours to about 5 hours under an inert atmosphere. When the heat treatment is performed under the condition within the above range, thermally rearranged reaction may be sufficiently performed.

During the preparation process of the polymer, by controlling polymer design while taking into consideration the characteristics of Ar₁, Ar₁′, Ar₂, and Q present in the chemical structure, pore size, distribution, and related characteristics may be controlled.

The polymer may include the compounds including a repeating unit represented by the above Chemical Formulae 19 to 32 or copolymers thereof, but is not limited thereto.

The polymers of the present invention can endure not only mild conditions, but also stringent conditions such as a long operation time, acidic conditions, high humidity, and high temperature, due to rigid backbones present in the polymers. The polymer according to the embodiment has excellent chemical stability, heat resistance, and mechanical properties.

The polymers including a repeating unit represented by Chemical Formulae 19 to 32 or copolymers thereof are designed to have a desired weight average molecular weight, and in one embodiment, a weight average molecular weight of about 10,000 to about 200,000. When they have weight average molecular weight within the above range, it may maintain excellent physical properties of the polymers.

The polymer according to one embodiment of the present invention is a polymer derived from polyamic acid or a polyimide, and may include picopores. The picopores have an hourglass-shaped structure forming a narrow valley at connection parts of at least two picopores, and thereby have high fractional free volume to effectively permeate or selectively separate low molecules.

Further, the polymer has excellent dimensional stability with respect to having less than 5% of shrinkage after imidization and heat treatment.

Yet another embodiment of the present invention may provide an article including the polymer. The article includes a sheet, a film, a powder, a membrane, or a fiber.

The article includes picopores that form a three-dimensional network structure where at least two picopores are three-dimensionally connected to have an hourglass-shaped structure forming a narrow valley at connection parts. The article may effectively permeate or selectively separate low molecules, may have excellent heat resistance, surface hardness, and dimensional stability, and therefore it may be widely applied to many areas where this performance needed.

Hereinafter, preferred examples will be provided for further understanding of the invention. These examples are for illustrative purposes only and are not intended to limit the scope of the present invention.

### EXAMPLES

### Example 1

### Preparation of a Polymer

As shown in Reaction Scheme 5 below, a polymer including polybenzoxazole including a repeating unit represented by the following Chemical Formula 51 was prepared from polyhydroxyamic acid.

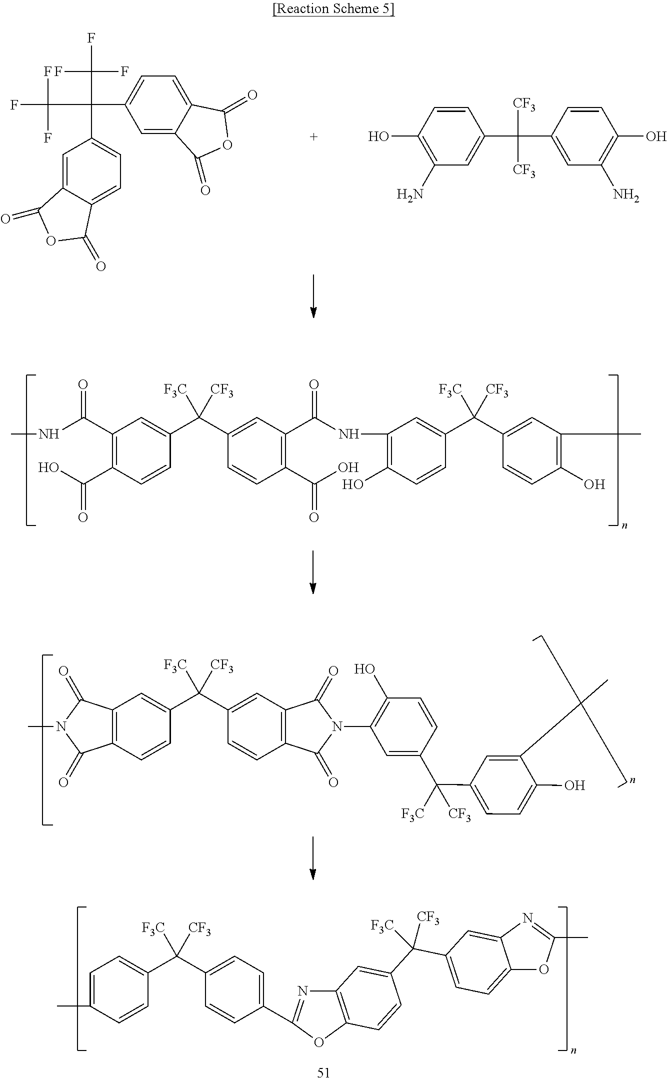

(1) Preparation of Polyhydroxyamic Acid

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride was added into 45.9 g (85 wt %) of N-methylpyrrolidone (NMP). Then, the solution was allowed to react at 15° C. for 4 hours to prepare a pale yellow viscous polyhydroxyamic acid solution.

(2) Preparation of Polyhydroxyimide

The prepared viscous polyhydroxyamic acid solution was cast on a glass plate 20 cm×25 cm in size, and cured and imidized in a vacuum oven at 100° C. for 2 hours, at 150° C. for 1 hour, at 200° C. for 1 hour, and at 250° C. for 1 hour. Then, vacuum drying was carried out in a vacuum oven at 60° C. for 24 hours in order to completely remove the residual solvent. Consequently, a transparent pale yellow polyhydroxyimide membrane was prepared. The thickness of the prepared membrane including polyhydroxyimide was 30 pm.

(3) Preparation of a Polymer Including Polybenzoxazole

The polyhydroxyimide membrane was thermally treated in the muffled tubular furnace at 350° C. at a heating rate of 5° C./min under an argon atmosphere (300 cm³[STP]/min), and was held for 1 hour at 350° C. Then, it was cooled down slowly to room temperature to prepare a polymer including polybenzoxazole including a repeating unit represented by the above Chemical Formula 51.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.18 and d-spacing of 580 pm.

### Example 2

### Preparation of a Polymer

A polymer including polybenzoxazole including a repeating unit represented by the above Chemical Formula 51 was prepared in the same manner as in Example 1, except that the polyhydroxyimide membrane was thermally treated at 400° C.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.22 and d-spacing of 592 pm.

### Example 3

### Preparation of a Polymer

A polymer including polybenzoxazole including a repeating unit represented by the above Chemical Formula 51 was prepared in the same manner as in Example 1, except that the polyhydroxyimide membrane was thermally treated at 450° C.

As a result of FT-IR analysis, characteristic bands of the resulting polybenzoxazole at 1553 cm⁻¹, 1480 cm⁻¹ (C═N), and 1052 cm⁻¹ (C—O) which were not detected in polyhydroxyimide were confirmed. The prepared polymer had a fractional free volume of 0.28 and d-spacing of 600 pm.

### Example 4

### Preparation of a Polymer

A polymer including polybenzoxazole including a repeating unit represented by the above Chemical Formula 51 was prepared in the same manner as in Example 1, except that the polyhydroxyimide membrane was thermally treated at 500° C.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.37 and d-spacing of 740 pm.

### Example 5

### Preparation of a Polymer

A polymer including polybenzoxazole including a repeating unit represented by the following Chemical Formula 52 was prepared according to the following reaction from polyhydroxyamic acid.

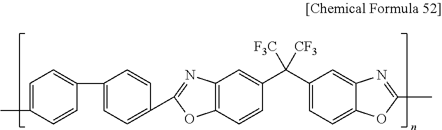

A polymer including polybenzoxazole including a repeating unit represented by the above Chemical Formula 52 was prepared in the same manner as in Example 3, except that 3.66 g (10 mmol) of 2,2-bis(3-amino-4-hydroxyphenyl)hexafluoropropane and 2.94 g (10 mmol) of 3,3′,4,4′-biphenyltetracarboxylic dianhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.219 and d-spacing of 606 pm.

### Example 6

### Preparation of a Polymer

A polymer including polybenzoxazole including a repeating unit represented by the following Chemical Formula 53 was prepared according to the following reaction from polyhydroxyamic acid.

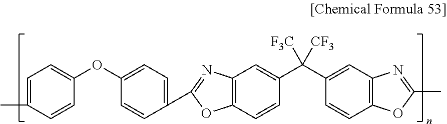

A polymer including polybenzoxazole including a repeating unit represented by the above Chemical Formula 53 was prepared in the same manner as in Example 3, except that 3.66 g (10 mmol) of 2,2-bis(3-amino-4-hydroxyphenyl)hexafluoropropane and 3.1 g (10 mmol) of 4,4′-oxydiphthalic anhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.205 and d-spacing of 611 pm.

### Example 7

### Preparation of a Polymer

A polymer including polybenzoxazole including a repeating unit represented by the following Chemical Formula 54 was prepared according to the following reaction from polyhydroxyamic acid.

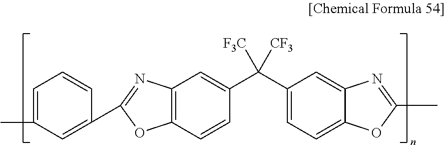

A polymer including polybenzoxazole including a repeating unit represented by the above Chemical Formula 54 was prepared in the same manner as in Example 3, except that 3.66 g (10 mmol) of 2,2-bis(3-amino-4-hydroxyphenyl)hexafluoropropane and 2.18 g (10 mmol) of 1,2,4,5-benzenetetracarboxylic dianhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.190 and d-spacing of 698 pm.

### Example 8

### Preparation of a Polymer

A polymer including polybenzoxazole including a repeating unit represented by the following Chemical Formula 55 was prepared according to the following reaction from polyhydroxyamic acid.

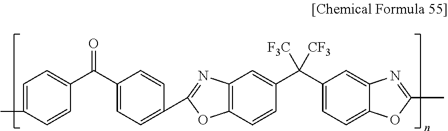

A polymer including polybenzoxazole including a repeating unit represented by the above Chemical Formula 55 was prepared in the same manner as in Example 3, except that 3.66 g (10 mmol) of 2,2-bis(3-amino-4-hydroxyphenyl)hexafluoropropane and 3.22 g (10 mmol) of 3,3′,4,4′-benzophenonetetracarboxylic dianhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.243 and d-spacing of 602 pm.

### Example 9

### Preparation of a Polymer

A polymer including polybenzothiazole including a repeating unit represented by the following Chemical Formula 56 was prepared according to the following reaction from polythiolamic acid.

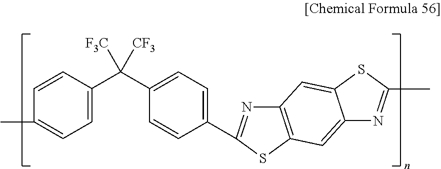

A polymer including polybenzothiazole including a repeating unit represented by the above Chemical Formula 56 was prepared in the same manner as in Example 3, except that 2.45 g (10 mmol) of 2,5-diamino-1,4-benzenedithiol dihydrochloride and 4.44 g (10 mmol) of 4,4′-(hexafluoroisopropylidene)diphthalic anhydride were reacted as a starting material to prepare a polyamic acid including a thiol group (—SH).

As a result of FT-IR analysis, characteristic bands of the resulting polybenzothiazole at 1484 cm⁻¹ (C—S) and 1404 cm⁻¹ (C—S) which were not detected in polythiolimide were confirmed. The prepared polymer had a fractional free volume of 0.262 and d-spacing of 667 pm.

### Example 10

### Preparation of a Polymer

A polymer including polypyrrolone including a repeating unit represented by the following Chemical Formula 57 was prepared according to the following reaction from polyaminoamic acid.

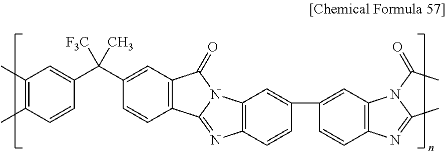

A polymer including polypyrrolone including a repeating unit represented by the above Chemical Formula 57 was prepared in the same manner as in Example 3, except that 2.14 g (10 mmol) of 3,3′-diaminobenzidine and 4.44 g (10 mmol) of 4,4′-(hexafluoroisopropylidene)diphthalic anhydride were reacted as a starting material to prepare a polyamic acid including an amine group (—NH₂).

As a result of FT-IR analysis, characteristic bands of the resulting polypyrrolone at 1758 cm⁻¹ (C═O) and 1625 cm⁻¹ (C═N) which were not detected in polyaminoimide were confirmed. The prepared polymer had a fractional free volume of 0.214 and d-spacing of 635 pm.

### Example 11

### Preparation of a Polymer

A polymer including polybenzoxazole including a repeating unit represented by the following Chemical Formula 58 was prepared according to the following reaction from polyhydroxyamic acid.

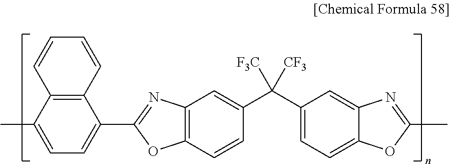

A polymer including polybenzoxazole including a repeating unit represented by the above Chemical Formula 58 was prepared in the same manner as in Example 3, except that 3.66 g (10 mmol) of 2,2-bis(3-amino-4-hydroxyphenyl)hexafluoropropane and 2.68 g (10 mmol) of 1,4,5,8-naphthaleic tetracarboxylic dianhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.326 and d-spacing of 699 pm.

### Example 12

### Preparation of a Polymer

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added to 32.4 g (80 wt %) of N-methylpyrrolidone (NMP), and intensively agitated for 4 hours. Subsequently, 3.22 ml (40 mmol) of pyridine as a catalyst for chemical imidization and 3.78 ml (40 mmol) of acetic anhydride were added to the solution. Then, the solution was allowed to react at room temperature for 24 hours to prepare a pale yellow viscous polyhydroxyimide solution. The pale yellow viscous polyhydroxyimide solution was agitated in triple-distilled water, and deposited to prepare a polymer powder. Then, the polymer powder was filtered and dried at 120° C.

The prepared polymer powder was dissolved in an amount of 20 wt % in an N-methylpyrrolidone (NMP) solution. The dissolved polyhydroxyimide solution was cast on a glass plate 20 cm×25 cm in size, and cured and imidized in vacuum oven at 180° C. for 6 hours. Then, vacuum drying was carried out in a vacuum oven at 60° C. for 24 hours in order to completely remove the residual solvent. Consequently, a transparent brown polyhydroxyimide membrane was prepared. The thickness of the prepared membrane including polyhydroxyimide was 40 μm.

The polyhydroxyimide membrane was thermally treated in a muffled tubular furnace at 450° C. at a heating rate of 10° C./min under an argon atmosphere (300 cm³[STP]/min), and was held for 1 hour at 450° C. Then, it cooled down slowly to room temperature to prepare a polymer including polybenzoxazole including a repeating unit represented by the above Chemical Formula 51.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.352 and d-spacing of 662 pm.

### Example 13

### Preparation of a Polymer

A polymer including polybenzoxazole including a repeating unit represented by the above Chemical Formula 51 was prepared in the same manner as in Example 12, except that 4.35 g (40 mmol) of trimethylchlorosilane was added before 3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were reacted.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.352 and d-spacing of 748 pm.

### Example 14

### Preparation of a Polymer

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added into 32.4 g (80 wt %) of N-methylpyrrolidone (NMP), and intensively agitated for 4 hours. A polymer including polybenzoxazole including a repeating unit represented by the above Chemical Formula 51 was prepared in the same manner as in Example 12, except that polyhydroxyimide was prepared by adding 32 ml of xylene as an azeotropic mixture, and removing the mixture of water and xylene by thermal solution imidization at 180° C. for 12 hours.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.222 and d-spacing of 595 pm.

### Example 15

### Preparation of a Polymer

A polymer including polybenzoxazole including a repeating unit represented by the above Chemical Formula 51 was prepared in the same manner as in Example 14, except that a membrane including polyhydroxyimide was heat-treated at 450° C. for 3 hours.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.26 and d-spacing of 602 pm.

### Example 16

### Preparation of a Polymer

A polymer including polybenzoxazole including a repeating unit represented by the above Chemical Formula 51 was prepared in the same manner as in Example 14, except that a membrane including polyhydroxyimide was heat-treated at 450° C. for 4 hours.

As a result of FT-IR analysis, characteristic bands of the resulting polybenzoxazole at 1553 cm⁻¹, 1480 cm⁻¹ (C═N) and 1052 cm⁻¹ (C—O) which were not detected in polyhydroxyimide were confirmed. The prepared polymer had a fractional free volume of 0.279 and d-spacing of 623 pm.

### Example 17

### Preparation of a Polymer

A polymer including polybenzoxazole including a repeating unit represented by the above Chemical Formula 51 was prepared in the same manner as in Example 14, except that a membrane including polyhydroxyimide was heat-treated at 450° C. for 5 hours.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.323 and d-spacing of 651 pm.

### Example 18

### Preparation of a Polymer

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added to 45.9 g (85 wt %) of N-methylpyrrolidone (NMP). Then, the solution was allowed to react at 15° C. for 4 hours to prepare a pale yellow viscous polyhydroxyamic acid solution.

The prepared viscous polyhydroxyamic acid solution was cast on a glass plate 20 cm×25 cm in size, and cured and imidized in vacuum oven at 100° C. for 2 hours, at 150° C. for 1 hour, at 200° C. for 1 hour, and at 250° C. for 1 hour. Then, vacuum drying was carried out in a vacuum oven at 60° C. for 24 hours in order to completely remove the residual solvent. Consequently, a transparent brownish polyhydroxyimide membrane was prepared. The thickness of the prepared membrane including polyhydroxyimide was 40 μm.

The polyhydroxyimide membrane was thermally treated in the muffled tubular furnace at 450° C. at a heating rate of 5° C./min under an argon atmosphere (300 cm³[STP]/min), and was held for 1 hour at 450° C. Then, it was cooled down slowly to room temperature to prepare a polybenzoxazole membrane.

The membrane including a polymer including the polybenzoxazole was treated in a 10M HCl solution for 1 hour and washed in distilled water, and then dried at 150° C. Thereby, a polymer including acid treated polybenzoxazole was prepared.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed, and a characteristic band of chlorine negative ions (Cl⁻) at 920 cm⁻¹ was confirmed.

### Example 19

### Preparation of a Polymer

A polymer including polybenzoxazole was prepared in the same manner as in Example 18, except adding a final process in which the polybenzoxazole membrane was treated in a 10M NaOH solution until the pH was set to 7.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. A characteristic band of chlorine negative ions (Cl⁻) at 920 cm⁻¹ was not confirmed. The prepared polymer had a fractional free volume of 0.261 and d-spacing of 597 pm.

### Example 20

### Preparation of a Polymer

A polymer including polybenzoxazole was prepared in the same manner as in Example 18, except adding two final processes in which the polybenzoxazole membrane was treated in a 10M NaOH solution until the pH was set to 7, and treated again in a 10M HCl solution for one hour and washed and dried at 150° C.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed, and a characteristic band of chlorine negative ions (Cl⁻) at 920 cm⁻¹ was confirmed.

### Example 21

### Preparation of a Polymer

A polymer including polybenzoxazole was prepared in the same manner as in Example 18, except that a 10M H₃PO₄ solution was used instead of a 10M HCl solution.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed, and a characteristic band of phosphoric acid negative ions (H₂PO₄⁻) at 1020 cm⁻¹ was confirmed.

### Example 22

### Preparation of a Polymer

A silica-dispersed solution at 5 wt % was fabricated via dispersion of fumed silica powder (Aerosil 200) with average particle size of 13 nm in N-methylpyrrolidone. Then, the silica disperse solution was added at a content of 1 wt % to the polyhydroxyamic acid solution in Example 3.

The polyhydroxyamic acid solution containing dispersed silica was cast on a glass plate 20 cm×25 cm in size and cured and imidized in vacuum oven for 2 hours at 100° C., 1 hour at 150° C., 1 hour at 200° C., and 1 hour at 250° C. Then, vacuum drying was carried out in a vacuum oven at 60° C. for 24 hours in order to completely remove the residual solvent. Consequently, a transparent brownish polyhydroxyimide membrane was obtained. The prepared membrane including polyhydroxyimide had a thickness of 30 μm.

The polyhydroxyimide membrane was thermally treated in the muffled tubular furnace at 450° C. at a heating rate of 10° C./min under an argon atmosphere (300 cm³[STP]/min), and was held for 1 hour at 450° C. Then, it was cooled down slowly to room temperature to prepare a polymer including polybenzoxazole.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.309 and d-spacing of 627 pm.

### Example 23

### Preparation of a Polymer

Zirconium phosphate-dispersed solution at 5 wt % was fabricated via dispersion of zirconium phosphate powder as a proton conductor in N-methylpyrrolidone. Then, the zirconium phosphate dispersed solution was added at a content of 20 wt % into the polyhydroxyamic acid solution of Example 3

The polyhydroxyamic acid solution including zirconium phosphate-dispersed was cast on a glass plate 20 cm×25 cm in size and cured and imidized in a vacuum oven for 2 hours at 100° C., 1 hour at 150° C., 1 hour at 200° C., and 1 hour at 250° C. Then, vacuum drying was carried out in a vacuum oven at 60° C. for 24 hours in order to completely remove the residual solvent. Consequently, a transparent brownish polyhydroxyimide membrane was obtained. The prepared membrane including polyhydroxyimide had a thickness of 35 pm.

The polyhydroxyimide membrane was thermally treated in a muffled tubular furnace at 450° C. at a heating rate of 10° C./min under an argon atmosphere (300 cm³[STP]/min), and was held for 1 hour at 450° C. Then, it was cooled down slowly to room temperature to prepare a polymer including polybenzoxazole.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.371 and d-spacing of 724 pm.

### Example 24

### Preparation of a Polymer

A polymer including polybenzoxazole including a repeating unit represented by the following Chemical Formula 59 was prepared according to the following reaction from polyhydroxyamic acid.

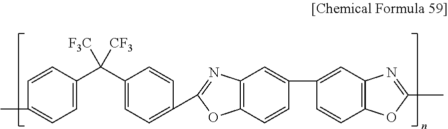

A polymer including polybenzoxazole including a repeating unit represented by the above Chemical Formula 59 was prepared in the same manner as in Example 3, except that 2.16 g (10 mmol) of 3,3′-dihydroxybenzidine and 4.44 g (10 mmol) of 4,4′-(hexafluoroisopropylidene)diphthalic anhydride were reacted as a starting material.

As a result of FT-IR analysis, characteristic bands of the resulting polybenzoxazole at 1553 cm⁻¹, 1480 cm⁻¹ (C═N), and 1052 cm⁻¹ (C—O) which were not detected in polyhydroxyimide were confirmed. The prepared polymer had a fractional free volume of 0.186 and d-spacing of 583 pm.

### Example 25

### Preparation of a Polymer

A polymer including polypyrrolone including a repeating unit represented by the following Chemical Formula 60 was prepared according to the following reaction from polyhydroxyamic acid.

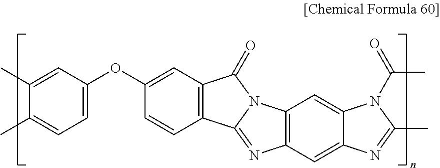

A polymer including polypyrrolone including a repeating unit represented by the above Chemical Formula 60 was prepared in the same manner as in Example 3, except that 2.84 g (10 mmol) of benzene-1,2,4,5-tetraamine tetrahydrochloride and 3.10 g (10 mmol) of 4,4′-oxydiphthalic anhydride were reacted as a starting material to prepare a polyamic acid including an amine-group (—NH₂).

As a result of FT-IR analysis, characteristic bands of the resulting polypyrrolone at 1758 cm⁻¹ (C═O) and 1625 cm⁻¹ (C═N), which were not detected in polyaminoimide were confirmed. The prepared polymer had a fractional free volume of 0.220 and d-spacing of 622 pm.

### Example 26

### Preparation of a Polymer

A polymer including a poly(benzoxazole-benzoxazole) copolymer including a repeating unit represented by the following Chemical Formula 61 was prepared according to the following reaction.

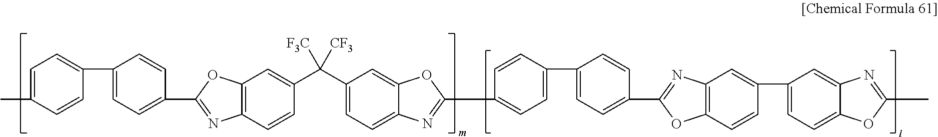

A polymer including a poly(benzoxazole-benzoxazole) copolymer (mole ratio, m:l, is 5:5) including a repeating unit represented by the above Chemical Formula 61 was prepared in the same manner as in Example 3, except that 3.66 g (10 mmol) of 2,2-bis(3-amino-4-hydroxyphenyl)hexafluoropropane, 2.16 g (10 mmol) of 3,3′-dihydroxybenzidine, and 5.88 g (20 mmol) of 3,3′,4,4′-biphenyltetracarboxylic anhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) which were not detected in polyhydroxyimide were confirmed. The prepared polymer had a fractional free volume of 0.237 and d-spacing of 609 pm.

### Example 27

### Preparation of a Polymer

A polymer including a poly(benzoxazole-imide) copolymer including a repeating unit represented by the following Chemical Formula 62 was prepared according to the following reaction.

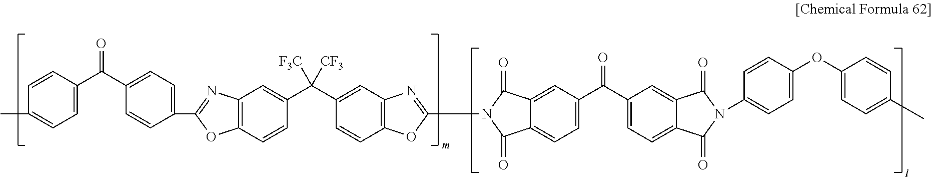

A polymer including a poly(benzoxazole-imide) copolymer (mole ratio, m:l, is 8:2) including a repeating unit represented by the above Chemical Formula 62 was prepared in the same manner as in Example 3, except that 5.86 g (16 mmol) of 2,2-bis(3-amino-4-hydroxyphenyl)hexafluoropropane, 0.8 g (4 mmol) of 4,4′-diaminodiphenylether and 6.45 g (20 mmol) of 3,3′,4,4′-benzophenonetetracarboxylic dianhydride were reacted as a starting material.

As a result of FT-IR analysis, characteristic bands of the resulting polybenzoxazole at 1553 cm⁻¹, 1480 cm⁻¹ (C═N), and 1058 cm⁻¹ (C—O) were confirmed, and characteristic bands of polyimide at 1720 cm⁻¹ (C═O) and 1580 cm⁻¹ (C═O) were confirmed. The prepared polymer had a fractional free volume of 0.226 and d-spacing of 615 pm.

### Example 28

### Preparation of a Polymer

A polymer including a poly(pyrrolone-imide) copolymer including a repeating unit represented by the following Chemical Formula 63 was prepared according to the following reaction.

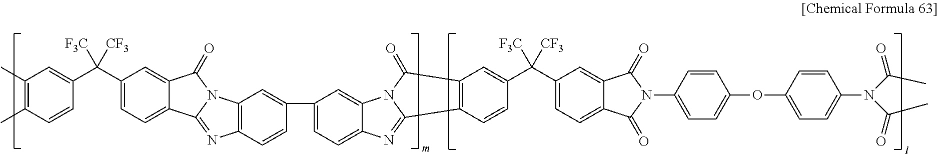

A polymer including a poly(pyrrolone-imide) copolymer (mole ratio, m:l, is 8:2) including a repeating unit represented by the above Chemical Formula 63 was prepared in the same manner as in Example 3, except that 3.42 g (16 mmol) of 3,3′-diaminobenzidine, 0.8 g (4 mmol) of 4,4′-diaminodiphenylether, and 8.88 g (20 mmol) of 4,4′-(hexafluoroisopropylidene)diphthalic anhydride were reacted as a starting material.

As a result of FT-IR analysis, characteristic bands of the resulting polypyrrolone at 1758 cm⁻¹ (C═O) and 1625 cm⁻¹ (C═N) were confirmed, and characteristic bands of polyimide at 1720 cm⁻¹ (C═O) and 1580 cm⁻¹ (C═O) were confirmed. The prepared polymer had a fractional free volume of 0.241 and d-spacing of 628 pm.

### Example 29

### Preparation of a Polymer

A polymer including a poly(benzothiazole-imide) copolymer including a repeating unit represented by the following Chemical Formula 64 was prepared according to the following reaction.

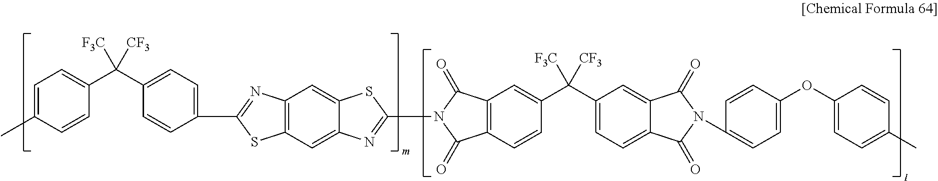

A polymer including a poly(benzothiazole-imide) copolymer (mole ratio, m:l, is 8:2) including a repeating unit represented by the above Chemical Formula 64 was prepared in the same manner as in Example 3, except that 3.92 g (16 mmol) of 2,5-diamino-1,4-benzenedithiol dihydrochloride, 0.8 g (4 mmol) of 4,4′-diaminodiphenylether, and 8.88 g (20 mmol) of 4,4′-(hexafluoroisopropylidene)diphthalic anhydride were reacted as a starting material.

As a result of FT-IR analysis, characteristic bands of the resulting polybenzothiazole at 1484 cm⁻¹ (C—S) and 1404 cm⁻¹ (C—S) were confirmed, and characteristic bands of polyimide at 1720 cm⁻¹ (C═O) and 1580 cm⁻¹ (C═O) were confirmed. The prepared polymer had a fractional free volume of 0.256 and d-spacing of 611 pm.

### Example 30

### Preparation of a Polymer

A polymer including a poly(benzoxazole-benzothiazole) copolymer including a repeating unit represented by the following Chemical Formula 65 was prepared according to the following reaction.

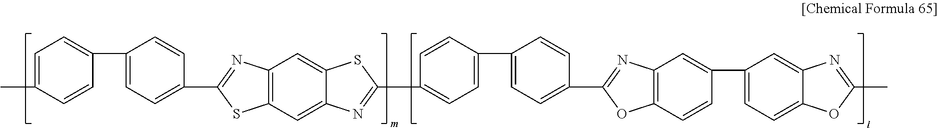

A polymer including a poly(benzoxazole-benzothiazole) copolymer (mole ratio, m:l, is 5:5) including a repeating unit represented by the above Chemical Formula 65 was prepared in the same manner as in Example 3, except that 2.16 g (10 mmol) of 3,3′-dihydroxybenzidine, 2.45 g (10 mmol) of 2,5-diamino-1,4-benzenedithiol dihydrochloride, and 6.64 g (20 mol) of 3,3′,4,4′-biphenyltetracarboxylic anhydride were reacted as a starting material.

As a result of FT-IR analysis, characteristic bands of the resulting polybenzoxazole at 1595 cm⁻¹, 1480 cm⁻¹ (C═N), and 1052 cm⁻¹ (C—O) which were not detected in polyimide were confirmed, and characteristic bands of polybenzothiazole at 1484 cm⁻¹ (C—S) and 1404 cm⁻¹ (C—S) were confirmed. The prepared polymer had a fractional free volume of 0.194 and d-spacing of 587 pm.

### Example 31

### Preparation of a Polymer

A polymer including a poly(pyrrolone-pyrrolone) copolymer including a repeating unit represented by the following Chemical Formula 66 was prepared according to the following reaction.

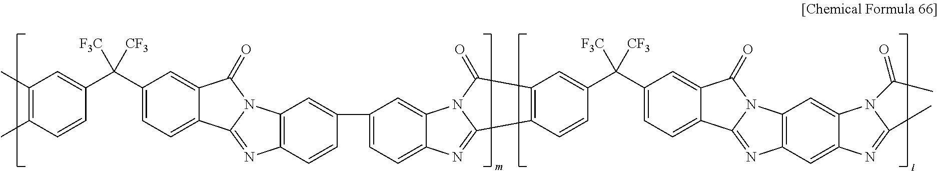

A polymer including a (pyrrolone-pyrrolone) copolymer (mole ratio, m:l, is 8:2) including a repeating unit represented by the above Chemical Formula 66 was prepared in the same manner as in Example 3, except that 3.42 g (16 mol) of 3,3′-diaminobenzidine, 1.14 g (4 mmol) of benzene-1,2,4,5-tetraamine tetrahydrochloride, and 8.88 g (20 mmol) of 4,4′-(hexafluoroisopropylidene) diphthalic anhydride were reacted as a starting material.

As a result of FT-IR analysis, characteristic bands of the resulting polypyrrolone at 1758 cm⁻¹ (C═O) and 1625 cm⁻¹ (C═N) which were not detected in polyaminoimide were confirmed. The prepared polymer had a fractional free volume of 0.207 and d-spacing of 602 pm.

### Example 32

### Preparation of a Polymer

A polymer including a poly(benzoxazole-imide) copolymer including a repeating unit represented by the following Chemical Formula 67 was prepared according to the following reaction.

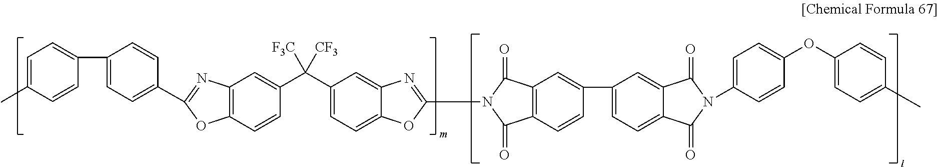

A polymer including a (benzoxazole-imide) copolymer (mole ratio, m:l, is 5:5) including a repeating unit represented by the above Chemical Formula 67 was prepared in the same manner as in Example 3, except that 3.66 g (10 mmol) of 2,2-bis(3-amino-4-hydroxyphenyl)hexafluoropropane, 2.00 g (10 mmol) of 4,4′-diaminodiphenylether, and 5.88 g (20 mmol) of 3,3′,4,4′-biphenyltetracarboxylic dianhydride were reacted as a starting material.

As a result of FT-IR analysis, characteristic bands of the resulting polybenzoxazole at 1553 m⁻¹, 1480 cm⁻¹ (C═N), and 1058 cm⁻¹ (C—O) were confirmed, and characteristic bands of the resulting polyimide at 1720 cm⁻¹ (C═O) and 1580 cm⁻¹ (C═O) were confirmed. The prepared polymer had a fractional free volume of 0.192 and d-spacing of 645 pm.

### Example 33

### Preparation of a Polymer

A polymer including a poly(benzoxazole-imide) copolymer (mol ratio, m:l, is 2:8) including a repeating unit represented by the above Chemical Formula 67 was prepared in the same manner as in Example 28, except that the copolymerization ratio of benzoxazole to imide was adjusted to 2:8.

As a result of FT-IR analysis, characteristic bands of the resulting polybenzoxazole at 1553 cm⁻¹, 1480 cm⁻¹ (C═N), and 1058 cm⁻¹ (C—O) were confirmed, and characteristic bands of the resulting polyimide at 1720 cm⁻¹ (C═O) and 1580 cm⁻¹ (C═O) were confirmed. The prepared polymer had a fractional free volume of 0.182 and d-spacing of 631 pm.

### Example 34

### Preparation of a Polymer

A polymer including a poly(benzoxazole-imide) copolymer (mol ratio, m:l, is 8:2) including a repeating unit represented by the above Chemical Formula 67 was prepared in the same manner as in Example 28, except that the copolymerization ratio of benzoxazole to imide was adjusted to 8:2.

As a result of FT-IR analysis, characteristic bands of the resulting polybenzoxazole at 1553 cm⁻¹, 1480 cm⁻¹ (C═N), and 1058 cm⁻¹ (C—O) were confirmed, and characteristic bands of the resulting polyimide at 1720 cm⁻¹ (C═O) and 1580 cm⁻¹ (C═O) were confirmed. The prepared polymer had a fractional free volume of 0.209 and d-spacing of 689 pm.

### Comparative Example 1

### Preparation of a Polymer

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added into 45.9 g (85 wt %) of N-methylpyrrolidone (NMP). Then, the solution was allowed to react at 15° C. for 4 hours to prepare a pale yellow viscous polyhydroxyamic acid solution.

The prepared viscous polyhydroxyamic acid solution was cast on a glass plate 20 cm×25 cm in size, and cured and imidized in vacuum oven at 100° C. for 2 hours, at 150° C. for 1 hour, at 200° C. for 1 hour, and at 250° C. for 1 hour. Then, vacuum drying was carried out in a vacuum oven at 60° C. for 24 hours in order to completely remove the residual solvent. Consequently, a transparent brownish polyhydroxyimide membrane was obtained. The prepared membrane including polyhydroxyimide had a thickness of 30 pm. The polyhydroxyimide membrane was thermally treated in a muffled tubular furnace at 300° C. at a heating rate of 10° C./min under an argon atmosphere (300 cm³[STP]/min), and was held for 1 hour at 300° C. Then, it was cooled down slowly to room temperature to prepare a polymer.

### Comparative Example 2

### Preparation of a Polymer Membrane

A polymer was prepared in the same manner as in Comparative Example 1, except that 2.45 g (10 mmol) of 2,5-diamino-1,4-benzenedithiol dihydrochloride and 4.44 g (10 mmol) of 4,4′-(hexafluoroisopropylidene)diphthalic anhydride were reacted as a starting material to prepare a polyamic acid including a thiol group (—SH).

### Comparative Example 3

### Preparation of a Polymer Membrane

A polymer was prepared in the same manner as in Comparative Example 1, except that 2.14 g (10 mmol) of 3,3′-diaminobenzidine and 4.44 g (10 mmol) of 4,4′-(hexafluoroisopropylidene)diphthalic anhydride were reacted as a starting material to prepare a polyamic acid including an amine-group (—NH₂).

### Comparative Example 4

### Preparation of a Polymer Membrane

A polymer was prepared in the same manner as in Comparative Example 1, except that 3.66 g (0.1 mol) of 2,2-bis(3-amino-4-hydroxyphenyl)hexafluoropropane and 3.1 g (10 mmol) of 4,4′-oxydiphthalic anhydride were reacted as a starting material.

### Comparative Example 5

### Preparation of a Polymer Membrane

A polymer was prepared in the same manner as in Comparative Example except that 3.66 g (10 mmol) of 2,2-bis(3-amino-4-hydroxyphenyl)hexafluoropropane and 2.18 g (10 mmol) of 1,2,4,5-benzenetetracarboxylic dianhydride were reacted as a starting material.

### Comparative Example 6

### Preparation of a Polymer Membrane

A polymer was prepared in the same manner as in Comparative Example except that 3.66 g (10 mmol) of 2,2-bis(3-amino-4-hydroxyphenyl)hexafluoropropane and 3.22 g (10 mmol) of 3,3′,4,4′-benzophenonetetracarboxylic dianhydride were reacted as a starting material.

### Comparative Example 7

### Preparation of a Polymer Membrane

A polymer was prepared in the same manner as in Comparative Example 1, except that 3.66 g (10 mmol) of 2,2-bis(3-amino-4-hydroxyphenyl)hexafluoropropane and 2.94 g (10 mmol) of 3,3′,4,4′-biphenyltetracarboxylic dianhydride were reacted as a starting material.

### Comparative Example 8

### Preparation of a Polymer Membrane

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added into 32.4 g (80 wt %) of N-methylpyrrolidone (NMP), and intensively agitated for 4 hours. Subsequently, 3.22 ml (40 mmol) of pyridine as a catalyst for chemical imidization and 3.78 ml (40 mmol) of acetic anhydride were added to the solution. Then, the solution was allowed to react at room temperature for 24 hours to prepare a pale yellow viscous polyhydroxyimide solution. The pale yellow viscous polyhydroxyimide solution was agitated in triple-distilled water, and deposited to prepare a polymer powder. Then, the polymer powder was filtered, and dried at 120° C.

The prepared polymer powder was dissolved in an amount of 20 wt % in an N-methylpyrrolidone (NMP) solution. The dissolved polyhydroxyimide solution was cast on a glass plate 20 cm×25 cm in size, and cured and imidized in vacuum oven at 180° C. for 6 hours. Then, vacuum drying was carried out in a vacuum oven at 60° C. for 24 hours in order to completely remove the residual solvent. Consequently, a transparent brownish polyhydroxyimide membrane was obtained. The prepared membrane including polyhydroxyimide had a thickness of 40 μm.

### Comparative Example 9

### Preparation of a Polymer Membrane

A polymer including polyhydroxyimide was prepared in the same manner as in Comparative Example 8, except that 4.35 g (40 mmol) of trimethylchlorosilane was added before 3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were reacted.

### Comparative Example 10

### Preparation of a Polymer Membrane

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added to 32.4 g (80 wt %) of N-methylpyrrolidone (NMP), and intensively agitated for 4 hours. A membrane including polyhydroxyimide was prepared in the same manner as in Comparative Example 8, except that polyhydroxyimide was prepared by adding 32 ml of xylene as an azeotropic mixture, and removing the mixture of water and xylene by thermal solution imidization at 180° C. for 12 hours.

### Comparative Example 11

### Preparation of a Carbon Molecular Sieve Membrane

A carbon molecular sieve membrane was prepared by carbonizing a polyimide membrane (Kapton®, DuPont) at 600° C.

In detail, a commercial polyimide membrane (Kapton®, DuPont) prepared from equimolar 1,2,4,5-benzenetetracarboxylic dianhydride and 4,4′-diaminodiphenylether as starting materials was thermally treated in a muffled tubular furnace at 600° C. at a heating rate of 5° C./min under an argon atmosphere (100 cm³[STP]/min). The membrane was held for one hour at 600° C. Then, it was cooled down slowly to room temperature to prepare a carbon molecular sieve membrane.

### Comparative Example 12

### Preparation of a Carbon Molecular Sieve Membrane

A carbon molecular sieve membrane was prepared in the same manner as in Comparative Example 11, except for carbonizing the polyimide membrane (Kapton®, DuPont) at 800° C.

### Comparative Example 13

### Preparation of a Carbon Molecular Sieve Membrane

A carbon molecular sieve membrane was prepared in the same manner as in Comparative Example 11, except that the membrane including polyhydroxyimide prepared according to Comparative Example 1 was carbonized at 600° C.

### Comparative Example 14

### Preparation of a Polymer 2,2-bis(trimethylsilylamino-4-trimethylsiloxyphenyl)-1,1,1,3,3,3-hexafluor opropane and hexafluoroisopropylidenebiphenyl-4,4-dicarboxylic acid chloride with the same equivalent was dissolved in dimethyl acetamide at 0° C. Then, the dissolved solution was cast on a glass film, and heat-treated at 300° C. under an inert atmosphere. Thereby, a membrane including polybenzoxazole was prepared.

### Experimental Example 1

### FT-IR Analysis (Fourier Transform Infrared, FT-IR)

In order to characterize a precursor and a polymer, ATR-FTIR (attenuated total reflectance (ATR)-Fourier transform infrared (FTIR)) spectra were obtained using an infrared microspectrometer (IlluminatIR, SensIR Technologies, Danbury, Conn., USA).

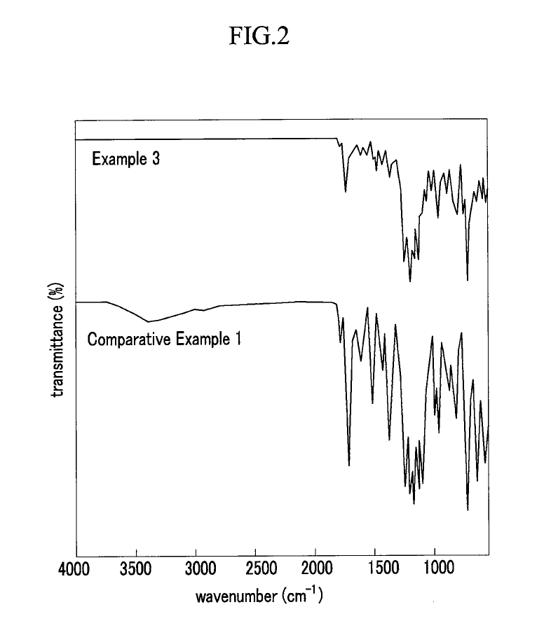

FIG. 2 shows FT-IR spectra of a polymer of Example 3 and of Comparative Example 1.

As shown in FIG. 2, in the case of the polyhydroxyimide of Comparative Example 1, a characteristic band of HO-phenylene at 3400 m⁻¹, characteristic bands of imide at 1788 cm⁻¹ and 1618 cm⁻¹, and a characteristic band of carbonyl-group at 1720 cm⁻¹ were observed. On the other hand, in the case of the polybenzoxazole of Example 3, characteristic bands of polybenzoxazole at 1553 cm⁻¹, 1480 cm⁻¹, and 1052 cm⁻¹ which were not detected in polyhydroxyimide were confirmed. It may be confirmed from the FT-IR spectra that the polymer including polyhydroxyimide of Comparative Example 1 was converted to the polymer including polybenzoxazole of Example 3 by thermal treatment.

In addition, Examples 1, 2, 4 to 8, 11 to 24, 26, 27, 30, and 32 to 34 which contain a similar structure and the same functional groups as Example 3, and

Comparative Examples 4 to 10 which contain a similar structure and the same functional groups as Comparative Example 1, showed the same FT-IR spectra as Example 3 and Comparative Example 1, respectively.

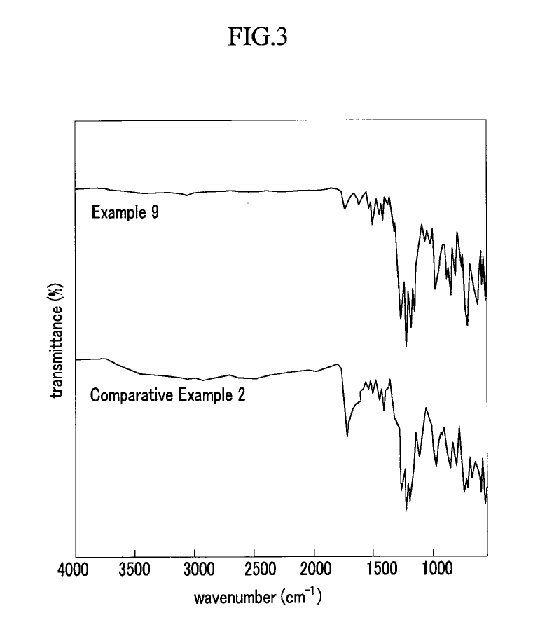

FIG. 3 shows FT-IR spectra of a polymer of Example 9 and of Comparative Example 2.

As shown in FIG. 3, in the case of the polythiolimide of Comparative Example 2, characteristic broad and weak bands of —SH at 2400 cm⁻¹ to 2600 cm⁻¹ and characteristic bands of imide at 1793 cm⁻¹ and 1720 cm⁻¹ were observed. On the other hand, in the case of the polybenzothiazole of Example 9, characteristic bands of polybenzothiazole at 1480 cm⁻¹ and 1404 cm⁻¹ which were not detected in polythiolimide were observed. It may be confirmed from the FT-IR spectra that the polymer including polythiolimide of Comparative Example 2 was converted to the polymer including polybenzothiazole of Example 9 by thermal treatment.

In addition, Examples 29 and 30 which contain a similar structure and the same functional groups to Example 9 showed the same infrared spectrum as Example 9.

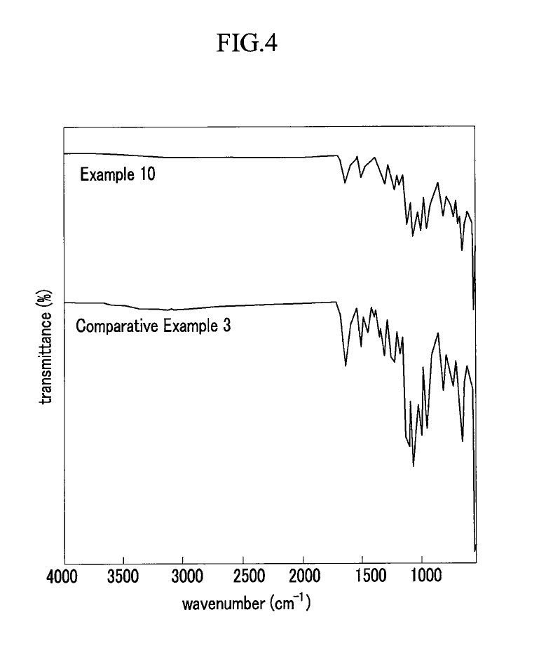

FIG. 4 shows FT-IR spectra of a polymer of Example 10 and of Comparative Example 3.

As shown in FIG. 4, in the case of the polyaminoimide of Comparative Example 3, a characteristic broad and weak band of —NH₂ at 2900 cm⁻¹ to 3400 cm⁻¹ and characteristic bands of imide at 1793 cm⁻¹ and 1720 cm⁻¹ were observed. On the other hand, in the case of the polypyrrolone of Example 10, characteristic bands of polypyrrolone at 1758 cm⁻¹ and 1625 cm⁻¹ which were not detected in polyaminoimide were observed. It may be confirmed from the FT-IR spectra that the polymer including polyaminoimide of Comparative Example 3 was converted to the polymer including polypyrrolone of Example 10 by thermal treatment.

In addition, Examples 25, 28, and 31 which contain a similar structure and the same functional groups as Example 10 showed the same infrared spectra as Example 10.

### Experimental Example 2

### TGA (Thermogravimetric Analysis)/MS (Mass Spectroscopy)

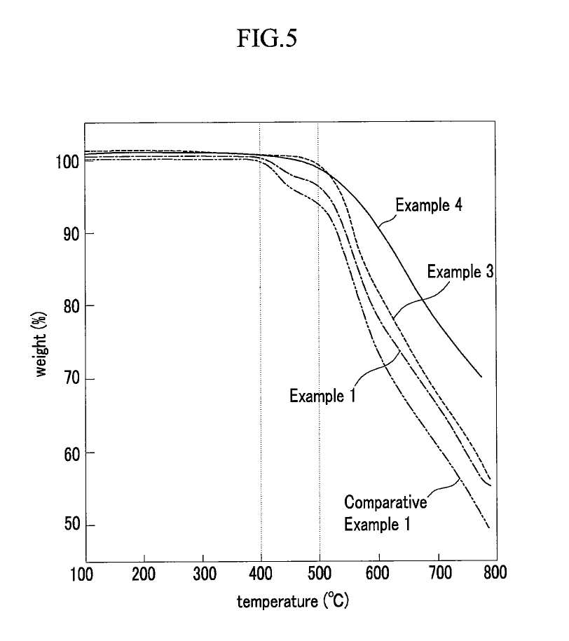

The polyimides of Comparative Examples 1 to 3, the polybenzoxazoles of Examples 1, 3, and 4, the polybenzothiazole of Example 9, and the polypyrrolone of Example 10 were subjected to thermogravimetric analysis/mass spectroscopy (TGA-MS) to confirm weight loss occurring by the thermal rearrangement. The TGA/MS was carried out using TG 209 F1 Iris® (NETZSCH, Germany) and QMS 403C Aeolos® (NETZSCH, Germany), while injecting Ar into each precursor membrane. The heating rate was 10° C./min and the Ar purge flow was 90 cm³[STP]/min. The results thus obtained are shown in FIGS. 5 to 7.

FIG. 5 is a TGA/MS thermogram of the polyhydroxyimide of Comparative Example 1 and the polybenzoxazole of Examples 1, 3, and 4.

As can be seen from FIG. 5, the thermal degradation of the polybenzoxazole of Examples 3 and 4 is not observed within the thermal conversion temperature of 400 to 500° C. On the other hand, the polyhydroxyimide of Comparative Example 1 and the polybenzoxazole of Example 1 began to be thermally rearranged at a thermal conversion temperature of 400 to 500° C. The polybenzoxazole of Example 1 that was treated at a relatively lower temperature of 350° C. to complete the thermally conversion process showed further conversion at a temperature range of 400 to 500° C. The evolved gas component was subjected to MS to confirm the presence of CO₂. According to elimination of CO₂, the weight of the polyhydroxyimide of Comparative Example 1 and the polybenzoxazole of Example 1 decreased 6 to 8% and 4 to 5% respectively, at the temperature range of 400 to 500° C. due to the thermal rearrangement through thermal treatment. However, the weight of polybenzoxazole of Examples 3 and 4 did not decrease up to 500° C.

In addition, Examples 1, 2, 4 to 8, 11 to 24, 26, 27, 30, and 32 to 34 that contain a similar structure and the same functional groups as Example 3, and Comparative Examples 4 to 10 that contain a similar structure and the same functional groups as Comparative Example 1, showed similar thermal decomposition curves to Example 3 and Comparative Example 1, respectively.

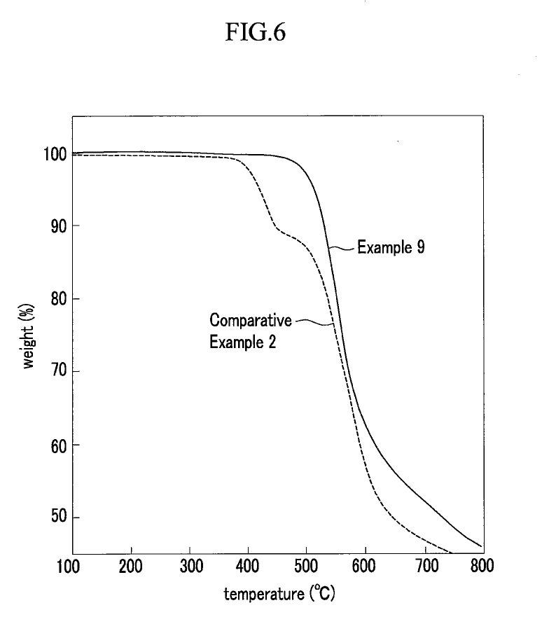

FIG. 6 is a TGA/MS thermogram of polythiolimide of Comparative Example 2 (precursor of polybenzothiazole of Example 9) and polybenzothiazole of Example 9.

As can be seen from FIG. 6, the thermal degradation of the polybenzothiazole of Example 9 is not observed within the thermal conversion temperature of 400 to 500° C. On the other hand, the polythiolimide of Comparative Example 2 began to be thermally rearranged at a thermal conversion temperature of 400 to 500° C. The evolved gas component was subjected to MS to confirm the presence of CO₂. According to elimination of CO₂, the weight of the polythiolimide of Comparative Example 2 decreased 12 to 14% at the temperature range of 400 to 500° C. due to the thermal rearrangement through thermal treatment. However, the weight of the polybenzothiazole of Example 9 did not decrease up to 500° C.

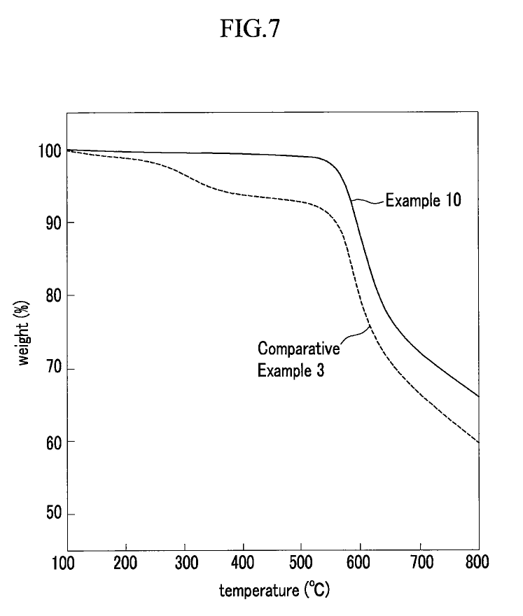

FIG. 7 is a TGA/MS thermogram of the polyaminoimide of Comparative Example 3 (precursor of polypyrrolone of Example 10) and the polypyrrolone of Example 10.

As can be seen from FIG. 7, the thermal degradation of the polypyrrolone of Example 10 is not observed within the thermal conversion temperature of 300 to 500° C. On the other hand, the polyaminoimide of Comparative Example 3 began to be thermally rearranged at a thermal conversion temperature of 300 to 500° C. The evolved gas component was subjected to MS to confirm the presence of H₂O. According to elimination of H₂O, the weight of polyaminoimide of Comparative Example 3 decreased 7 to 9% at the temperature range of 300 to 500° C. due to the thermal rearrangement through thermal treatment. However, the weight of polypyrrolone of Example 10 did not decrease up to 500° C.

In addition, Examples 25, 28, and 31 that contain a similar structure and the same functional groups as Example 10 showed similar thermal decomposition curves to Example 10.

According to these data, the polymers prepared according to Examples 1 to 34 have excellent thermal resistance at a high temperature.

### Experimental Example 3

### Elemental Analysis

To observe a structural change of the polymers of Examples 1 to 3 and Comparative Example 1, an elemental analyzer (Carlo Erba/Fison Inc, ThermoFinnigan EA1108) was engaged. WO₃/Cu was engaged as a catalyst, and BBOT (2,5-bis(5-tert-butyl-benzoxazole-2-yl)thiophene) was engaged as a standard material. Table 1 shows the test results of examples at 1000° C.

TABLE 1

| | Chemical | | | | | |
|---|---|---|---|---|---|---|
| Polymer | Formula | C (wt %) | H (wt %) | N (wt %) | O (wt %) | F (wt %) |
| Example | — | 54.1 ± 0.16 | 2.07 ± 0.00 | 3.87 ± 0.01 | 9.34 ± 0.18 | 30.6 ± 0.02 |
| 1 | | | | | | |
| Example | — | 55.2 ± 0.01 | 2.02 ± 0.01 | 4.05 ± 0.00 | 7.23 ± 0.03 | 31.5 ± 0.04 |
| 2 | | | | | | |
| Example | [C₃₂H₁₄F₁₂N₂O₂]ₙ | 56.7 ± 0.01 | 1.93 ± 0.02 | 4.21 ± 0.01 | 4.89 ± 0.12 | 32.3 ± 0.12 |
| 3 | | (55.9*) | (2.06*) | (4.08*) | (4.66*) | (33.2*) |
| Comparative | [C₃₄H₁₄F₁₂N₂O₆]ₙ | 53.2 ± 0.08 | 1.87 ± 0.06 | 3.62 ± 0.01 | 11.3 ± 0.22 | 30.0 ± 0.08 |
| | | (52.7*) | (1.82*) | (3.62*) | (11.3*) | (29.4*) |
| Example | | | | | | |
| 1 | | | | | | |

*calculated value
measurement apparatus: ThermoFinnigan (Carlo Erba/Fison) EA1108
temperature: 1000° C., (1060° C. for O₂)
catalyst: WO₃/Cu (nickel-plated carbon, nickel wool, quartz turnings, soda lime, magnesium perchlorate anhydrone for O)
sample weight: 5 mg, (2 mg for O)
measured element: C, H, N, O
standard material: BBOT (2,5-bis(5-tert-butyl-benzoxazole-2-yl) thiophene), (sulfanilamide for O)

Referring to the above Table 1, the polyhydroxyimide of Comparative Example 1 must include 52.7 wt % carbon (C), 1.82 wt % hydrogen (H), 3.62 wt % nitrogen (N), 11.3 wt % oxygen (O), and 29.4 wt % fluorine (F) in the abstract. The constituents of polyhydroxyimide of Comparative Example 1 (53.2±0.08 wt % carbon (C), 1.87±0.06 wt % hydrogen (H), 3.62±0.01 wt % nitrogen (N), 11.3±0.22 wt % oxygen (O), and 30.0±0.08 wt % fluorine (F)) were consistent with the above theoretical polyhydroxyimide constituents.

In addition, the polybenzoxazole of Example 3 must include 55.9 wt % carbon (C), 2.06 wt % hydrogen (H), 4.08 wt % nitrogen (N), 4.66 wt % oxygen (O), and 33.2 wt % fluorine (F) in the abstract. The constituents of polybenzoxazole of Example 3 (56.7±0.01 wt % carbon (C), 1.93±0.02 wt % hydrogen (H), 4.21±0.01 wt % nitrogen (N), 4.89±0.12 wt % oxygen (O), and 32.3±0.12 wt % fluorine (F)) were consistent with the above theoretical polybenzoxazole constituents.

According to these data, it may be confirmed that the formulae of the thermally rearranged polymers of Examples 1 to 34 are consistent with the supposed chemical formulae. Thereby, it may be confirmed that the polymers prepared according to Examples 1 to 34 are prepared by thermal rearrangement.

### Experimental Example 4

### Mechanical Properties

The mechanical properties of the polymer membranes prepared according to Examples 1 to 12, 14, and 24 to 34, and Comparative Examples 1 to 13, were measured at 25° C. using AGS-J 500N equipment (Shimadzu). Five specimens of each sample were tested. The standard deviation from the mean was within ±5%. The results thus obtained are shown in the following Table 2.

TABLE 2

| | Tensile strength | Elongation percent at break |
|---|---|---|
| Polymer | (MPa) | (%) |
| Example 1 | 87 | 3.8 |
| Example 2 | 95 | 3.5 |
| Example 3 | 98 | 3.9 |
| Example 4 | 101 | 3.2 |
| Example 5 | 96 | 4.7 |
| Example 6 | 104 | 4.2 |
| Example 7 | 109 | 3.1 |
| Example 8 | 103 | 4.1 |
| Example 9 | 95 | 5.7 |
| Example 10 | 88 | 4.2 |
| Example 11 | 96 | 3.7 |
| Example 12 | 92 | 5.2 |
| Example 14 | 88 | 2.6 |
| Example 24 | 117 | 4.2 |
| Example 25 | 109 | 5.3 |
| Example 26 | 98 | 5.9 |
| Example 27 | 84 | 6.7 |
| Example 28 | 91 | 5.5 |
| Example 29 | 101 | 4.5 |
| Example 30 | 96 | 3.2 |
| Example 31 | 88 | 3.8 |
| Example 32 | 96 | 5.2 |
| Example 33 | 82 | 6.7 |
| Example 34 | 95 | 4.3 |
| Comparative | 83 | 3.1 |
| Example 1 | | |
| Comparative | 76 | 4.2 |
| Example 2 | | |
| Comparative | 75 | 4.8 |
| Example 3 | | |
| Comparative | 81 | 3.5 |
| Example 4 | | |
| Comparative | 90 | 2.5 |
| Example 5 | | |
| Comparative | 78 | 3.3 |
| Example 6 | | |
| Comparative | 85 | 3.1 |
| Example 7 | | |
| Comparative | 64 | 3.4 |
| Example 8 | | |
| Comparative | 65 | 3.7 |
| Example 9 | | |
| Comparative | 66 | 3.5 |
| Example 10 | | |
| Comparative | 42 | 0.4 |
| Example 11 | | |
| Comparative | 52 | 0.3 |
| Example 12 | | |
| Comparative | 34 | 0.6 |
| Example 13 | | |

As shown in the Table 2, the polymers of Examples 1 to 12, 14, and 24 to 34 showed better tensile strength (unit: MPa) and elongation percent at break (unit: %) than those of Comparative Examples 1 to 13. This is because the polyimide main chain structure was converted into a stiff and rigid aromatic-connected polybenzoxazole, polybenzothiazole, or polypyrrolone structure through thermal rearrangement.

Therefore, it is advantageous in that the polymers of Examples 1 to 34 can endure moderate conditions as well as harsh conditions such as a long operation time, a high operation temperature, an acidic condition, and high humidity due to the rigid polymer backbone present in the polymer.

### Experimental Example 5

### Adsorption/Desorption Isotherm Analysis

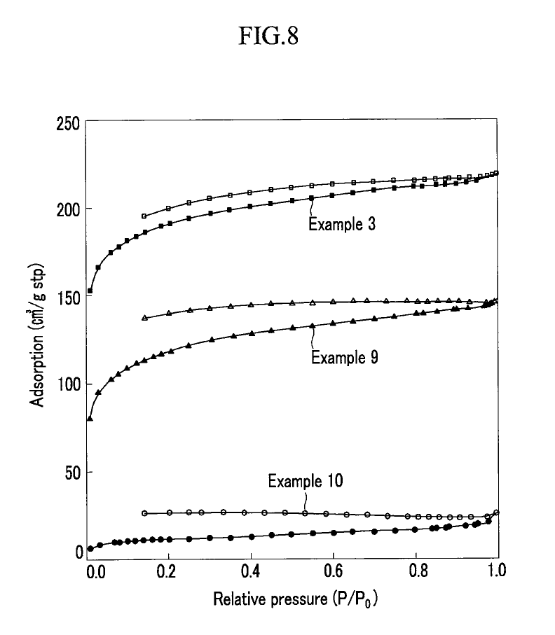

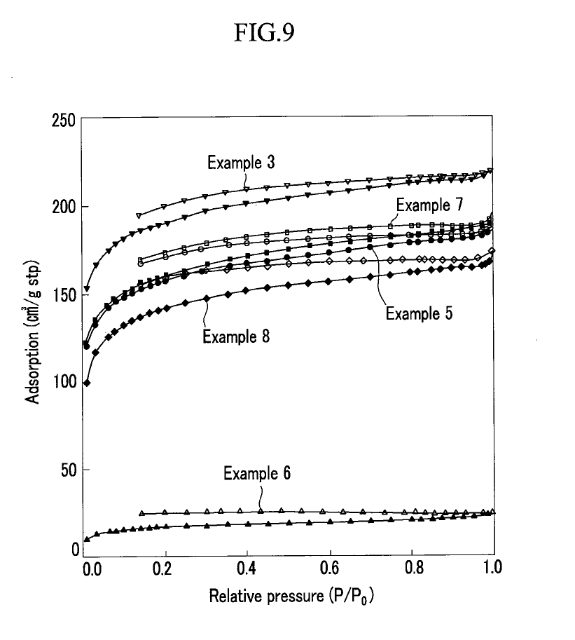

An adsorption/desorption isotherm analysis was performed to determine nitrogen (N₂) adsorption/desorption characteristics of the polymer prepared according to Examples 1 to 12, 14, 24, and 25, and Comparative Examples 1 to 3. N₂ adsorption/desorption isotherms of the polymers were measured by a BET (Brunauer-Emmett-Teller) method. The results are shown in FIGS. 8 and 9.

FIG. 8 shows N₂ adsorption/desorption isotherms at −196° C. for Examples 3, 9, and 10. FIG. 9 shows N₂ adsorption/desorption isotherms at −196° C. for Examples 3 and 5 to 8.

As shown in FIGS. 8 and 9, the N₂ adsorption/desorption isotherms of Examples 3 and 5 to 10 are of a reversible Type IV form with hysteresis. This result including a large specific surface area and gas adsorbing capacity confirmed that picopores were well connected.

In order to realize more precise characterization of the polymers according to one embodiment, the pore volume of polymers according to Examples 1 to 10, 11, 12, 14, 24, and 25, and Comparative Examples 1 to 3, were measured using a specific surface area and pore analyzer (ASAP2020, Micromeritics, GA, USA). At this time, the polymers were transferred to pre-weighed analytic tubes that were capped with Transeal™ to prevent permeation of oxygen and atmospheric moisture during transfers and weighing. The polymers were evacuated under a dynamic vacuum up to 300° C. until an outgas rate was less than 2 mTorr/min. The results are shown in the following Table 3.

Specific surface area and total pore volume were calculated by measuring nitrogen adsorption degree until saturation pressure (P/Pₒ=1) by the cm³/g unit and using liquefied nitrogen at 77K through Equations 1 and 2 that are well-known for the Brunauer-Emmett-Teller (BET) function, within 0.05<P/Pₒ<0.3.

$$\frac{1}{v [ ( {P}_{0} / P ) - 1 ]} = \frac{c - 1}{{v}_{m} c} ( \frac{P}{{P}_{0}} ) + \frac{1}{{v}_{m} c} \qquad [ Equation 1 ]$$

In Equation 1,

P is balance pressure of gas,

Pₒ is saturated pressure of gas,

v is quantity of gas adsorbed,

vₘ is quantity of gas absorbed at the surface at single phase at adsorption temperature, and

c is the BET constant of Equation 2.

$$c = exp ( \frac{{E}_{1} - {E}_{L}}{RT} ) \qquad [ Equation 2 ]$$

In Equation 2,

E₁ is adsorption heat at the first phase,

E_{L} is adsorption heat beyond the second phase,

R is a gas constant, and

T is measuring temperature.

TABLE 3

| | Maximum | BET | Total pore volume at |
|---|---|---|---|
| | adsorption quantity | surface area | a single point |
| Polymer | (cm³/g [STP]) | (m²/g) | (cm³/g [STP]) |
| Example 1 | 3.58 | 2.73 | 0.002 |
| Example 2 | 16.9 | 31.47 | 0.023 |
| Example 3 | 219.2 | 661.5 | 0.335 |
| Example 4 | 236.7 | 638.2 | 0.309 |
| Example 5 | 185.5 | 545.5 | 0.283 |
| Example 6 | 24.8 | 59.78 | 0.036 |
| Example 7 | 195.9 | 556.1 | 0.290 |
| Example 8 | 174.4 | 492.0 | 0.257 |
| Example 9 | 145.8 | 409.9 | 0.223 |
| Example 10 | 173.2 | 532.9 | 0.266 |
| Example 11 | 209.5 | 592.8 | 0.297 |
| Example 12 | 163.9 | 457.6 | 0.239 |
| Example 14 | 142.8 | 352.8 | 0.213 |
| Example 24 | 89.2 | 76.4 | 0.096 |
| Example 25 | 117.6 | 92.7 | 0.141 |
| Comparative | 23.4 | 9.97 | 0.018 |
| Example 1 | | | |
| Comparative | 68.6 | 44.8 | 0.072 |
| Example 2 | | | |
| Comparative | 14.7 | 27.9 | 0.19 |
| Example 3 | | | |

As shown in Table 3, the BET surface area of Example 3 is 661.5 m²/g that is markedly large for a polymer, and total pore volume at a single point is 0.335 cm³/g. This indicates that the polymers of Examples 1 to 34 may include a substantial amount of free volume.

### Experimental Example 6

### Positron Annihilation Lifetime Spectroscopy (PALS) Measurements

The PALS measurements were performed in nitrogen at ambient temperature using an automated EG&G Ortec fast-fast coincidence spectrometer. The timing resolution of the system was 240 ps.

The polymer membranes were stacked to a thickness of 1 mm on either side of a ²²Na—Ti foil source. There was no source correction needed for the Ti foil (thickness 2.5 μm). Each spectrum consisted of approximately 10 million integrated counts. The spectra were modeled as the sum of three decaying exponentials or as a continuous distribution. The PALS measurement is performed by obtaining time difference τ₁, τ₂, τ₃, and the like between γ₀ of 1.27 MeV produced by radiation of positrons produced from a ²²Na isotope and γ₁ and γ₂ of 0.511 MeV produced by annihilation thereafter.

The size of pores may be calculated through Equation 3 using disappearance time of 0.511 MeV of 2-γ signals.

$${τ}_{o - Ps} = {\frac{1}{2} [ 1 - \frac{R}{R + Δ R} + \frac{1}{2 π} sin ( \frac{2 π R}{R + Δ R} ) ]}^{- 1} \qquad [ Equation 3 ]$$

In Equation 3,

τ_{o-Ps} is disappearance time of positrons,

R is pore size, and

ΔR is an empirical parameter of the supposition that the pores are spherically shaped.

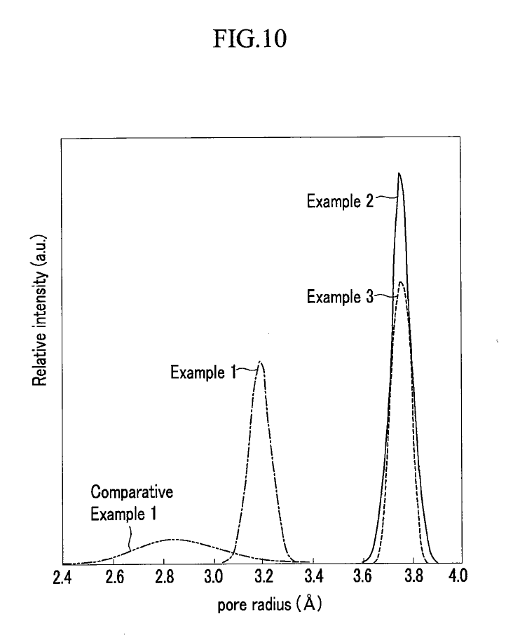

The results are shown in the following Table 4 and FIG. 10. Table 4 and FIG. 10 confirm the size and uniformity of the pores.

TABLE 4

| | Inten- | | | Treated |
|---|---|---|---|---|
| | sity I₃ | Lifetime | | temperature |
| Polymer | [%] | [τ₃/ns] | FWHM* | [° C.] |
| Example 1 | 4.6 | 2.3 | 0.14 | 350 |
| Example 2 | 14.3 | 3.2 | 0.12 | 400 |
| Example 3 | 8.0 | 3.3 | 0.17 | 450 |
| Comparative Example 1 | 2.0 | 2.0 | 0.48 | 300 |

*FWHM, full width at half maximum from the o-PS lifetime τ₃ distribution

FIG. 10 is a graph showing pore radius distribution of polymers of Examples 1 to 3 and Comparative Example 1 measured by PALS. The polymer of Comparative Example 1 has a wide pore radius distribution area and small quantity of pores as a conventional polymer. But the polymer of Example 1 has a narrow pore radius distribution area and a large quantity of pore sizes at about 320 pm. Further, the polymers of Examples 2 and 3 have a narrow pore radius distribution area and a large quantity of pore sizes of 370 pm to 380 pm generated by thermal conversion. The reason why the number of pores decreases in Example 3 as opposed to Example 2 is that the pores are linked to each other at a higher thermal conversion temperature. This confirms that picopores are well-connected to each other.

### Experimental Example 7

### Gas Permeability and Selectivity Measurements

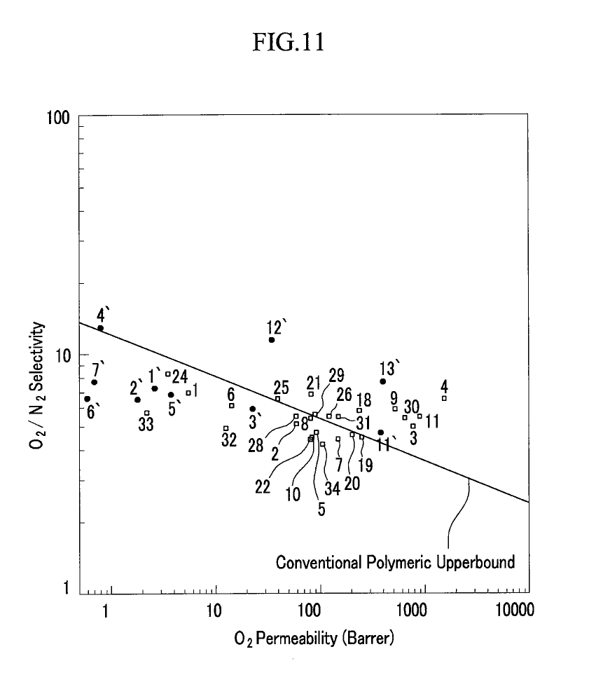

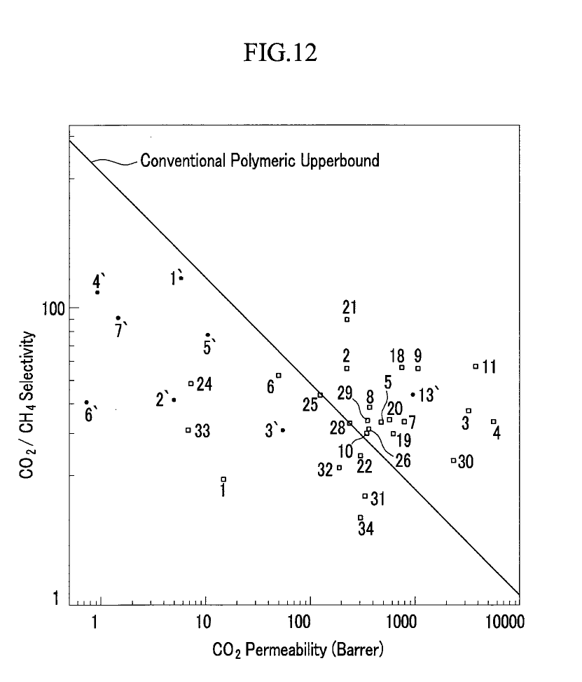

In order to ascertain gas permeability and selectivity of a polymer of Examples 1 to 34 and Comparative Examples 1 to 7 and 11 to 13, the following processes were performed. The results are shown in the following Table 5 and FIGS. 11 and 12.

Gas permeability and selectivity were measured using a high-vacuum time-lag apparatus, the calibrated downstream volume was 30 cm³, and the upstream and the downstream pressures were measured using a Baratron transducer with a full scale of 33 atm and 0.002 atm, respectively.

All of the pure gas permeation tests were performed more than 5 times at 25° C. The standard deviation from the mean values of permeabilities was within ±2%, and the sample-to-sample reproducibility was very good within samples at ±5%. The effective area of the polymer membranes was 4.00 cm².

For these pure gases, it is possible to measure either the volume of permeation at a fixed pressure or the rate of increase of permeation pressure in a fixed receiver volume. The permeation pressure, p₂, has a very small value (<2 Torr), while the inlet pressure, p₁, is atmospheric pressure or more. While the pressure at the permeation side was measured by recording p₂ versus time (sec), it is capable of approximating the permeabilities of gas molecules through the polymer membranes. The permeability coefficient of A molecules, P_{A}, can be calculated from the rate at which the downstream pressure increases in the fixed permeation volume at a steady state as in the following Equation 4.

$${P}_{A} = \frac{Vl}{{p}_{1} ART} {( \frac{d {p}_{2}}{d t} )}_{ss} \qquad [ Equation 4 ]$$

In Equation 4,

V is the volume of a fixed downstream receiver,

l is the membrane thickness,

A is the membrane area,

p₁ and p₂ are the upstream and downstream pressures, and

R, T, and t are the gas constant, temperature, and time, respectively.

TABLE 5

| | H₂ | O₂ | CO₂ | | |
|---|---|---|---|---|---|
| | perme- | perme- | perme- | | |
| | ability | ability | ability | O₂/N₂ | CO₂/CH₄ |
| Polymer | (Barrer) | (Barrer) | (Barrer) | selectivity | selectivity |
| Example 1 | 60.9 | 5.5 | 23.6 | 6.9 | 26.2 |
| Example 2 | 372.4 | 59.8 | 296.9 | 5.1 | 61.2 |
| Example 3 | 2855.9 | 776.1 | 3575.3 | 5 | 44.3 |
| Example 4 | 8867.5 | 1547.2 | 5963.2 | 6.5 | 40.7 |
| Example 5 | 443.5 | 92.8 | 596.9 | 4.7 | 40.5 |
| Example 6 | 91.2 | 14.3 | 72.79 | 6.1 | 58.2 |
| Example 7 | 634.9 | 148.2 | 951.8 | 4.4 | 40.7 |
| Example 8 | 356.4 | 81.4 | 468.6 | 5.4 | 45.5 |
| Example 9 | 2560 | 524.5 | 1251.3 | 5.9 | 61.4 |
| Example 10 | 495.3 | 84.4 | 442 | 4.5 | 37.2 |
| Example 11 | 4671.3 | 900.6 | 4111.5 | 5.5 | 62.5 |
| Example 12 | 4423 | 1438 | 4923 | 3.7 | 29 |
| Example 13 | 3391 | 1065 | 3699 | 3.2 | 18 |
| Example 14 | 408 | 81 | 398 | 4.3 | 34 |
| Example 15 | 1902 | 612 | 2855 | 3.4 | 27 |
| Example 16 | 2334 | 795 | 2464 | 3.7 | 13 |
| Example 17 | 2878 | 917 | 4922 | 3.5 | 23 |
| Example 18 | 1231 | 236.5 | 912.3 | 5.8 | 61.6 |
| Example 19 | 1061.5 | 250.1 | 759.3 | 4.5 | 37.2 |
| Example 20 | 941.8 | 203.3 | 701.9 | 4.6 | 41.3 |
| Example 21 | 738 | 82.4 | 295.1 | 6.8 | 89.4 |
| Example 22 | 445.4 | 82.1 | 392.2 | 4.4 | 31.3 |
| Example 24 | 53 | 3.5 | 12 | 8.3 | 54.5 |
| Example 25 | 135.4 | 39.7 | 171.4 | 6.5 | 49.1 |
| Example 26 | 742.3 | 122.1 | 461.7 | 5.5 | 38.5 |
| Example 27 | 491.6 | 107 | 389.1 | 4.2 | 19.5 |
| Example 28 | 300.1 | 59.7 | 314.4 | 5.5 | 40.3 |
| Example 29 | 350.4 | 89.6 | 451.3 | 5.6 | 41 |
| Example 30 | 2699.8 | 650.1 | 2604.1 | 5.4 | 30.2 |
| Example 31 | 752.1 | 150.4 | 429.5 | 5.5 | 23 |
| Example 32 | 192.7 | 12.5 | 251.9 | 4.9 | 28.6 |
| Example 33 | 8.6 | 2.2 | 11.4 | 5.7 | 38.2 |
| Example 34 | 294.2 | 106.6 | 388.9 | 4.2 | 19.4 |
| Comparative | 35.2 | 2.6 | 9.9 | 7.2 | 123.4 |
| Example 1 | | | | | |
| Comparative | 14.3 | 1.8 | 8.5 | 6.5 | 48.2 |
| Example 2 | | | | | |
| Comparative | 206.8 | 22.7 | 80.2 | 5.9 | 38 |
| Example 3 | | | | | |
| Comparative | 12.2 | 0.8 | 1.8 | 13 | 110.7 |
| Example 4 | | | | | |
| Comparative | 42.8 | 3.7 | 17 | 6.8 | 79.5 |
| Example 5 | | | | | |
| Comparative | 11.1 | 0.6 | 1.43 | 6.6 | 47.4 |
| Example 6 | | | | | |
| Comparative | 14.3 | 0.7 | 2.7 | 7.7 | 90.6 |
| Example 7 | | | | | |
| Comparative | 534 | 383 | 1820 | 4.7 | — |
| Example 11 | | | | | |
| Comparative | 248 | 34.8 | 128 | 11.5 | — |
| Example 12 | | | | | |
| Comparative | 4973.9 | 401.5 | 1140.7 | 7.65 | 50.2 |
| Example 13 | | | | | |

As shown in Table 5, it may be confirmed that the polymers of Examples 1 to 34 have excellent gas permeability and selectivity compared to the polymers of Comparative Examples 1 to 13.

FIGS. 11 and 12 are graphs showing oxygen permeability (Barrer) and oxygen/nitrogen selectivity, and carbon dioxide permeability (Barrer) and carbon dioxide/methane selectivity of flat membranes prepared in Examples 1 to 11, 18 to 22, and 24 to 34 of the present invention, and Comparative Examples 1 to 7 and 11 to 13, respectively (the numbers 1 to 11, 18 to 22, and 24 to 34 indicate Examples 1 to 11, 18 to 22, and 24 to 34, respectively, and the numbers 1′ to 7′ and 11′ to 13′ indicate Comparative Examples 1 to 7 and 11 to 13, respectively).

As shown in FIGS. 11 and 12, it may be confirmed that the polymers of Examples 1 to 34 have excellent gas permeability and selectivity.

It may be confirmed that the polymers of Examples 1 to 34 include well-connected picopores.

### Experimental Example 8

### Fractional Free Volume (FFV) Measurements

The fractional free volumes of the polymers of Examples 3, 5 to 8, and 10, and Comparative Examples 1 and 3 to 7 were measured.

The density of a polymer is related to the degree of free volume, and has an influence on gas permeability.

First, density of the membranes was measured by a buoyancy method using a Sartorius LA 310S analytical balance in accordance with Equation 5.

$${ρ}_{P} = \frac{{w}_{a}}{{w}_{a} - {w}_{w}} \times {ρ}_{w} \qquad [ Equation 5 ]$$

In Equation 5,

ρ_{P} is the density of a polymer,

ρ_{w} is the density of deionized water,

ωₐ is the weight of a polymer measured in the air, and

ω_{w} is the weight of a polymer measured in the deionized water.

The fractional free volume (FFV, V_{f}) was calculated from the data in accordance with Equation 6 below.

$$F F V = \frac{V - 1.3 {V}_{W}}{V} \qquad [ Equation 6 ]$$

In Equation 6,

V is the polymer specific volume and

Vw is the specific Van der Waals volume.

The d-spacing was calculated in accordance with Bragg's Equation from X-ray diffraction pattern results.

The results are shown in the following Table 6.

TABLE 6

| | | polymer | Van der | | | |
|---|---|---|---|---|---|---|
| | | specific | Waals | Fractional | Increment | |
| | Density | volume | volume | free volume | in FFV | d-spacing |
| Polymer | (g/cm³) | (V, cm³/g) | (V_{w}, cm^{3/}g) | (FFV, V_{f}) | (%) | (pm) |
| Comparative | 1.503 | 0.665 | 0.430 | 0.159 | 65 | 548 |
| Example 1 | | | | | | |
| Example 3 | 1.293 | 0.773 | 0.439 | 0.263 | | 600 |
| Comparative | 1.453 | 0.688 | 0.459 | 0.134 | 64 | 546 |
| Example 7 | | | | | | |
| Example 5 | 1.271 | 0.787 | 0.473 | 0.219 | | 606 |
| Comparative | 1.469 | 0.681 | 0.455 | 0.131 | 57 | 503 |
| Example 4 | | | | | | |
| Example 6 | 1.304 | 0.767 | 0.469 | 0.205 | | 611 |
| Comparative | 1.478 | 0.677 | 0.443 | 0.148 | 28 | 560 |
| Example 5 | | | | | | |
| Example 7 | 1.362 | 0.734 | 0.457 | 0.190 | | 698 |
| Comparative | 1.482 | 0.675 | 0.457 | 0.120 | 102 | 539 |
| Example 6 | | | | | | |
| Example 8 | 1.240 | 0.806 | 0.470 | 0.243 | | 602 |
| Comparative | 1.475 | 0.678 | 0.373 | 0.172 | 64 | 576 |
| Example 3 | | | | | | |
| Example 10 | 1.406 | 0.711 | 0.610 | 0.282 | | 634 |
| Comparative | 1.449 | 0.690 | 0.417 | 0.215 | 64 | 578 |
| Example 8 | | | | | | |
| Example 12 | 1.146 | 0.873 | 0.439 | 0.352 | | 662 |
| Comparative | 1.487 | 0.673 | 0.430 | 0.172 | 29 | 545 |
| Example 10 | | | | | | |
| Example 14 | 1.377 | 0.727 | 0.439 | 0.222 | | 595 |

As shown in Table 6, the polymers of Examples 3, 5 to 8, 10, and 12 and 14 have decreased density due to heat treatment compared to Comparative Examples 1, 3 to 8, and 10, and thereby have increased fractional free volume by 28% to 102%. Consequently, it may be confirmed that the polymers of Examples 1 to 34 may have abundant uniform-sized picopores through heat treatment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A polymer derived from polyamic acid or a polyimide, wherein
the polymer derived from polyamic acid or a polyimide includes picopores, and
the polyamic acid and the polyimide include a repeating unit obtained from an aromatic diamine including at least one ortho-positioned functional group with respect to an amine group and a dianhydride.

2. The polymer of claim 1, wherein the picopores have an hourglass-shaped structure by connecting at least two picopores.

3. The polymer of claim 1, wherein the functional group includes OH, SH, or NH₂.

4. The polymer of claim 1, wherein the polymer derived from polyamic acid or a polyimide has a fractional free volume (FFV) of 0.18 to 0.40.

5. The polymer of claim 1, wherein the polymer derived from polyamic acid or polyimide has interplanar distance (d-spacing) of 580 pm to 800 pm measured by X-ray diffraction (XRD).

6. The polymer of claim 1, wherein the picopores have a full width at half maximum (FWHM) of about 10 pm to about 40 pm measured by positron annihilation lifetime spectroscopy (PALS).

7. The polymer of claim 1, wherein the polymer derived from polyamic acid or a polyimide has a BET surface area of 100 m²/g to 1000 m²/g.

8. The polymer of claim 1, wherein the polyamic acid is selected from the group consisting of a polyamic acid including a repeating unit represented by the following Chemical Formulae 1 to 4, polyamic acid copolymers including a repeating unit represented by the following Chemical Formulae 5 to 8, copolymers thereof, and blends thereof: 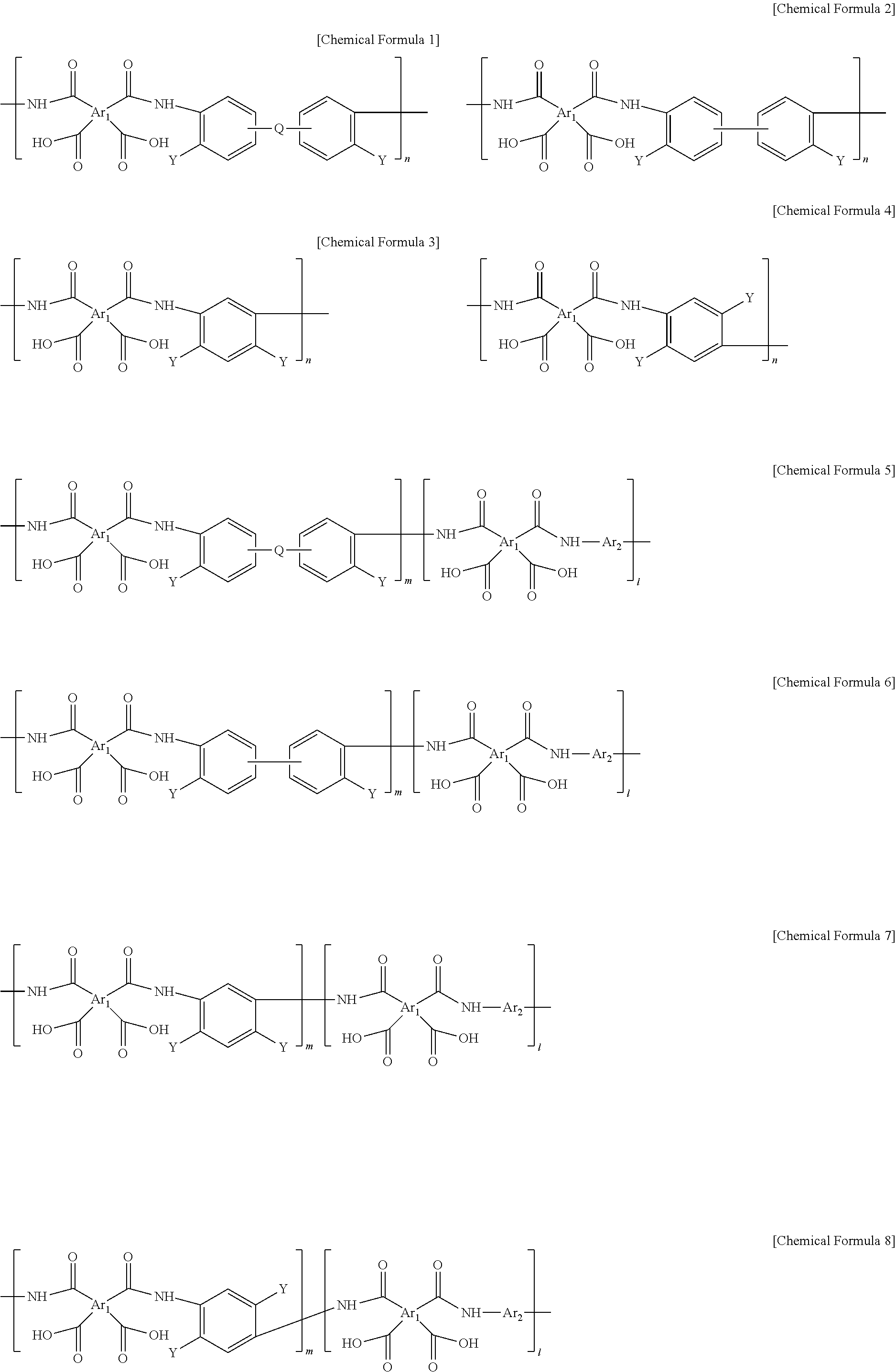
wherein, in the above Chemical Formulae 1 to 8, Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{c}, (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different in each repeating unit and is independently selected from OH, SH, and NH₂,
n is an integer ranging from 20 to 200,
m is an integer ranging from 10 to 400, and
l is an integer ranging from 10 to 400.

9. The polymer of claim 8, wherein the Ar₁ is selected from one of the following Chemical Formulae: 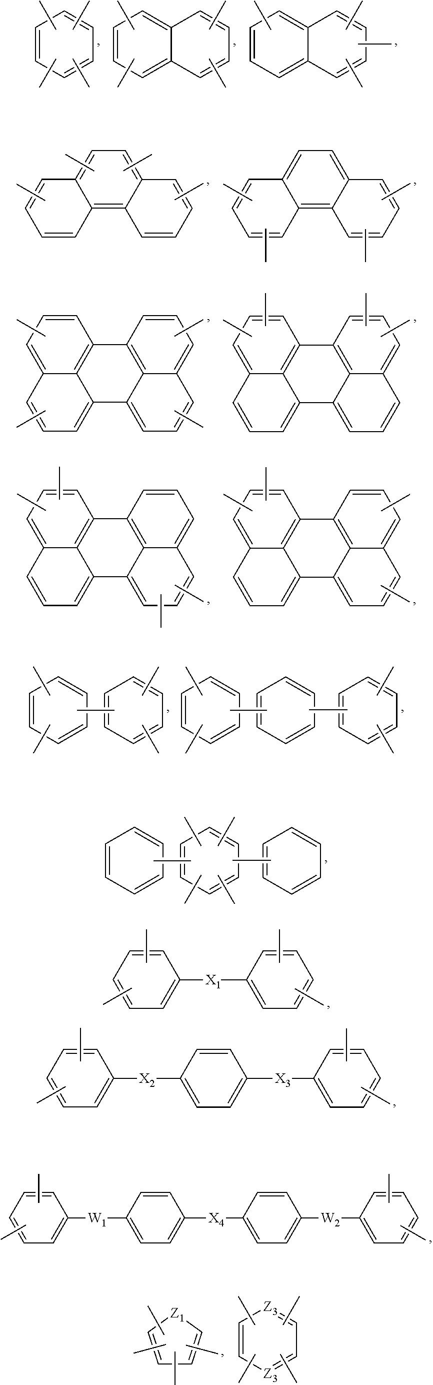
wherein, in the above Chemical Formula,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁R₂, or NR₃, where R₁, R₂, and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

10. The polymer of claim 9, wherein the Ar₁ is selected from one of the following Chemical Formulae:

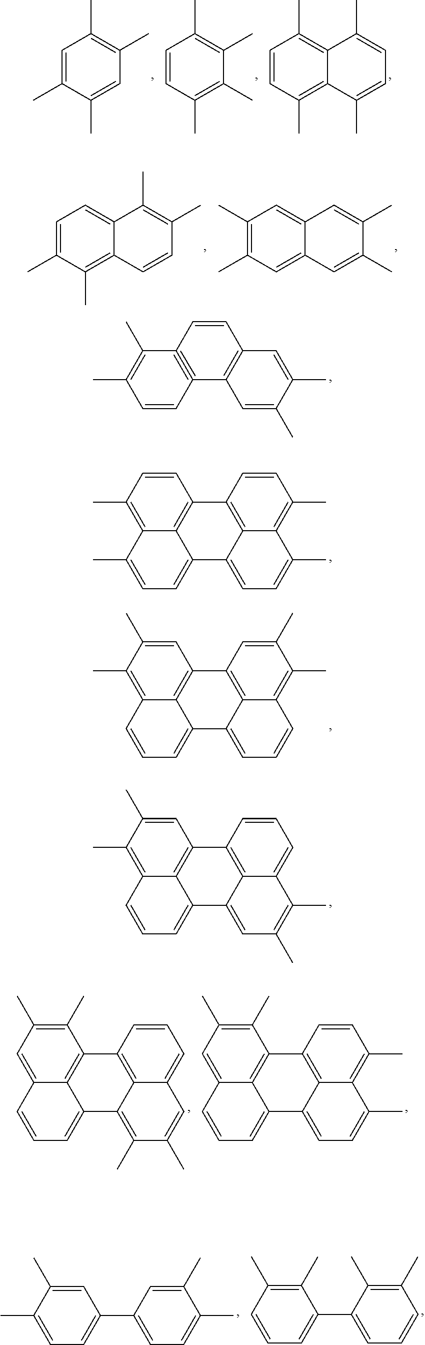

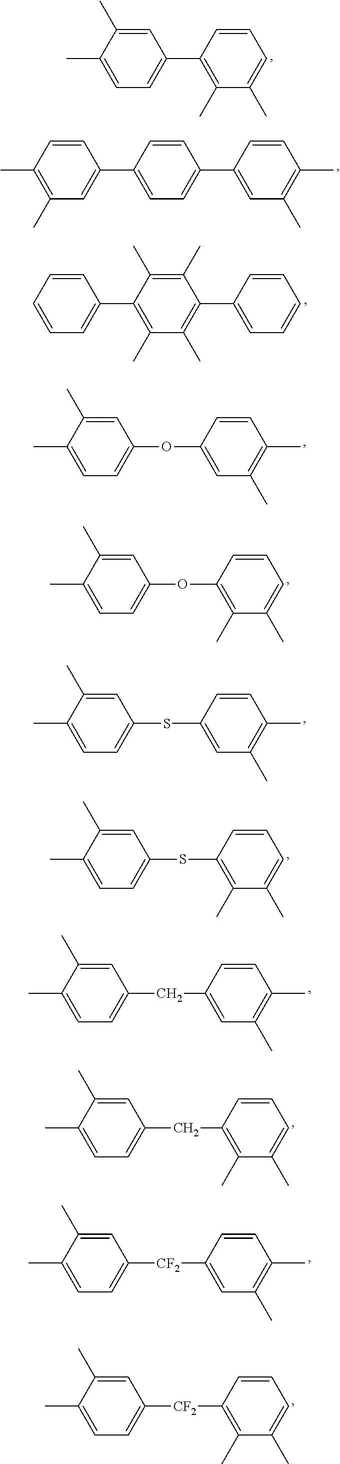

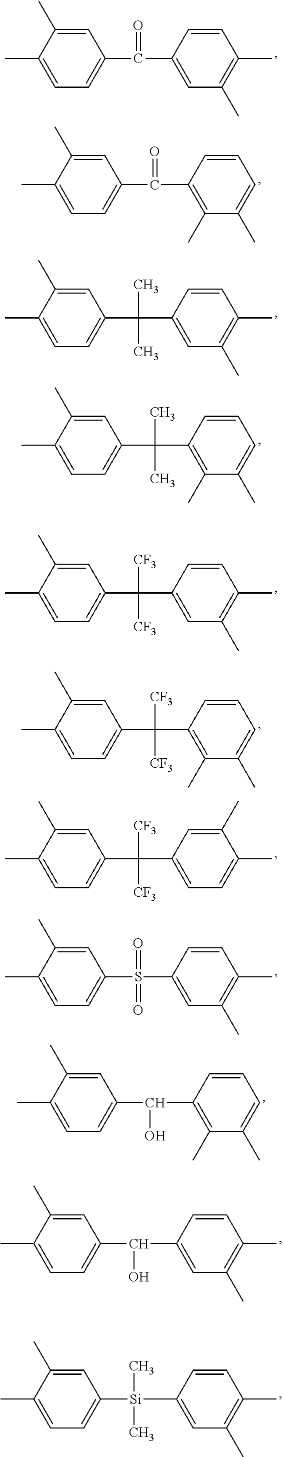

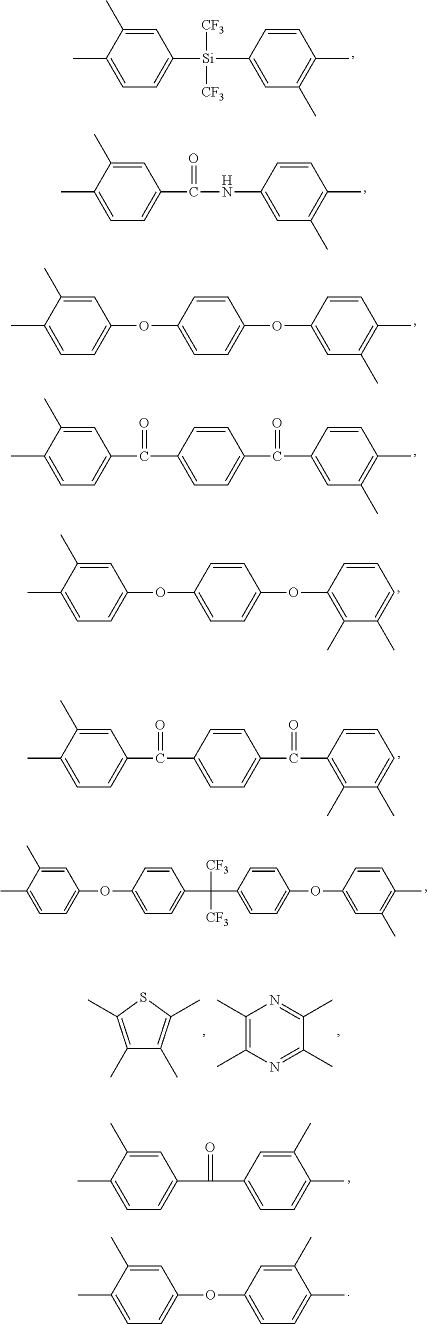

11. The polymer of claim 8, wherein the Ar₂ is selected from one of the following Chemical Formulae: 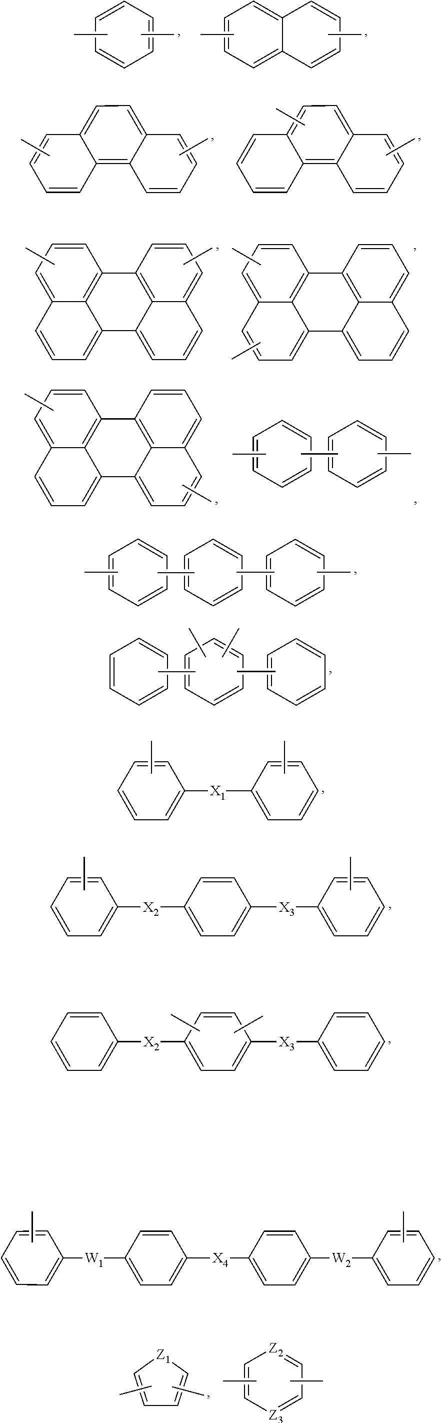
wherein, in the above Chemical Formulae,
X₁, X₂, X₃ and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁R₂ or NR₃, where R₁, R₂, and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

12. The polymer of claim 11, wherein the Ar₂ is selected from one of the following Chemical Formulae:

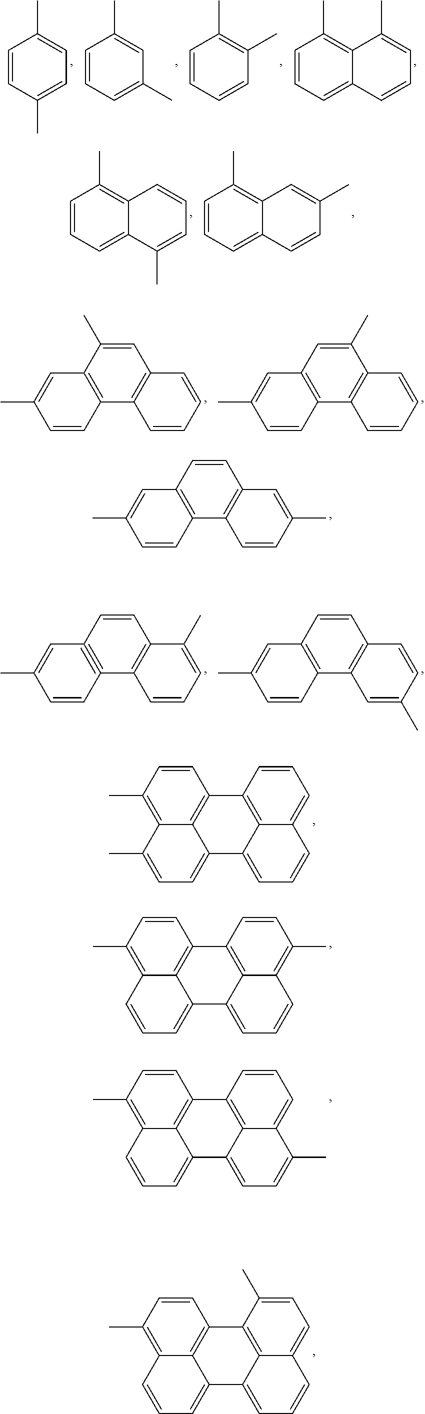

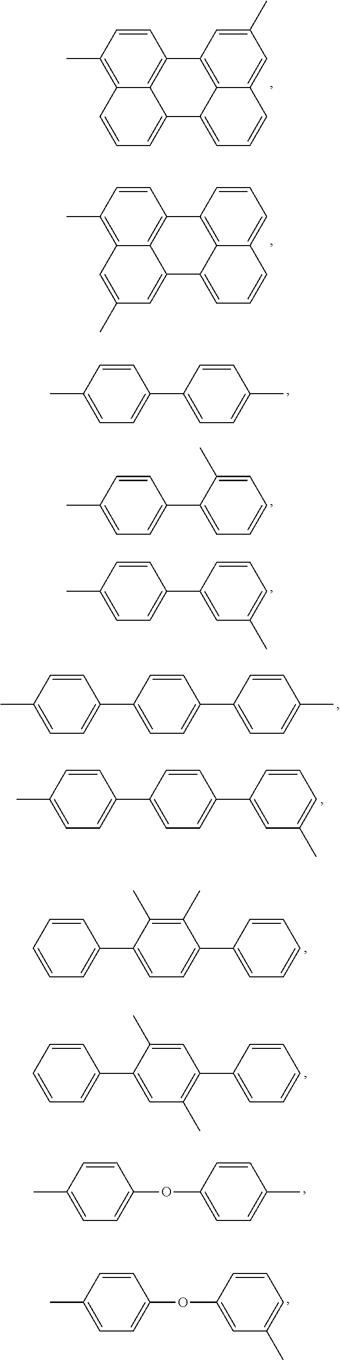

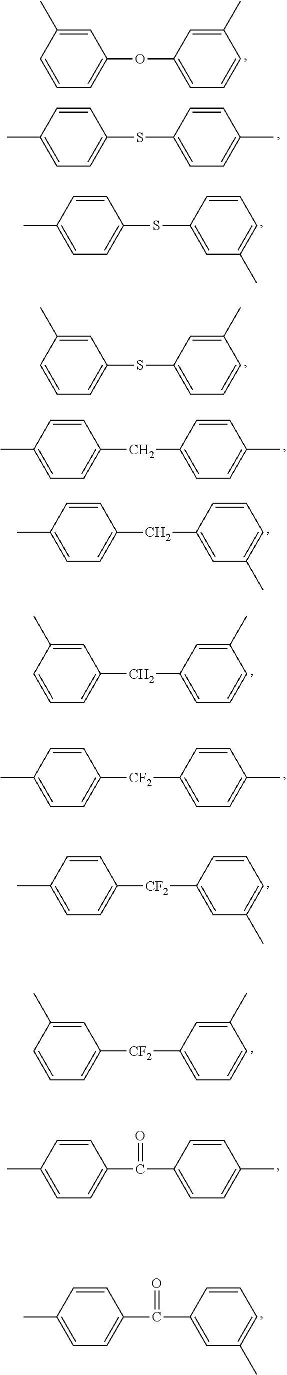

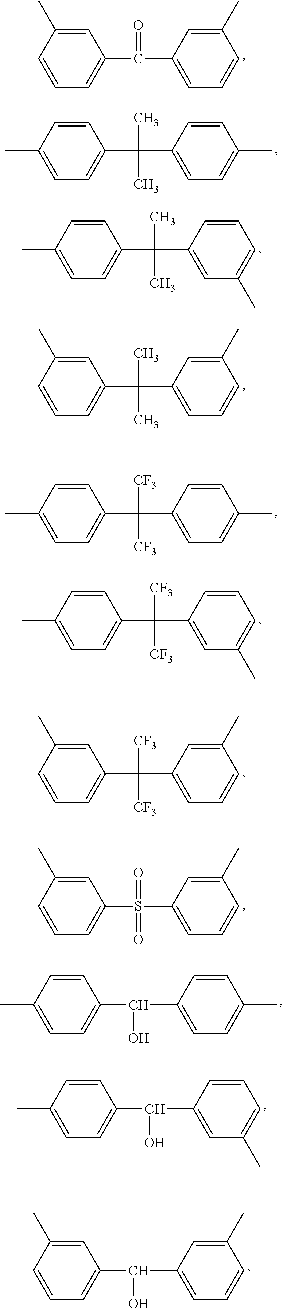

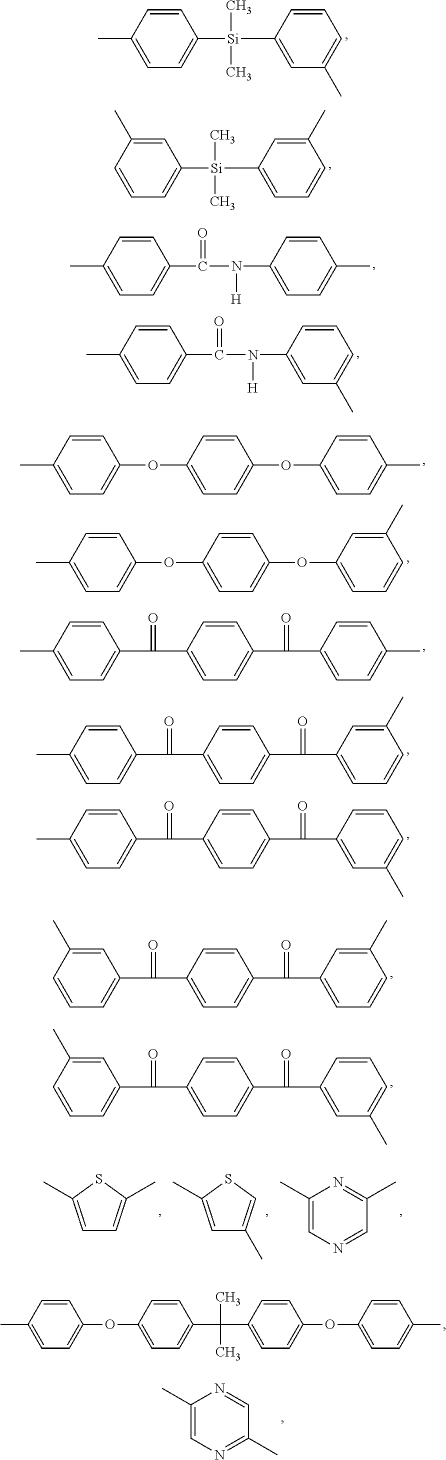

13. The polymer of claim 8, wherein the Q is selected from C(CH₃)₂, C(CF₃)₂, O, S, S(═O)₂, or C(═O).

14. The polymer of claim 8, wherein the Ar₁ is a functional group represented by the following Chemical Formula A, B, or C, Ar₂ is a functional group represented by the following Chemical Formula D or E, and Q may be C(CF₃)₂:

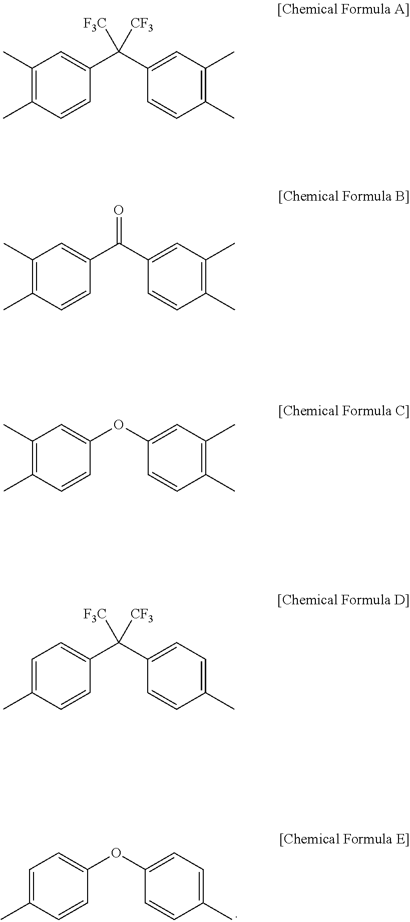

15. The polymer of claim 8, wherein, a mole ratio between the repeating units in the polyamic acid copolymer including a repeating unit represented by the above Chemical Formulae 1 to 4, or an m:l mole ratio in Chemical Formula 5 to 8 ranges from 0.1:9.9 to 9.9:0.1.

16. The polymer of claim 1, wherein the polyimide is selected from the group consisting of polyimide including a repeating unit represented by the following Chemical Formulae 33 to 36, polyimide copolymers including a repeating unit represented by the following Chemical Formulae 37 to 40, copolymers thereof, and blends thereof: 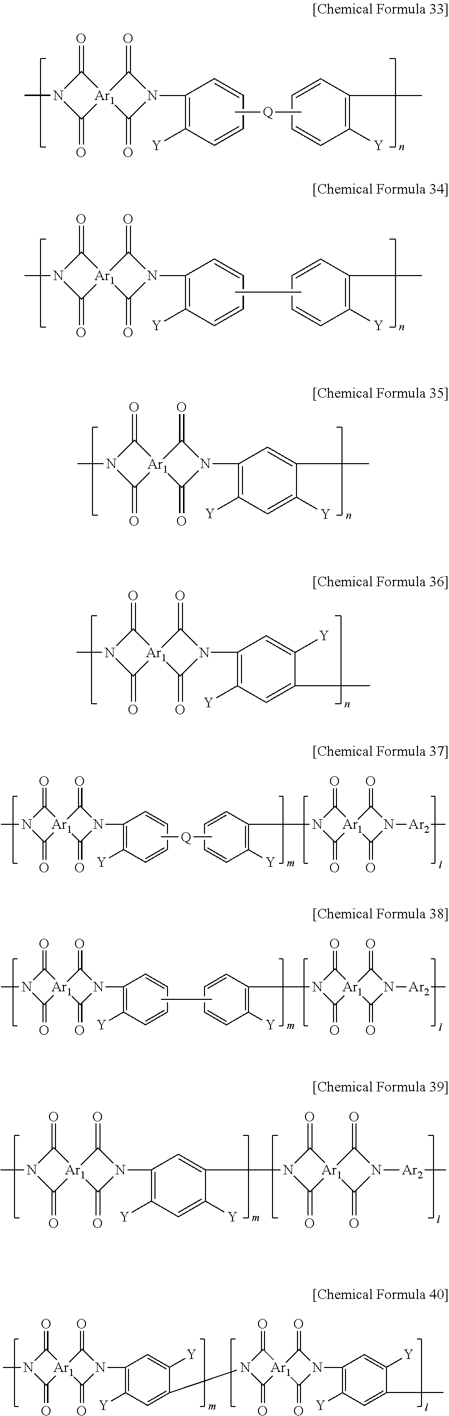
wherein, in the above Chemical Formulae 33 to 40,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Ar₂ is an aromatic group selected from a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different in each repeating unit and is independently selected from OH, SH, or NH₂,
n is an integer ranging from 20 to 200,
m is an integer ranging from 10 to 400, and
l is an integer ranging from 10 to 400.

17. The polymer of claim 16, wherein the Ar₁ is selected from one of the following Chemical Formulae: 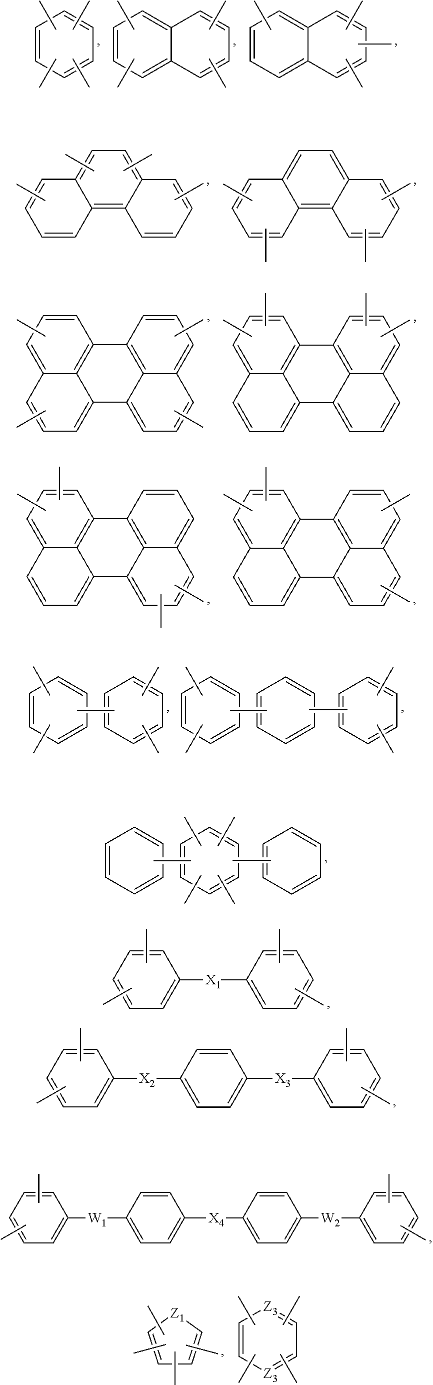
wherein, in the above Chemical Formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁R₂ or NR₃, where R₁, R₂, and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

18. The polymer of claim 17, wherein the Ar₁ is selected from one of the following Chemical Formulae:

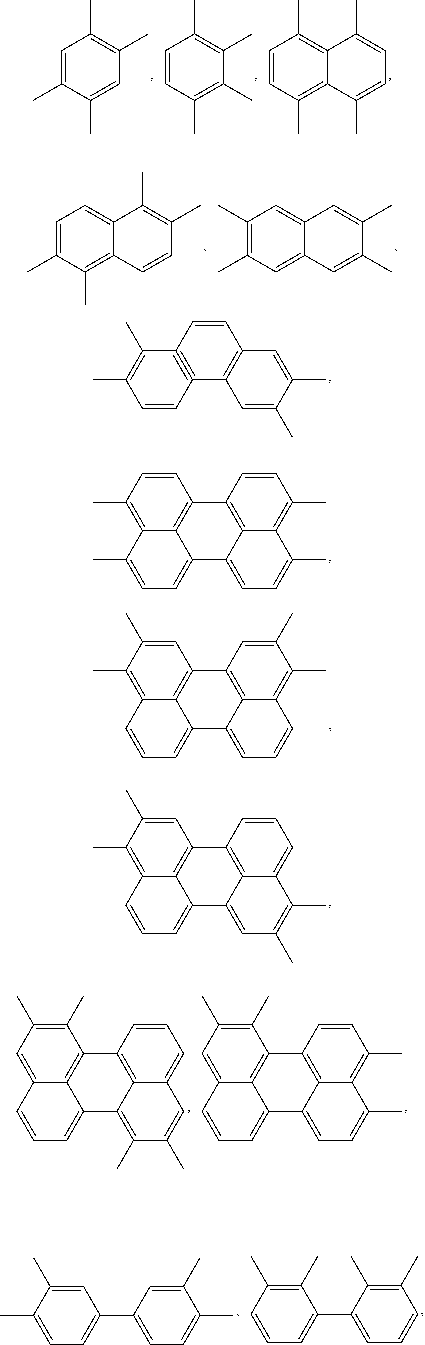

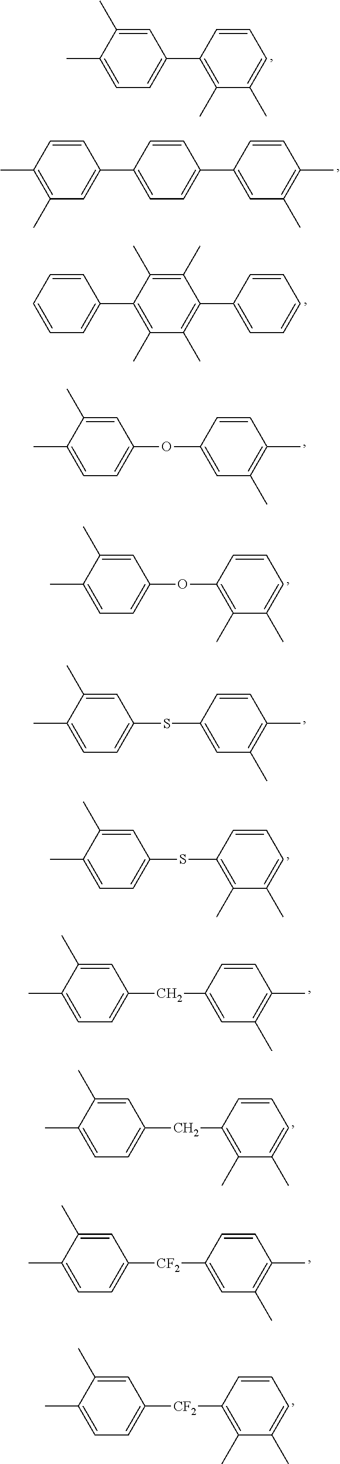

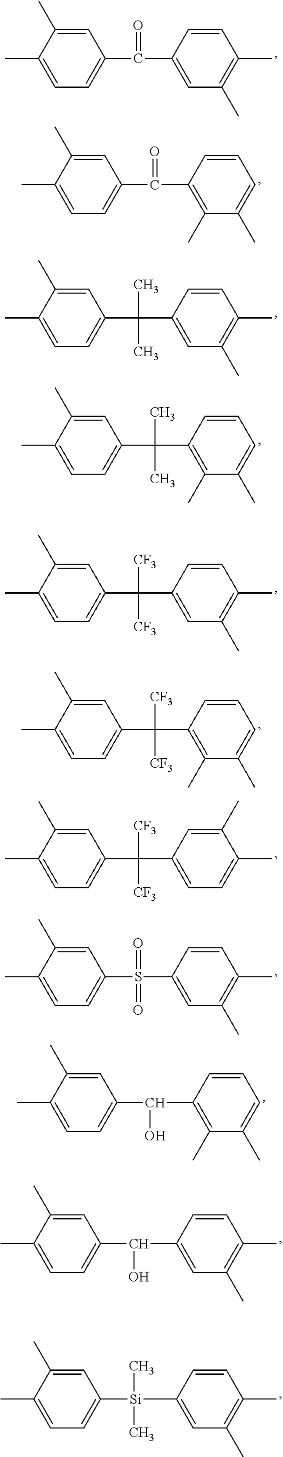

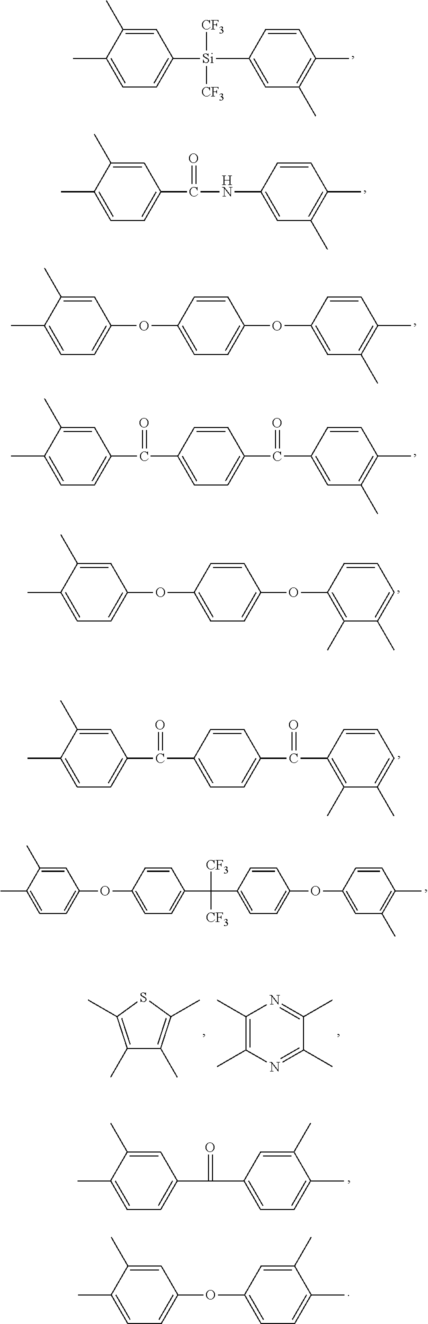

19. The polymer of claim 16, wherein the Ar₂ is selected from one of the following Chemical Formulae: 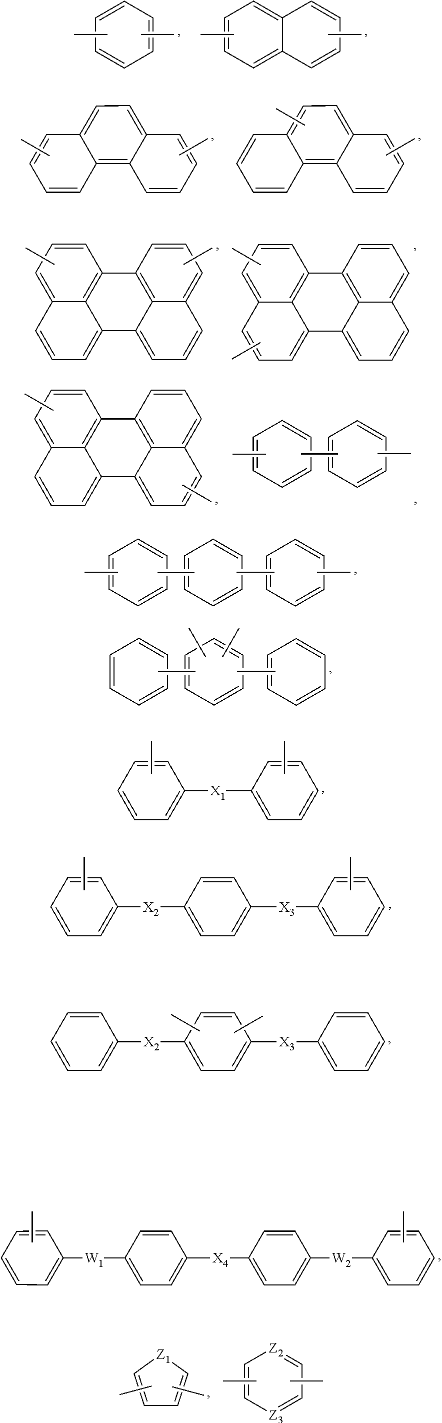
wherein, in the above Chemical Formulae, X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁R₂, or NR₃, where R₁, R₂ and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

20. The polymer of claim 19, wherein the Ar₂ is selected from one of the following Chemical Formulae:

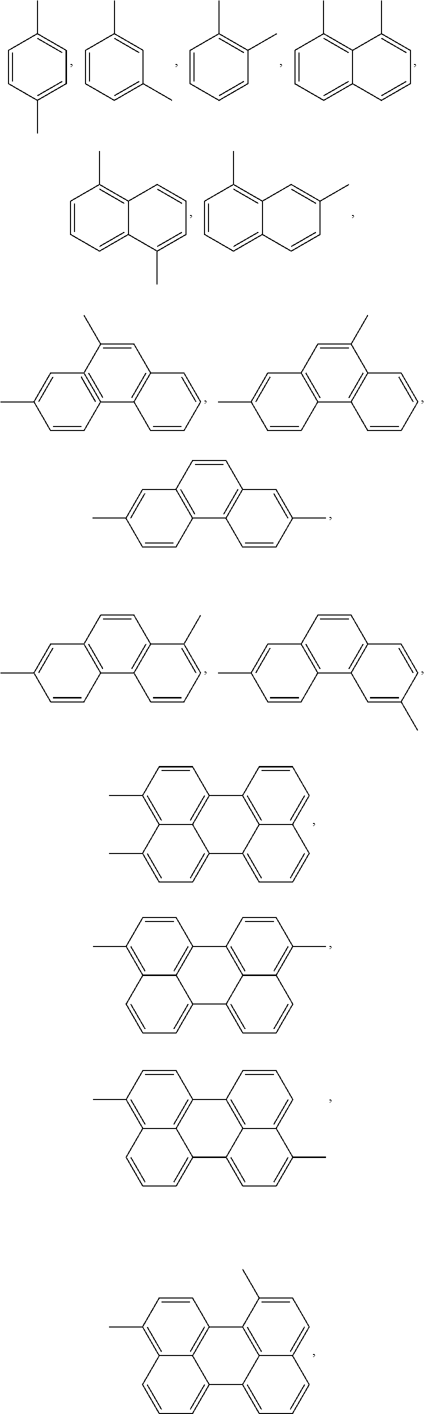

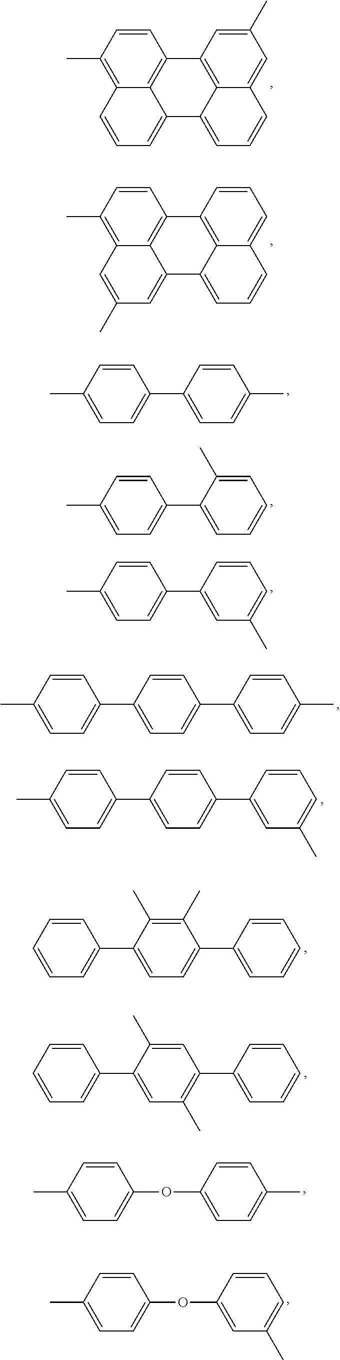

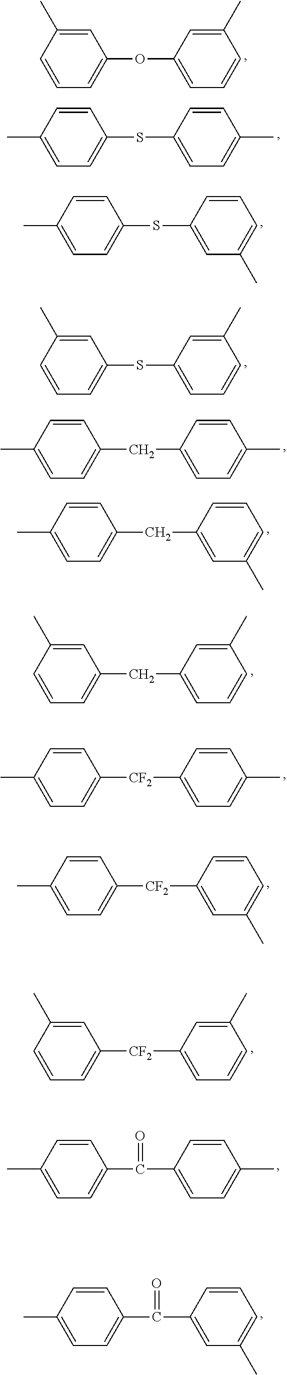

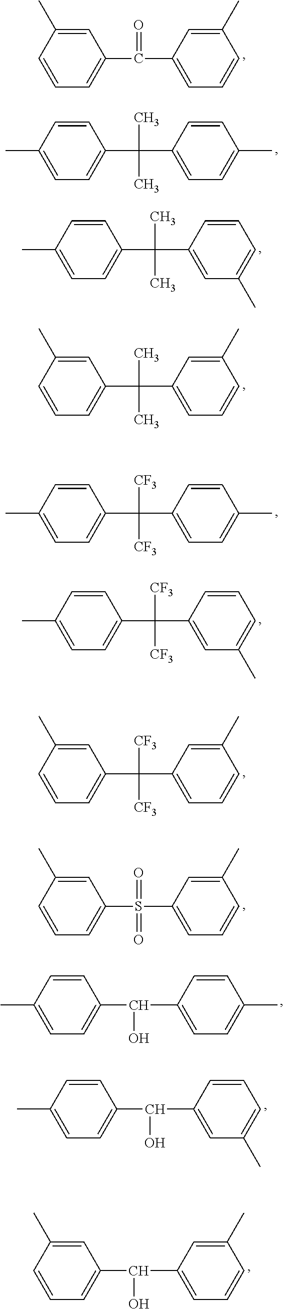

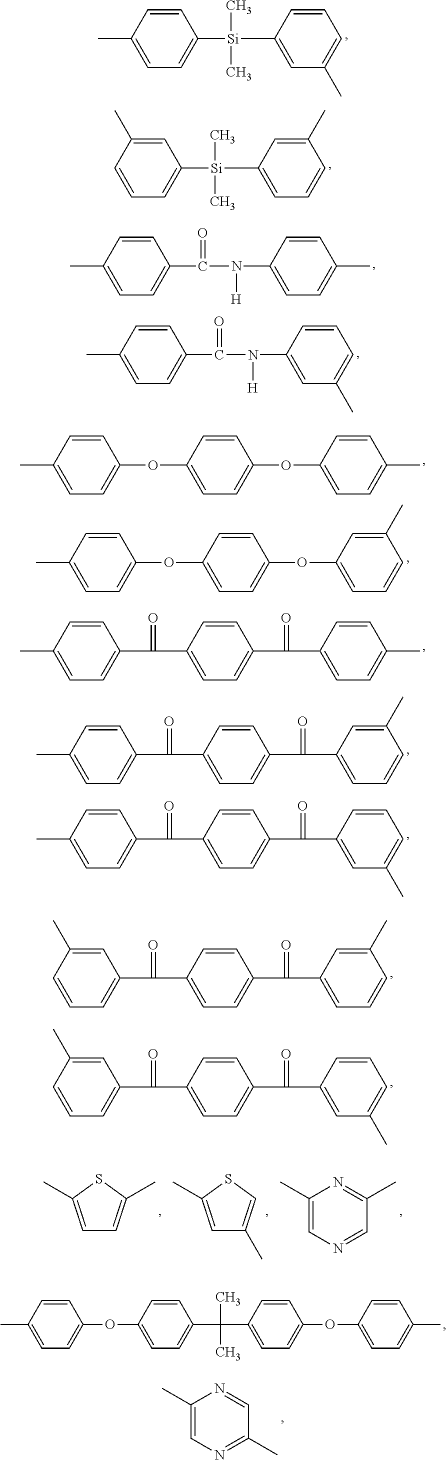

21. The polymer of claim 16, wherein the Q is selected from C(CH₃)₂, C(CF₃)₂, O, S, S(═O)₂, or C(═O).

22. The polymer of claim 16, wherein Ar₁ is a functional group represented by the following Chemical Formula A, B, or C, Ar₂ is a functional group represented by the following Chemical Formula D or E, and Q is C(CF₃)₂:

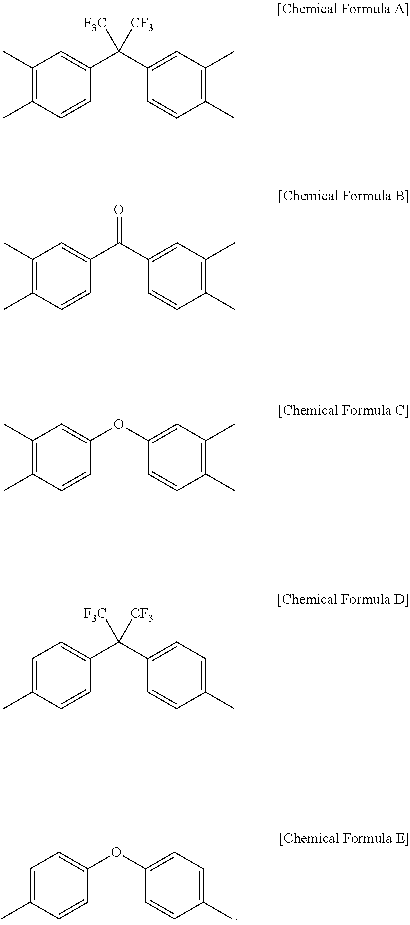

23. The polymer of claim 16, wherein a mole ratio between the repeating units in the polyimide copolymer including a repeating unit represented by the above Chemical Formulae 33 to 36, or an m:l mole ratio in Chemical Formula 37 to 40 ranges from 0.1:9.9 to 9.9:0.1.

24. The polymer of claim 1, wherein the polymer derived from polyamic acid or a polyimide includes compounds including a repeating unit represented by one of the following Chemical Formulae 19 to 32 or copolymers thereof: 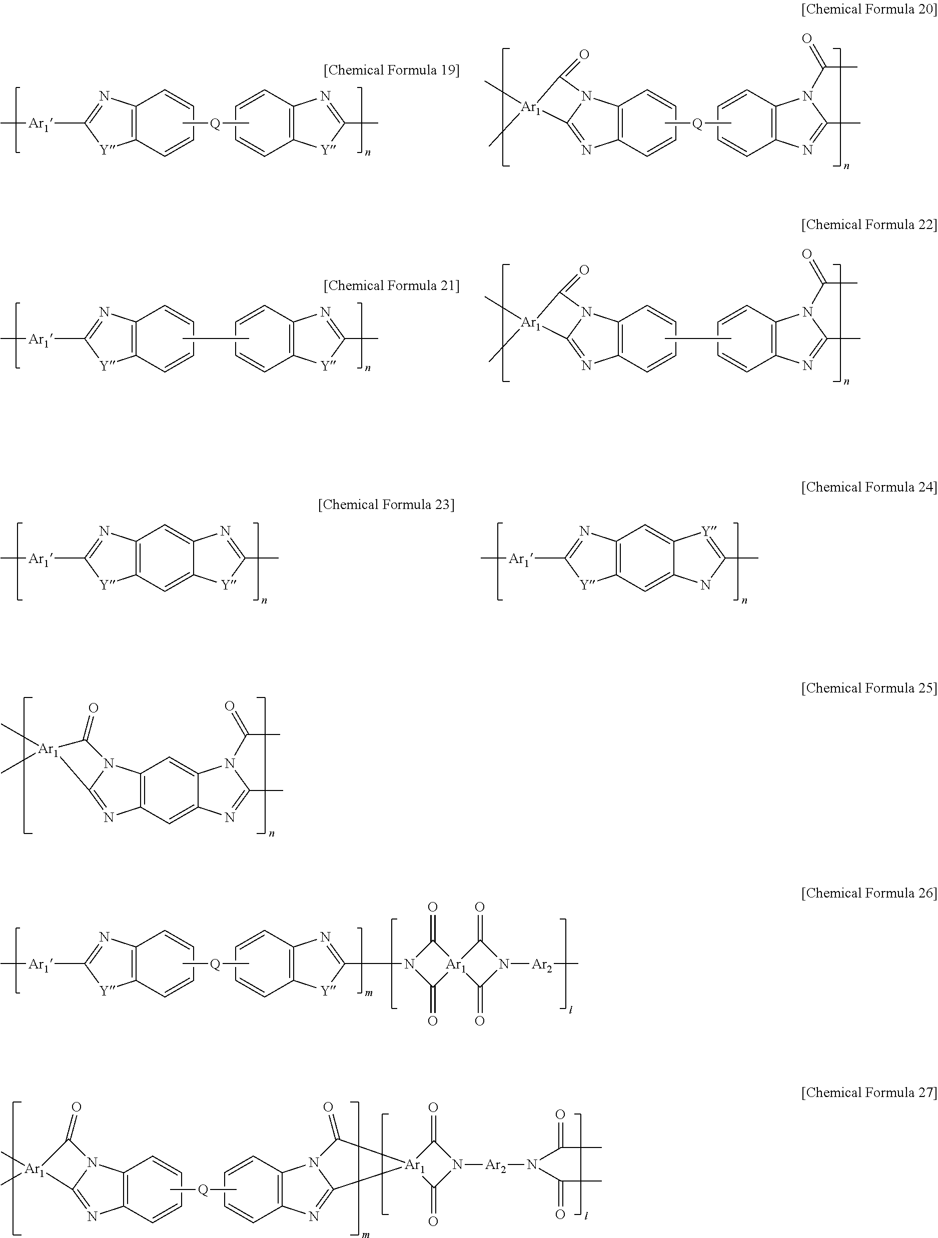 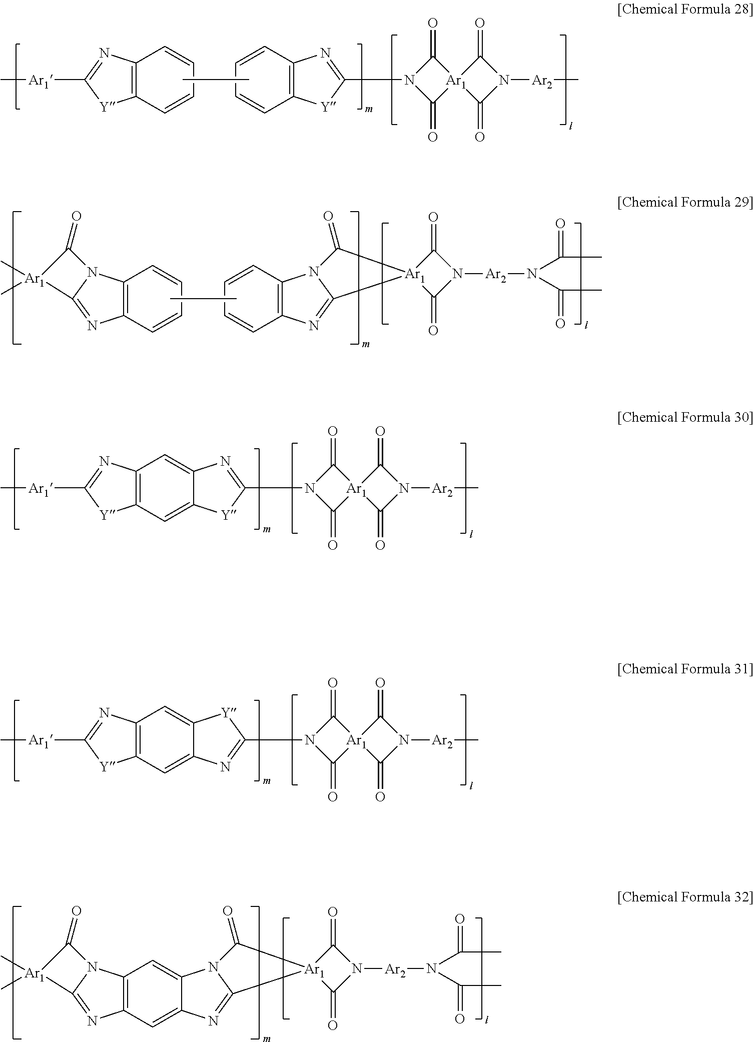
wherein, in the above Chemical Formulae 19 to 32,
Ar₁ is an aromatic group selected from a substituted or unsubstituted quadrivalent C6 to C24 arylene group and a substituted or unsubstituted quadrivalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Ar₁′ and Ar₂ are the same or different and are independently a substituted or unsubstituted divalent C6 to C24 arylene group and a substituted or unsubstituted divalent C4 to C24 heterocyclic group, where the aromatic group is present singularly; at least two aromatic groups are fused to form a condensed cycle; or at least two aromatic groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y″ is O or S,
n is an integer ranging from 20 to 200,
m is an integer ranging from 10 to 400, and
l is an integer ranging from 10 to 400.

25. The polymer of claim 24, wherein the Ar₁ is selected from one of the following Chemical Formulae: 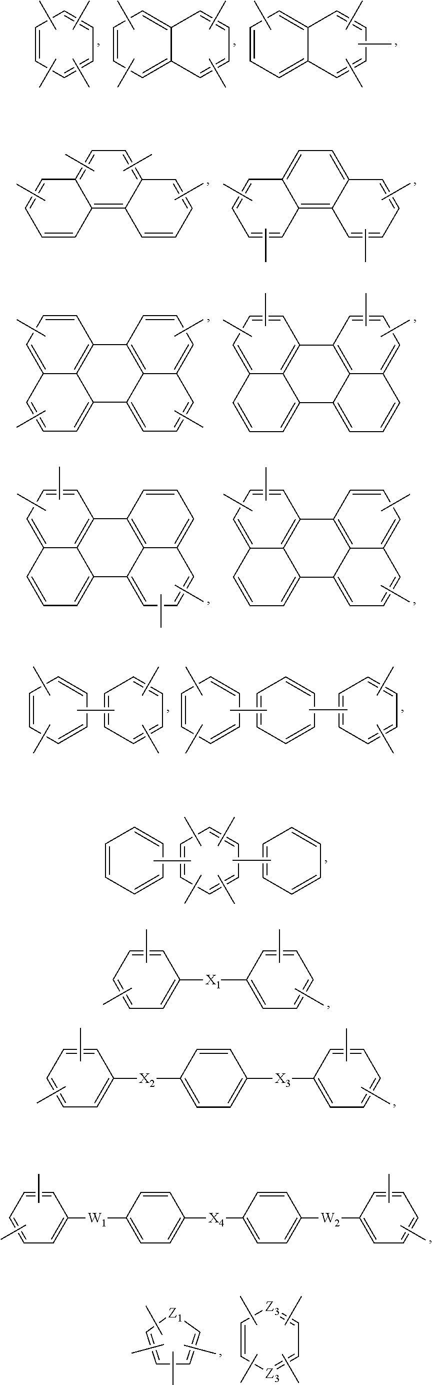
wherein, in the above Chemical Formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different, and are independently O, S, or C(═O),
Z₁ is O, S, CR₁R₂, or NR₃, where R₁, R₂, and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

26. The polymer of claim 25, wherein the Ar₁ is selected from one of the following Chemical Formulae:

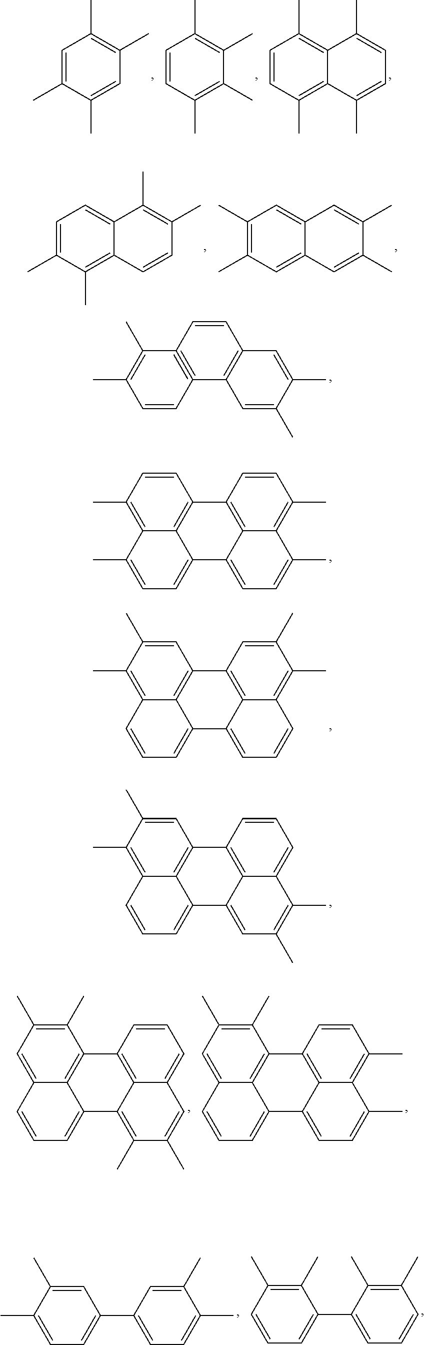

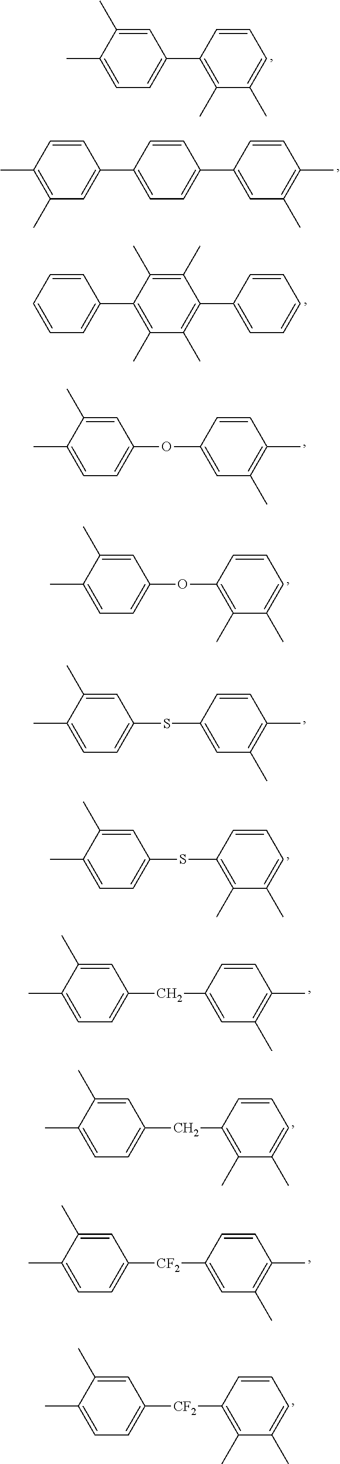

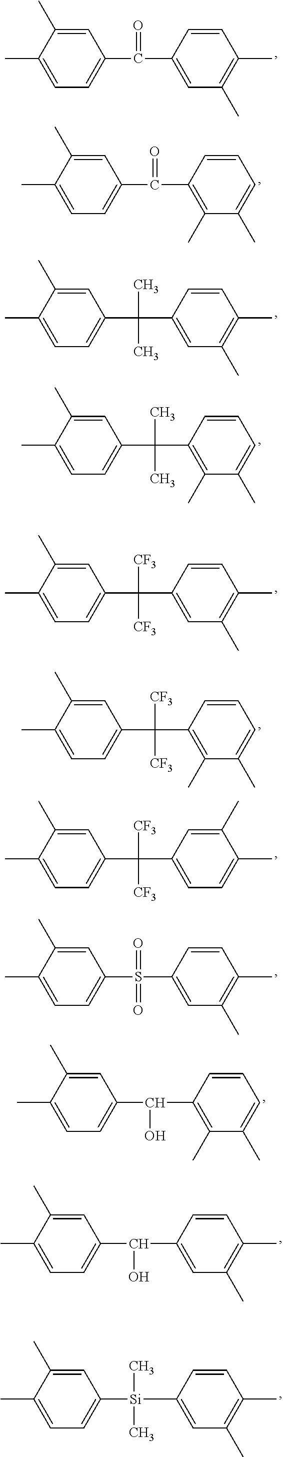

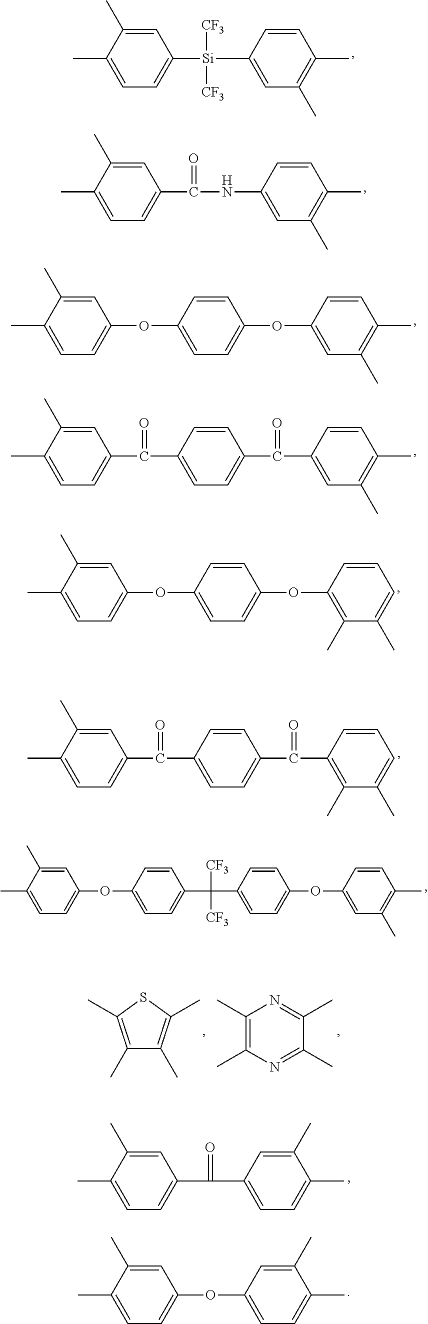

27. The polymer of claim 24, wherein the Ar₁′ and Ar₂ are selected from one of the following Chemical Formulae: 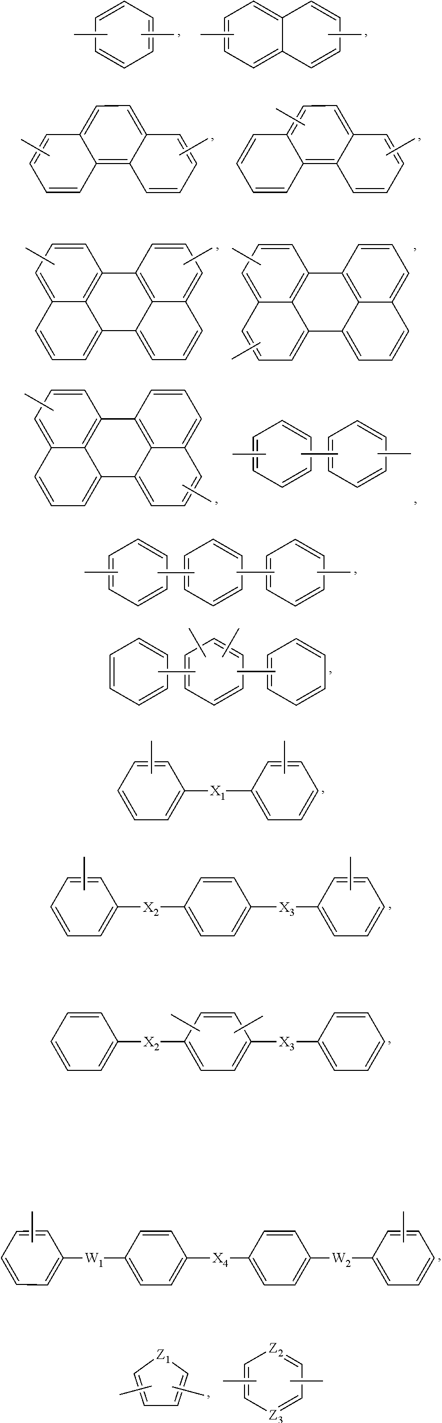
wherein, in the above Chemical Formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦p≦10), C(CH₃)₂, C(CF₃)₂, or C(═O)NH,
W₁ and W₂ are the same or different and are independently O, S, or C(═O),
Z₁ is O, S, CR₁R₂, or NR₃, where R₁, R₂, and R₃ are the same or different and are independently hydrogen or a C1 to C5 alkyl group, and
Z₂ and Z₃ are the same or different and are independently N or CR₄ (where R₄ is hydrogen or a C1 to C5 alkyl group), provided that both Z₂ and Z₃ are not CR₄.

28. The polymer of claim 27, wherein the Ar₁′ and Ar₂ are selected from one of the following Chemical Formulae:

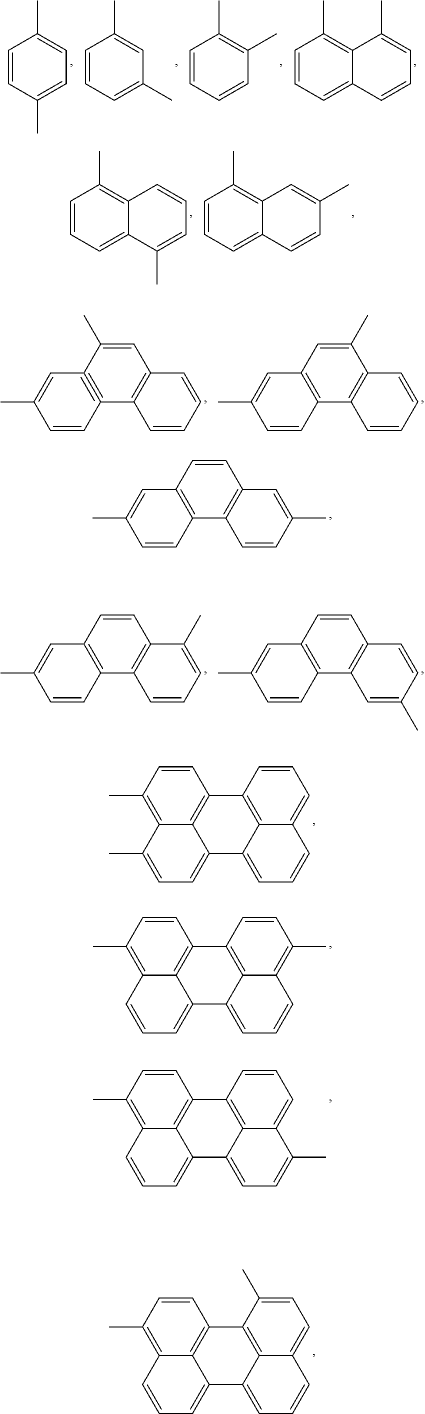

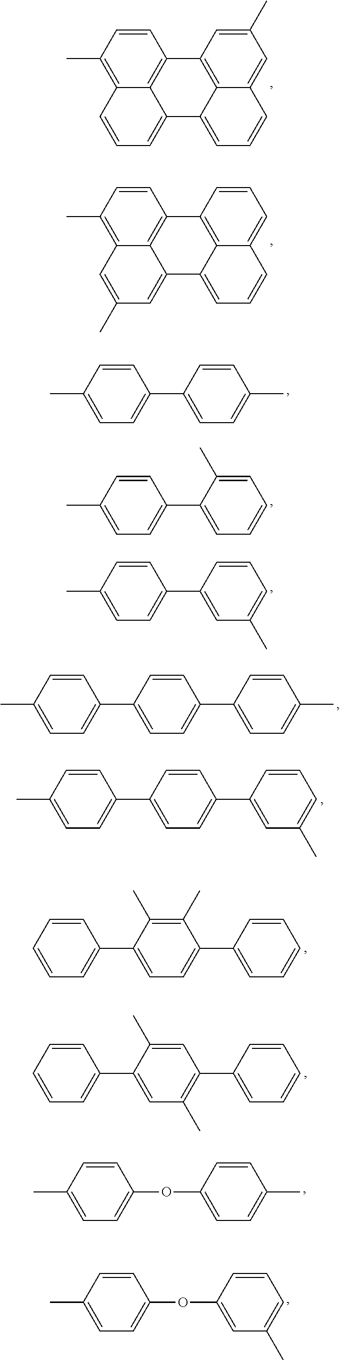

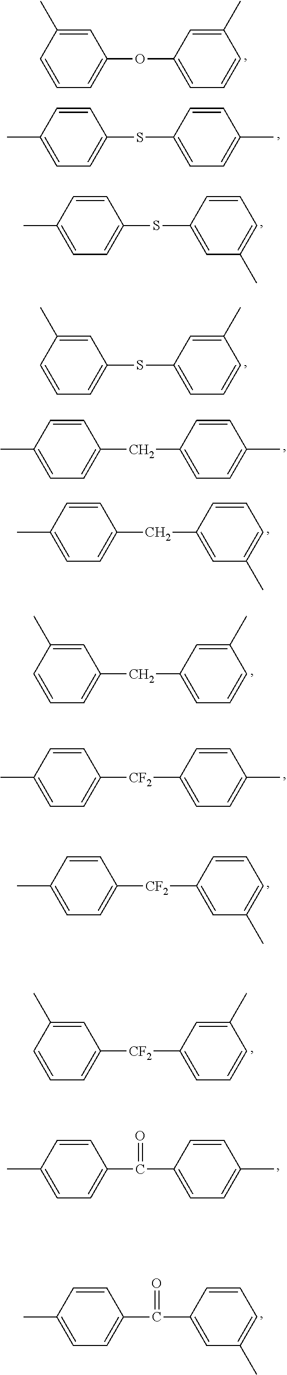

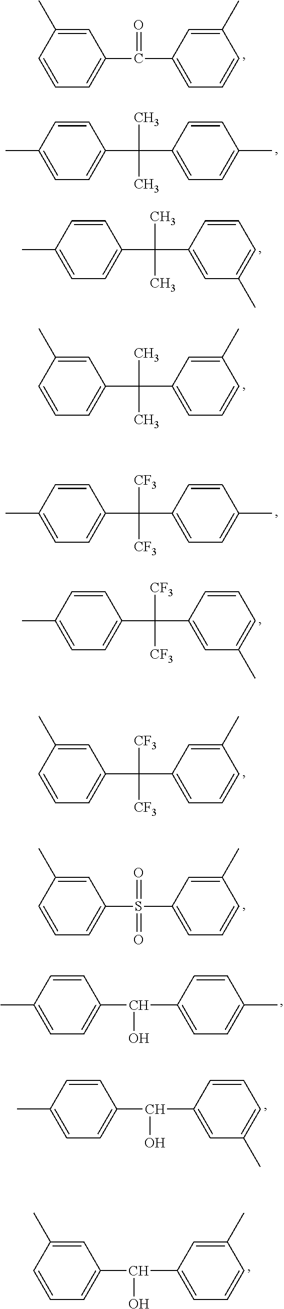

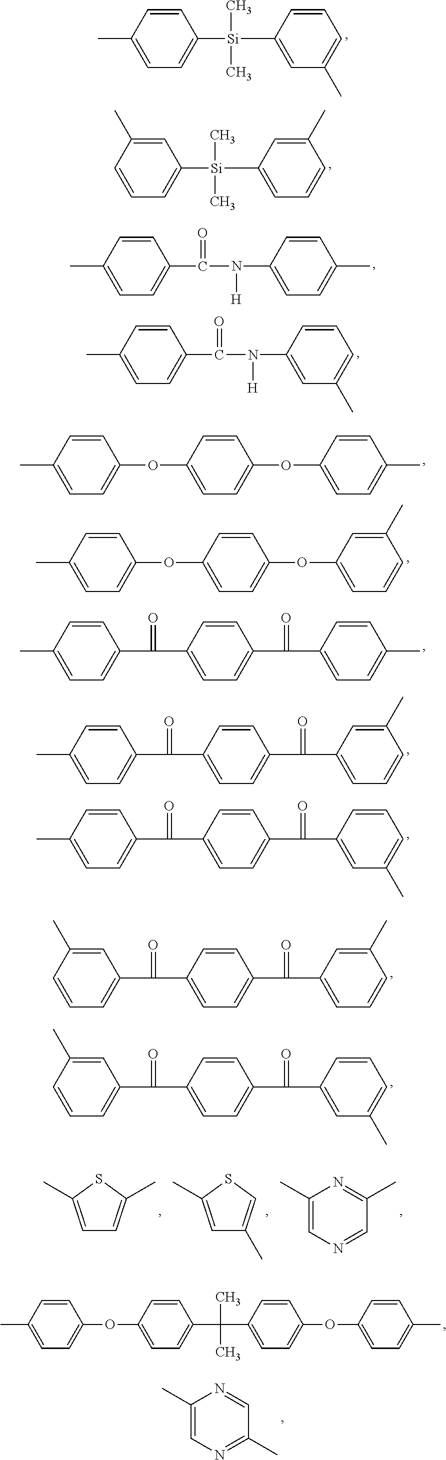

29. The polymer of claim 24, wherein the Q is selected from C(CH₃)₂, C(CF₃)₂, O, S, S(═O)₂, or C(═O).

30. The polymer of claim 24, wherein the Ar₁ is a functional group represented by the following Chemical Formula A, B, or C, Ar₁′ is a functional group represented by the following Chemical Formula F, G, or H, Ar₂ is a functional group represented by the following Chemical Formula D or E, and Q may be C(CF₃)₂:

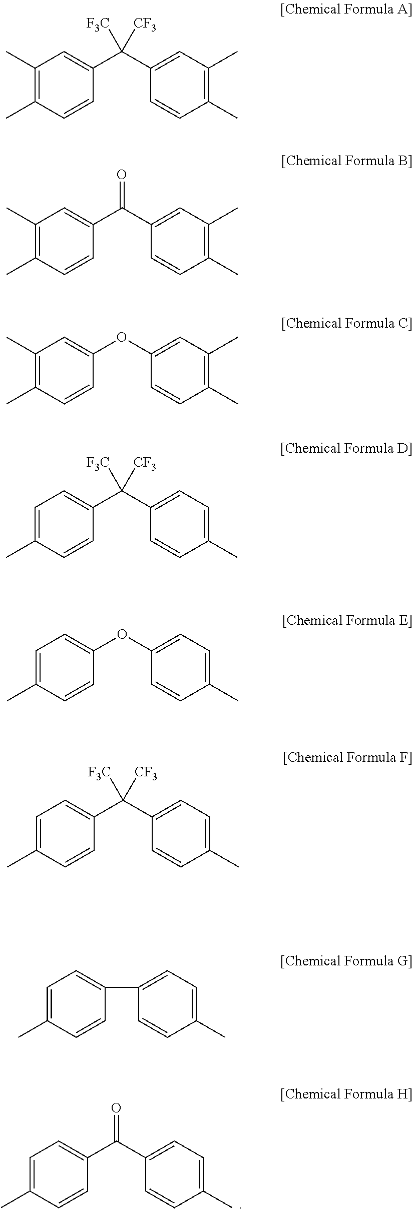

31. The polymer of claim 1, wherein the polymer has a weight average molecular weight (Mw) of 10,000 to 200,000.

32. The polymer of claim 1, which is doped with an acid dopant.

33. The polymer of claim 32, wherein the acid dopant includes one selected from the group consisting of sulfuric acid, hydrochloric acid, phosphoric acid, nitric acid, HBrO₃, HClO₄, HPF₆, HBF₆, 1-methyl-3-methylimidazolium cations (BMIM⁺), and a combination thereof.

34. The polymer of claim 1, wherein the polymer further includes an additive selected from the group consisting of fumed silica, zirconium oxide, tetraethoxysilane, montmorillonite clay, and a combination thereof.

35. The polymer of claim 1, wherein the polymer further includes an inorganic filler selected from the group consisting of phosphotungstic acid (PWA), phosphomolybdic acid, silicotungstic acid (SiWA), molybdophosphoric acid, silicomolybdic acid, phosphotin acid, zirconium phosphate (ZrP), and a combination thereof.

36. A preparation method of a polymer, wherein the method comprises:
obtaining a polyimide by imidization of polyamic acid;
and heat-treating the polyimide,
wherein the polyamic acid includes a repeating unit obtained from an aromatic diamine including at least one ortho-positioned functional group with respect to an amine group and a dianhydride, and
the polymer includes picopores.

37. The preparation method of the polymer of claim 36, wherein the heat treatment is performed by increasing the temperature by 1° C./min to 30° C./min up to 350° C. to 500° C., and then maintaining the temperature for 1 minute to 12 hours under an inert atmosphere.

38. The preparation method of the polymer of claim 37, wherein the heat treatment is performed by increasing the temperature by 5° C./min to 20° C./min up to 350° C. to 450° C., and then maintaining the temperature for about 1 hour to about 6 hours under an inert atmosphere.

39. A preparation method of a polymer, wherein the method comprises
heat-treating a polyimide,
wherein the polyimide includes a repeating unit obtained from an aromatic diamine including at least one ortho-positioned functional group with respect to an amine group and a dianhydride, and
the polymer includes picopores.

40. The preparation method of the polymer of claim 39, wherein the heat treatment is performed by increasing the temperature by 1° C./min to 30° C./min up to 350° C. to 500° C., and then maintaining the temperature for 1 minute to 12 hours under an inert atmosphere.

41. The preparing method of the polymer of claim 40, wherein the heat treatment is performed by increasing the temperature by 5° C./min to 20° C./min up to 350° C. to 450° C., and then maintaining the temperature for about 1 hour to about 6 hours under an inert atmosphere.

42. An article including the polymer of claim 1.

43. The article of claim 42, wherein the article includes a sheet, a film, a powder, a layer, or a fiber.

44. The article of claim 42, wherein the article includes picopores, and
the picopores form a three-dimensional network structure where at least two picopores are three-dimensionally connected to have an hourglass-shaped structure forming a narrow valley at connection parts.
